(19) United States
(12) Patent Application Publication
(10) Pub. No.: US 2003/0083908 A1
(43) Pub. Date: May 1, 2003

(54) System and method for reinsurance placement

(76) Inventor: Sylvia Steinmann, Meilen (CH)

Correspondence Address: SHAW PITTMAN LLP, 1650 TYSONS BOULEVARD, MCLEAN, VA, 22102, US

(21) Appl. No.: 10/267,942

(22) Filed: Oct. 10, 2002

Related U.S. Application Data
(60) Provisional application No. 60/328,441, filed on Oct. 12, 2001.

(51) Int. Cl. G06F 17/60

(52) U.S. Cl. 705/4

(57) ABSTRACT

A system and method for facilitating the placement of reinsurance, the method involving a cedent collecting risk data to determine if a need for reinsurance exists, and, if so, preparing a renewal package containing data reinsurers need to provide a quotation. A renewal package includes programs, possibly in different combinations, to be sent to different selected reinsurers. The renewal package is dispatched to the reinsurers, who evaluate it and return quotations. The cedent evaluates the quotations, benchmarks prices, negotiates, and agrees to a final reinsurance program structure, written share, and price from chosen reinsurers. The chosen reinsurers forward written share proposals to the cedent, who evaluates the proposals and captures a final share and price. The cedent and chosen reinsurers sign off on the final share and price.

This application claims the benefit of U.S. Provisional Application No. 60/328,441, filed Oct. 12, 2001, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to the insurance and reinsurance industries, and more particularly, to a system and method for managing the creation and placement of reinsurance. The present invention provides reinsurance creation and placement tools for direct insurers (cedents), which can be used as a stand-alone tool or in conjunction with tools from reinsurers.

2. Background of the Invention

Reinsurance is the insurance of insurance companies' risks. More precisely, reinsurance is the transfer of part of the hazards or risks that a direct insurer assumes by way of insurance contract or legal provision on behalf of an insured, to a second insurance carrier, the reinsurer, who has no direct contractual relationship with the insured.

To set premium rates, insurers must be able to predict future losses. However, it is impossible to predict the exact moment fate will strike any one individual, or the extent of the loss that this blow will cause. Thus, insurers consider large groups of their clients under the assumption that each is exposed to the same types of risk, and that each loss is a separate event. In such cases, the larger the group, the closer the average loss will approach a definite value. This is the result described by the law of large numbers, discovered by Jakob Bernoulli around 1700. Thanks to this law, an insurer can predict the total annual loss to be expected for the group much more accurately than for any one individual. The projected losses are then distributed among those insured, thereby determining the premium.

Today, insurers make extensive use of statistics to calculate the expected losses and distribute them over the individual premiums. Statistics are always based on the past, but the laws of probability make it possible to apply these data to the present and to predict future trends. Though the theory of probability is highly developed, there is a risk that there may be differences between prediction and reality. This risk, known as underwriting (or actuarial) risk, is one of the main reasons that reinsurance is needed.

Through reinsurance, a direct insurer can limit (as much as possible) annual fluctuations in the losses it must bear on its own account, and be protected in case of catastrophe. Reinsurance thus allows direct insurers to free themselves from the part of a risk that exceeds their underwriting capacity, or risks which, for one reason or another, they do not wish to bear alone.

Thus, the role of a reinsurance company is to insure insurance companies and other risk-bearing organizations. Insurance companies (known as “ceding companies” or cedents) purchase insurance from reinsurance companies (known as “accepting companies” or reinsurers) to transfer some of their risk. This transfer of risk reduces the volatility of financial results for the insurance company, even if an unusually high number of claims or one especially large claim is submitted in one time period.

In some instances, reinsurers must spread their risks as well. When the reinsurer is not able or willing to assume the entire risk that the insurer wants to cede, the reinsurer may pass a portion of the risk to another reinsurer, called a retrocessionaire. The process of ceding insurance risk from one reinsurer to another is called retrocession.

There are various kinds of risks reinsured; along with large, complex property and casualty risks, such as earthquakes and hurricanes, the most common types of risk brought to reinsurers are mortality (life) and morbidity (health).

Direct insurers find relief from particularly large individual risks by ceding them individually in the form for facultative reinsurance. In facultative reinsurance, the direct insurer (ceding company) is free to choose which particular, individual risks it wants to reinsure; and the reinsurer, for its part, is free either to accept or refuse any risk offered to it. The term facultative is used because both the insurer and the reinsurer have the ability or (faculty) to decide whether to cede or assume the particular risk involved. A direct insurer who elects to reinsure a risk facultatively must present the reinsurer with a precisely defined offer containing all pertinent information on the risk in question. The reinsurer, after detailed examination, will decide whether or not to accept the offer. Risks ceded under facultative arrangements are typically standard risks with unusual underwriting characteristics or substandard risks.

In addition, entire portfolios containing all of a direct insurer's fire, motor, or marine insurance policies, for example, are also the object of reinsurance. These insurance portfolios are covered by blanket agreements, so-called obligatory reinsurance treaties.

The process of facultative reinsurance placement is readily automated because the process is systematic and capable of being handled through structured documentation. There have been numerous attempts to automate facultative reinsurance principally through structured documentation.

Obligatory (treaty) reinsurance is different. There is no systematic approach to placing treaty reinsurance. In addition, the obligatory reinsurance placement process makes extensive use of unstructured documents, in contrast to the facultative reinsurance placement process, which can use structured forms and documents. Thus, the obligatory reinsurance placement process is not amenable to full automation. Nonetheless, there is a need for tools to facilitate the obligatory reinsurance placement process and allow benchmarking. To be most useful in the obligatory reinsurance placement process, reinsurance placement and creation tools must be specifically designed for the obligatory reinsurance placement process rather than reinsurance generally. Thus, recognition of the unique aspects of the obligatory reinsurance placement process is an important part of the present invention.

Obligatory reinsurance is treaty reinsurance for entire portfolios: automatic reinsurance. In obligatory reinsurance, the direct insurer is obliged to cede to the reinsurer a contractually agreed share of the risks defined in the reinsurance treaty; the reinsurer is obliged to accept that share: hence the term obligatory. The reinsurer cannot therefore refuse to provide insurance protection for an individual risk falling within the scope of the treaty, nor may the direct insurer decide not to cede such a risk to the reinsurer. As a rule, obligatory reinsurance treaties are terminable on an annual basis.

Both forms of reinsurance (facultative and obligatory) may be either proportional or non-proportional in form. Proportional reinsurance requires both parties to share premiums and claims according to specified amount of percentage (quota share and excess). In all varieties of proportional reinsurance, the direct insurer and the reinsurer divide premiums and losses between them at a contractually defined ratio. According to the type of treaty, this ratio may be identical for all risks covered in the contract (quota share reinsurance), or it may vary from risk to risk (all other proportional reinsurance types). In all cases, however, the reinsurer's share of the premiums is directly proportional to its obligation to pay any losses. For instance, if the reinsurer accepts 90% of a particular risk and the direct insurer retains 10%, the premium is apportioned at a ratio of 90:10.

Non-proportional reinsurance is issued when the amount or proportion of risk is not known and the risk level depends upon a dollar amount or number of claims (stop-loss or excess of loss). In non-proportional reinsurance, there is no set, pre-determined ratio for dividing premiums and losses between the direct insurer and the reinsurer. Losses are apportioned according to the actual amount of loss incurred. The treaty defines an amount up to which the direct insurer will pay all losses: the deductible (other terms used include net retention, excess point; and priority). For its part, the reinsurer obliges himself to pay all losses above the deductible amount and not exceeding a contractually defined cover limit.

As the price for this cover, the reinsurer demands a suitable portion of the original premium. In defining (rating) this price, the reinsurer considers the loss experience of past years (experience rating) as well as the losses to be expected from that type and composition of risk (exposure rating).

Thus, the reinsurance agreement only obliges the reinsurer to pay when the reinsured portfolio or risk incurs an actual loss that exceeds the deductible amount.

The question of just how much reinsurance to buy is a complex matter of business judgment at which every direct insurer must arrive at an answer consistent with its business strategy. A final decision will depend on a complex set of factors such as the decision to cede risk for reduced volatility or financial result management, willingness by the reinsurers to take on risk, the company's financial strength, and market conditions. At present, there is a need for tools to make the factors involved in this decision process more transparent and easy to understand.

As part of the insurance management process, an insurer must evaluate the business requirement for reinsurance, and in that process, the cedent must arrange for the creation, management, and placement of the reinsurance. The conventional process for managing the creation and placement of reinsurance can take place either directly from the cedents to the reinsurers or through a third party (e.g., broker). The mechanisms of this transaction require exchanges of information, data, and requests. These exchanges involve all concerned parties and traditionally take place via visits, telephone, fax, mail, and e-mail.

Often, several iterations are necessary to reach an agreement between all involved parties. Within the reinsurance placement transaction, there is a definition of the reinsured liabilities; a specification of the reinsurance premium; a specification of the shares of all involved reinsurers in the liabilities and premium; and a specification of any conditions or special terms associated with the transaction.

This process is repeated periodically since reinsurance products are ordinarily reviewed and repriced annually unless market conditions dictate more frequent action. For example, a regulatory change may require immediate repricing actions.

The processes and customs involved in the placement of reinsurance have evolved over many years and are sufficient to enable billions of dollars of transactions each year. Nonetheless, there is room for improvement. To begin with, there is a need for a system and method for facilitating the purchasing of reinsurance for all of the participants active in the markets. Moreover, there is a need for tools and processes—both from the perspective of the client (cedent) and from the perspective of the reinsurer.—

From the cedent's perspective, it is desirable to streamline the business process and collaboration according to standards desired by the cedent. Also, there is a need for systematic storage of each and every step in the placement process, for subsequent historical review. Cedents need processes, tools and data transparency to help manage their reinsurance portfolio and to purchase reinsurance in a cost-effective way and under competitive market conditions. Such tools should preferably provide an overview of a cedent's local reinsurance coverage on a global basis and allow a cedent to manage and monitor a worldwide generation or renewal of a reinsurance portfolio—from the creation of a submission and an initial reinsurance offer, through the tender stage, to the final acceptance of prices and shares.

From the perspective of the reinsurer, there is a need for a system and method that eases the collection of standardized quality data from cedents and allows cedents to send selected portfolios to reinsurance participants (including electronic submissions).

Thus, there is a need for a system and method that meets these reinsurance-purchasing needs. More specifically, there is a need for a system and a method that allow the cedent to manage and monitor world-wide renewals—from the creation of a submission and an initial reinsurance offer, through the tender stage, to the final acceptance of prices and shares. Moreover, there is a need for a system and a method that support both centralized and decentralized business decision-making models in an efficient reinsurance management process. Such a system and a method are particularly useful to the extent they include certain features such as:

ease the collection of standardized quality data from the business units

provide the cedent with an overview of its local reinsurance coverage within a global context

support the steering of business processes and monitors defined responsibilities, ensuring that deadlines are met

allow cedents to send selected portfolios to reinsurance participants (including electronic submissions)

support benchmarking of reinsurance quotes so as to streamline collaborative decision-making

can be customized to fit your company's unique structure, processes and reporting needs

provides full security of the cedent's data and of information exchange with the reinsurer

can be installed with the cedent or be hosted cost-efficiently.

From the vantage point of the reinsurer, there is a need for a tool that streamlines the renewal process and offers the user all relevant client and treaty information in a single tool. It helps to get a consolidated view of the state of the renewal and to produce different reports on the whole business ceded by a cedent company.

### SUMMARY OF THE INVENTION

The present invention facilitates the creation, management, and placement of reinsurance. Built on a unified platform, the present invention enables collaboration between all of the players involved in the reinsurance creation, management, and placement process. The present invention enables the cedent to customize the business process and collaboration in the invention according to standards and business structure desired by the cedent. Moreover, the invention provides for the storage of each and every step in the creation and placement process, for subsequent historical review.

In facilitating the creation, management, and placement of reinsurance, the system and method of the present invention support the collaboration of cedents and reinsurers within a one-to-many relationship market-network, which can be defined as the sum of human relationships, market behavior, accepted processes, and (increasingly) electronic infrastructures that comprise the way of doing business. The market-network becomes viable through the collaborative involvement of its participants.

The present invention provides cedents with the processes, tools, and data transparency that they need to manage their reinsurance portfolio and to purchase reinsurance in a cost-effective way and under competitive market conditions. Accordingly, a cedent can manage and monitor a worldwide generation or renewal of a reinsurance portfolio—from the creation of a submission and an initial reinsurance offer, through the tender stage, to the final acceptance of prices and shares. The present invention supports both centralized and decentralized business decision-making models in the reinsurance creation, management, and placement process.

Based on this method and system, the present invention eases the collection of structured or unstructured data from business units, provides a cedent with an overview of its local reinsurance coverages on a global basis, and distinguishes participants for each treaty or program. The present invention also enables a cedent to guide the business processes and monitor defined responsibilities, ensuring that deadlines are met. It supports benchmarking of reinsurance quotes by compiling quotes received from the market into an overview, thereby streamlining the collaborative decision-making process. The present invention is also customizable to suit an individual cedent's unique business model, processes, or reporting needs. The present invention also provides full control and security of the cedent's data/information exchanged with the reinsurer.

An embodiment of the present invention includes one or more of the following novel features:

The capture of the entire cedent's reinsurance creation and placement business process on a unified platform that involves all required players of the cedent;

Having the invention customizable to the cedent's business process according to the standards desired by the cedent;

The storage of each and every step in the process for historical review; and

The storage of every discussion stream associated with business opportunity and program.

### DEFINITIONS

The following definitions are provided for clarity in understanding this specification. It should be understood, however, that the terms defined below and used throughout the specification and claims may have equivalent terms known to those skilled in the field of reinsurance. For example, what is generally referred to as a “program” in the U.S. reinsurance market is generally referred to as a “renewal” in the European reinsurance market. For this reason, the specification and the claims should not be limited to the particular terms used, but instead should be read to broadly encompass all equivalent terms known to those skilled in the art.

Annual Aggregated Deductible (AAD): This is an additional deductible—this time at the layer level, which is first deducted from the sum of all losses occurring within the layer during the year, to arrive at the claim amount. AAD is the liability of the cedent and represents a floor. For example, if total loss amounts on layer 1 are $17 million and there is an AAD of $3 million, the net loss amount payable by the reinsurer is $14 million and the cedent pays the $3 million in addition to the original retention.

Annual Aggregated Limit (AAL): This represents the maximum amount for which the reinsurer is liable, after taking into account the claims over a whole year. In effect, this represents a cap on the reinsurer's liabilities. For example, consider $10 million xs $10 million with an AAL of 10 million and claims of $15 million, $25 million, and $15 million. This equates to reinsurer payments of $5 million, $10 million, and $5 million. With the AAL, however, the reinsurer pays only 10 million and the cedent pays the remainder as well as the retention.

Broker: A professional intermediary (person or organization) that, in return for a commission or fee, brings together buyers and sellers of (re)insurance, advises on (re)insurance needs, and negotiates (re)insurance with (re)insurers. Normally, commission is received from the (re)insurer in consideration for brokering or placing the business with them, but fees may also be charged by brokers to their clients. The term is also used to denote the fee paid to a broker who arranges reinsurance cover for a ceding office.

Business Opportunity: An umbrella type concept used for the grouping together of related programs.

CAT XL: Catastrophe excess of loss reinsurance. Excess of loss reinsurance for catastrophe risks in which retention and limit of liability apply to the sum of all losses arising from the same event; unlike WXL/E coverage, a Cat XL is structured so that coverage only applies when two or more risks are affected by a single event.

Commission Type: Commission Type (“fix” or “var”) for proportional treaties determines applicability of other commission fields. “Fix” implies that a pre-determined percentage of ceded premiums will be paid to cedent. “Var” implies that the actual commission percentage will be determined retrospectively based on the loss ratio (claims/earned premiums) actually experienced. In this case, maximum (“max”) and minimum (“min”) commission percentages as well as associated min and max loss ratios will be specified. At the start of the year, the provisional commission (falling between the min and max commissions) will be used. At the end of the year, the final commission is known.

Cover: Protection against losses provided under the terms of an insurance or reinsurance contract. This is the reinsurer's liability amount in the event of a claim that exceeds the deductible.

Deductible: In excess of loss reinsurance, the amount of loss retained by the reinsured before the liability of the reinsurer attaches. Within a program, it is the amount at which each layer comes into play. Also called the excess (xs) point or priority.

Deposit Premium: Premium based on an estimate of the final premium and paid at the beginning of a contract, which provides for future premium adjustments.

EPI: Estimated premium income ceded to reinsurers (for proportional programs).

Geographical Inclusions/Exclusions: The geographical scope of the program, which may be amended at the layer level by including and/or excluding countries or regions.

Geographical Scope: Countries/regions (territorial risk) covered by a program.

GNPI (Gross Net Premium Income): Gross premium written by the cedent, less premiums ceded for proportional reinsurance; no deduction is made for expenses.

Layer: Section of cover. Mainly used in excess of loss reinsurance, where total coverage may be divided into a number of consecutive layers that can be placed with different reinsurers and have different loss profiles (lower layers attach more often and are thus more expensive).

Layer Option: A variation on a particular layer within the same program, resulting in different financial rates. For example, layer 1 option 1 includes fire and water, while layer 1 option 2 includes only fire.

Leader: Reinsurer chosen based on its reputation or size to lead other reinsurers in underwriting major risks and which usually assumes the largest share; the leader often agrees on terms and conditions and assumes responsibility for administering a shared contract.

Line of Business: Classification or grouping of insurance coverages which provide protection for similar risks; e.g., property, casualty, life, etc.

Loading: Additional amounts of premium above the underwriter's normal risk premium to allow for future administrative expense, loss escalation, and a reasonable profit margin on non-proportional contracts (with VAR rate type).

Management Expenses/Administration Expenses: Percentage of written premiums specified in the special conditions of a proportional reinsurance contract (typically 5%, to offset administrative costs), which the reinsurer deducts from its result before calculating the amount of profit commission it owes the cedent.

Minimum Premium: Smallest amount of premium for which a (re)insurer will issue coverage under a given policy.

Negotiation Phase: The negotiation phase starts after the reinsurers have provided initial quotes to the cedent. The cedent decides on preferred participants and conducts a period of negotiation of allocated share and, possibly, rate. The end result of negotiation is an agreed written share.

No Claims Bonus: A reduction of premium, expressed as a percentage of ceded premium, allowed at the time of renewal to an insured that has made no claim in the previous period or periods of insurance.

Number of Lines: In surplus reinsurance, the amount of liability retained by the reinsured. Each surplus layer of reinsurance is expressed as a multiple of the cedent's retention. For example, a “four-line” surplus share treaty affords reinsurance for four times the “retention” (i.e., the liability retained by the cedent). This enables the cedent to write five times as much insurance as was possible before reinsurance. For example, if the reinsured retained a maximum of $100,000 liability per policy in a given class of insurance, but wished to write policies for a maximum of $500,000 per policy, a four-line surplus share treaty would accomplish the objective: it would provide $400,000 of treaty capacity, with losses shared 1-to-5 by the reinsured and 4-to-5 by the reinsurer, beginning with the first dollar of loss.

Percent Ceded: Percent ceded by the primary insurer for quota share treaties. The cedent and reinsurer share costs, liabilities, and premiums in the ratio specified.

Perils: Risks associated with a program. Main perils are defined at the program level, but may then be amended at a layer level.

Premium: Amount paid to the reinsurer by the insurer for the accepted risk.

Premium Type: The Premium Type (Fixed, Flat, or Var) determines the relevant quotation fields for non-proportional layers. “Fixed” implies that a single percentage rate of actual GNPI will determine the reinsurance premium. “Flat” implies that a pre-determined amount will comprise the reinsurance premium. “Var” implies that a range of percentages (with minimum and maximum percentage values, again tied to the GNPI) will determine the reinsurance premium. At the end of the year, when the definite GNPI value is known, the burning cost will determine the final fixed percentage rate within the variable minimum and maximum rates.

Profit Commission: An additional commission the reinsurer pays to the client depending on profitability (based, for example, on a percentage of the profits, where profits=ceded premiums—claims—commission—incurred reinsurer mgmt expenses) or some other characteristic of the business written.

Program Name: Defines a unique program name for the program.

Program Option: A variation on a particular program quote, resulting in a different financial offer. For example, program ‘A’ has two layers and program ‘B’ has three layers.

Quota share: Proportional reinsurance. The quota share treaty is an obligatory ceding treaty; that is, a formal agreement entered into between two parties—the reassured and the reinsurer—under which the reassured is obliged to cede a fixed percentage of all business covered by the treaty and the reinsurer is obliged to accept all cessions so made. There may be limitations to the cover in respect of natural perils and/or in respect of sums insured. A reinsurance commission will be retained by the cedent to recompense for acquisition and costs.

Quotation Phase: The quotation phase allows the underwriter to enter values such as risk rate, technical rate, and breakeven rate. At the end of the quotation phase, the reinsurer provides a rate and share to the cedent.

Reinstatement: Additional cover to restore the limit of a non-proportional reinsurance contract to its full amount after a loss. One reinstatement equals the full amount of the original cover. The number of reinstatements can be limited/unlimited, free/with cost, and use one of three prorata methods (temporis, amount, or both)

Share: The proportion, as a percentage, of the total risk undertaken by the reinsurer. During the renewal process, the share provided by the reinsurer to the cedent is captured during the quotation phase, at the end of the negotiation phase, and finally at the end of the signing phase.

Signing Phase: The signing phase is the final phase in the treaty renewal process. The final signed share (which normally is identical to the written share) is entered.

Subject to NoC: The participants involved in a multi-year or continuous program define a period known as Subject to Notice of Cancellation, where either party has the right to cancel the program.

Surplus: Proportional reinsurance in which the cedent shares the risk with the reinsurer on a pro rata basis. The proportion of the risk retained by the cedent is defined as a percentage of their maximum retention (=maximum or one line) to the sum insured of the risk. The maximum cession to the surplus treaty is usually expressed as a certain number of lines. There may be a second, third, or more surplus treaty to provide automatic capacity for risks with higher sums insured, which exceed the capacity provided by a first surplus treaty. Surplus is one of the oldest forms of treaty reinsurance and still very common in property reinsurance. Premiums and losses are shared pro rata, according to the individual proportion of cover for each risk.

Treaty Capacity: Limit of liability of the reinsured against the insured. Maximum amount of coverage that can be offered by a (re)insurer over a given period, based on underwriting policy, financial strength, and market conditions. Specific underwriting capacities may apply to single loss events or single risks. The limit of capacity may also be imposed by law or by a regulatory authority. Reinsurance provides insurers with additional underwriting capacity to help them accept larger risks than would otherwise be possible and sometimes also to accommodate existing policyholders by transacting types of business the insurers would normally prefer to avoid.

Type of GNPI: Flag indicating state of GNPI (either “written” or “earned”).

Type of Treaty: Defines the type of treaty (e.g., CAT XL or Surplus) of the program.

WXL/Event: Working excess of loss per event. This is valid for non-proportional insurance. Working excess of loss reinsurance in which retention and cover apply to the sum of all losses arising from the same event. Unlike a Cat XL, there is no two-risks warranty and the deductible is low enough for coverage to be triggered by a single risk.

WXL/Risk: Working excess of loss per risk. This is valid for non-proportional insurance. Working excess of loss reinsurance in which the deductible and cover are applied individually for each risk, irrespective of whether losses derive from a single event.

### BRIEF DESCRIPTION OF THE DRAWINGS

FIG. 1 is a flowchart depicting the four phases of the reinsurance placement process, according to an embodiment of the present invention.

FIGS. 2A and 2B are schematic diagrams of exemplary system architectures for implementing the method of the present invention, according to an embodiment of the present invention.

FIG. 3 is a flowchart describing the four phases of FIG. 1 in more detail, according to an embodiment of the present invention.

FIG. 4 is a flowchart describing an exemplary method by which a cedent collects risk data and assesses reinsurance needs, according to an embodiment of the present invention.

FIG. 5 is a flowchart describing an exemplary method by which a cedent prepares renewal packages and dispatches the packages to reinsurers, according to an embodiment of the present invention.

FIG. 6 is a flowchart describing an exemplary method by which a reinsurer provides a reinsurance quote, according to an embodiment of the present invention.

FIGS. 7A and 7B are flowcharts describing an exemplary method by which a cedent and a reinsurer, respectively, evaluate quotes and negotiate reinsurance placement, according to an embodiment of the present invention.

FIG. 8 is a flowchart describing an exemplary method for completing the placement of reinsurance business, according to an embodiment of the present invention.

FIGS. 9A-9E are exemplary screen images through which a cedent manager creates a business opportunity, according to an embodiment of the present invention.

FIGS. 10A and 10B are exemplary screen images through which a cedent transactor collects and publishes risk data, according to an embodiment of the present invention.

FIGS. 11A-11G are exemplary screen images through which a cedent manager prepares and sends a reinsurance structure proposal, according to an embodiment of the present invention.

FIGS. 12A-12E are exemplary screen images through which a cedent manager creates a dispatch of a request for quotation, according to an embodiment of the present invention.

FIGS. 13A-13D are exemplary screen images through which the reinsurer provides a quotation for the program proposed by the cedent, according to an embodiment of the present invention.

FIGS. 14, 15, 16A, and 16B are exemplary screen images through which a cedent receives quotations returned by reinsurers, according to an embodiment of the present invention.

FIGS. 17A-17C are exemplary screen images through which a cedent manually enters a quotation returned by a reinsurer, according to an embodiment of the present invention.

FIGS. 18A-18C are exemplary screen images through which a cedent manager compares quotations of reinsurers, according to an embodiment of the present invention.

FIG. 19 is an exemplary screen image through which a cedent manager prepares participation conditions to be negotiated with reinsurers, according to an embodiment of the present invention.

FIGS. 20A-20C illustrate the contents of an exemplary downloaded file for a request for written share, according to an embodiment of the present invention.

FIGS. 20D and 20E illustrate exemplary screens through which a reinsurance officer manually enters written shares, according to an embodiment of the present invention.

FIGS. 21A and 21B are exemplary screen images through which a cedent manager receives offered written shares returned by reinsurers, according to an embodiment of the present invention.

FIG. 22A and 22B are exemplary screen images through which a cedent manager reviews all offered written shares returned by reinsurers and assigns final shares, according to an embodiment of the present invention.

FIGS. 23A and 23B are screen images illustrating the contents of an exemplary downloaded file for the confirmation of final signed shares, according to an embodiment of the present invention.

FIGS. 24A and 24B are exemplary screen images providing program and portfolio reports for a cedent, according to an embodiment of the present invention.

FIGS. 25A-25C are exemplary screen images through which a reinsurer can copy an existing program into a new program, according to an embodiment of the present invention.

FIG. 26 is an exemplary screen image illustrating an exemplary mouse-over text help feature, according to an embodiment of the present invention.

### DETAILED DESCRIPTION OF THE INVENTION

An embodiment of the present invention is a process manager, document management system, and collaboration platform for the creation, management, and placement of a reinsurance portfolio. The present invention accompanies the involved individuals of all parties throughout the reinsurance portfolio creation, management, and placement process, and facilitates their interactions in a standardized, yet customizable, fashion—including the management and storage of related documents and data.

All cedents and reinsurers have traditions that they are not willing to give up. This reality is due to their hierarchical structures, their established internal business processes, and the existing software they are using for functions such as treaty administration, accounting, and pricing. To take these idiosyncrasies into account, the process manager of the present invention includes two systems: a cedent system and a reinsurer system. Each system can be highly customized, to adapt to the requirements of each party.

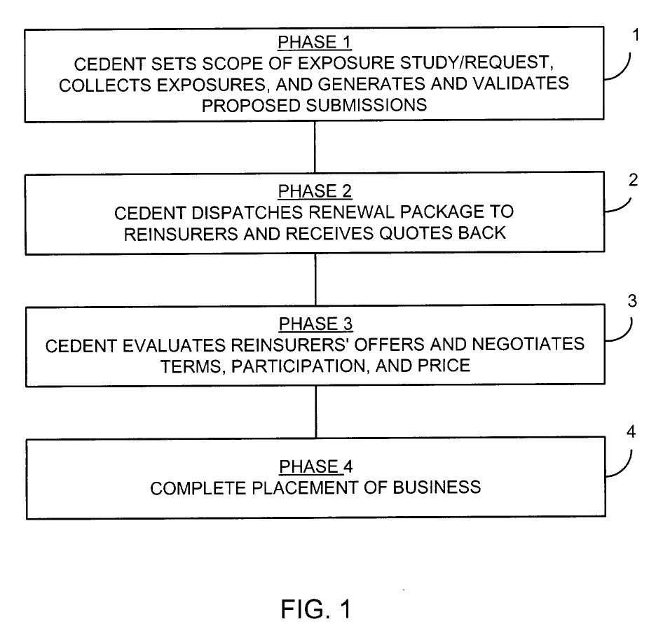

FIG. 1 summarizes an exemplary reinsurance creation, management, and placement process, according to an embodiment of the present invention. As shown, the process includes four phases.

In phase 1, a cedent sets parameters for a reinsurance study or request, and collects exposures, or risk data, to assess whether the cedent needs reinsurance. If the cedent determines that there is a need for reinsurance, then the cedent generates and validates proposed submissions, which include one or more proposed submission programs. The programs each provide the data and documentation that reinsurers will need to provide a corresponding quotation/offer for reinsurance. At the conclusion of phase 1, the proposed submissions and programs are approved and ready to include in a renewal package for distribution to the market.

In phase 2, the cedent dispatches the renewal package to one or more reinsurers. Upon receipt, the reinsurers evaluate the renewal package, prepare quotations, and dispatch those quotations back to the cedent. At the conclusion of phase 2, the cedent has imported or entered into its system responses to requests for quotation from the one or more reinsurers.

In phase 3, the cedent evaluates the reinsurers' quotations, compares quotations received from different reinsurers (if more than one reinsurer participates), and consults with the reinsurers to negotiate for the most favorable reinsurance program conditions (e.g., terms, participation, and price). The cedent decides upon a final reinsurance program structure and price. The cedent dispatches requests for written shares to chosen reinsurers, in which the cedent may propose participation amounts. At the conclusion of phase 3, the cedent has received reinsurance proposals for written shares.

In phase 4, the cedent evaluates the proposed participations in light of the agreements reached in phase 3, and decides on and captures final shares. At the conclusion of phase 4, the cedent and the chosen reinsurers sign off on a final share, price, and conditions, thus completing the placement of the reinsurance business.

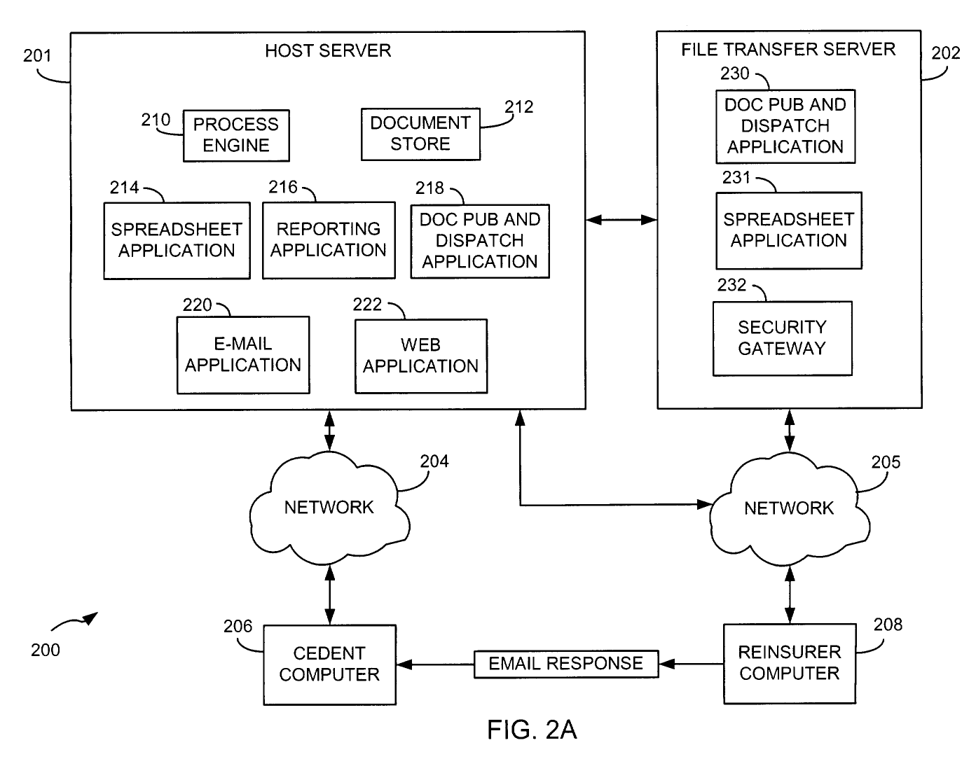

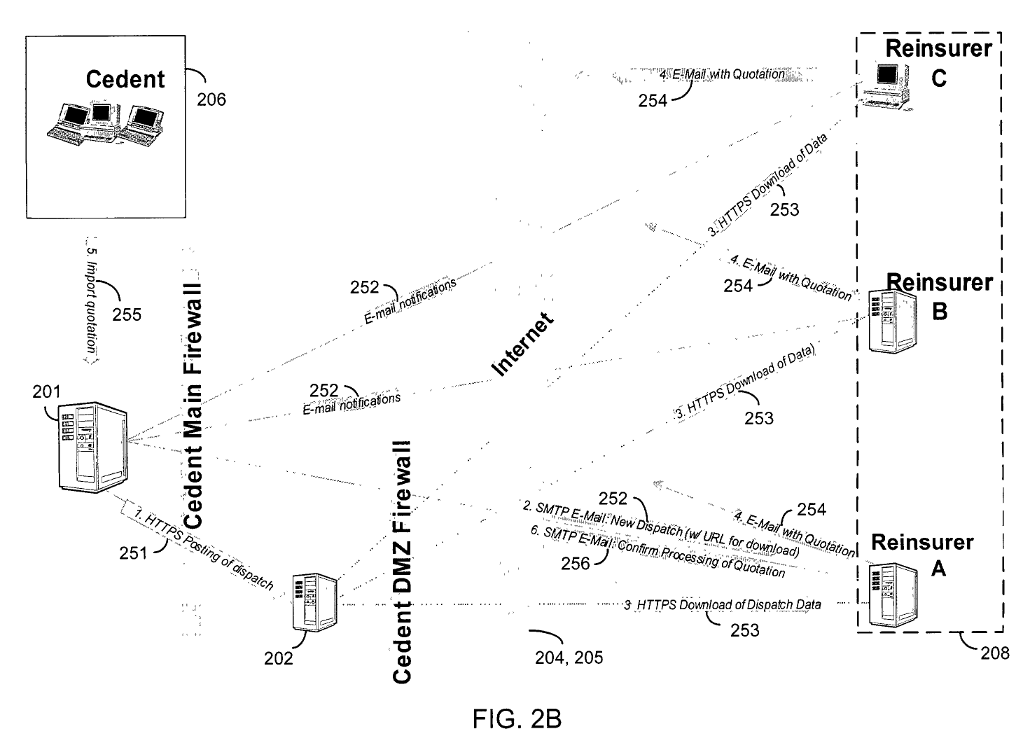

FIG. 2A illustrates an exemplary system 200 for implementing the process shown in FIG. 1. As shown, system 200 includes at least one cedent computer 206 in communication with a host server 201 through a computer network 204. Host server 201 is, in turn, in communication with a secure file transfer server 202 through, for example, a local area network (LAN). Computer network 204 is, for example, the Internet.

Host server 201 executes the process of the present invention for the cedent. Host server 201 also stores data associated with the cedent's reinsurance creation, management, and placement process and is adapted to communicate with cedent computer 206 using e-mail, document publishing, and Web browsing, as well as with secure file transfer server 202 using a secure file transfer. Host server 201 communicates with reinsurer's computer 208 using, for example, e-mail via network 205, for notifying reinsurers of the availability of dispatch data stored on secure file transfer server 202.

Cedent computer 206 displays the graphical user interface (GUI) through which a cedent interacts with host server 201 and completes the process of the present invention. Web application 222 provides the GUI to cedent computer 206. This cedent GUI is referred to herein as the cedent interface. Cedent computer 206 does not require special software, other than a browser.

Upon dispatch of a renewal package, host server 201 creates files for each selected reinsurer and stores the program quote sheet and additional documentation to secure file transfer server 202. Host server 201 sends a notification to the computers of reinsurers 208 through network 205, which could be the same network as network 204. Host server 201 also communicates with reinsurer computers 208 through network 205, with web application 222 providing a GUI to reinsurer computers 208. Optionally, instead of a browser-based interface provided by host server 201, reinsurer computers 208 could be provisioned with an interface application that cooperates with file transfer server 202 to download data and store it locally on reinsurer computers 208. In any case, the reinsurer GUI is referred to herein as the reinsurer interface.

In a specific implementation of the present invention, reinsurer computers 208 do not require special software, other than a browser. Reinsurer computers 208 receive communications from host server 201 and cedent computer 206 using, for example, e-mail to receive notifications of requests for quotation and to return offers and shares.

In the case in which a cedent places reinsurance within its own legal entity (i.e., the insurance company consolidates its insurance into its own reinsurance company or division), network 205 could be a corporate intranet in direct communication (i.e., not through a public network) with host server 201.

Although computers 206 and 208 are labeled cedent and reinsurer, respectively, one of ordinary skill in the art would appreciate that brokers or other representatives of the cedent and reinsurer could be users of computers 206 and 208. Likewise, any references herein to cedents and reinsurers should be interpreted to include any other possible representatives of these parties. For example, reinsurers could also include managing general agents and brokers. In a preferred embodiment, however, only cedents have access to cedent computer 206 and host server 201, and not reinsurers.

As shown in FIG. 2A, an exemplary host server 201 contains several applications to execute the processes of the present invention, including, for example, a process engine 210, a document store 212, a spreadsheet application 214, a reporting application 216, a document publishing and dispatch application 218, an e-mail application 220, and a web application 222. Host server 201 could also include a security gateway. An exemplary file transfer server 202 contains several applications to store and administer dispatch information, including, for example, a document publishing application 230, a spreadsheet application 231, and a security gateway 232.

Process engine 210 controls information flow between the participating cedent parties to execute the processes of the present invention. An example of a suitable process engine 210 is ActionWorks™ produced by Action Technologies, Inc. of Alameda, Calif.

Document store 212 stores files and related metadata, for example, on host server 201 or a Structured Query Language (SQL) database on host server 201.

Spreadsheet application 214 creates spreadsheets on which structured renewal data is imported. With the data imported, file transfer server 202 distributes the spreadsheets to the reinsurers, which then provide quotations on the spreadsheets.

Reporting application 216 provides summarized and detail reports of cedent and reinsurer data stored on host server 201 for the cedent. In presenting the reports to the cedent, reporting application 216 cooperates with the cedent interface provisioned on cedent computers 206.

Document publishing and dispatch application 218 prepares one dispatch file per reinsurer as selected by the cedent and sends all of them to secure file transfer server 202. Application 218 enables a user to associate, attach, delete, copy, and view documents. Application 218 is, for example, an Active Server Page (ASP) application. In an embodiment of the present invention, document publishing and dispatch application 218 is accessible through two GUI mechanisms, which both include folder tabs that display the contents of document folders for a given reinsurance business opportunity or program. In the first mechanism, a publishing icon within a program or business opportunity view, when selected, shows documents for the relevant program or business opportunity. In the second mechanism, for “draft documents” (business opportunity level) or “documents,” a user can “browse” programs and business opportunities in a database using pop-down menus (populated by an ASP query of relevant business database). The ASP script displays eligible programs or business opportunities and allows users to select a program or a business opportunity to access the associated documents.

E-mail application 220 sends e-mails from host server 201 to computers 206 and 208. E-mail application 220 can use any of the well-known protocols for sending and receiving e-mail, e.g., Simple Mail Transfer Protocol (SMTP), Post Office Protocol 3 (POP3), and Internet Message Access Protocol (IMAP).

Web application 222 receives and responds to HTTP requests from computers 206. An example of a suitable web application 222 is a Microsoft Internet Information Server™.

File transfer server 202 stores the files of programs that have been dispatched to the reinsurers. In an embodiment of the present invention, as a program is dispatched to selected participants from host server 201, application 230 creates separate directories on file transfer server 202 for each reinsurer (accessible by the reinsurer with a unique username and password) in which that particular reinsurer's dispatch files are stored. The dispatch files are preferably self-extracting, compressed files, containing Excel spreadsheets and supplemental documents. In response to e-mail notifications sent from host server 201, the reinsurers download the dispatch files from file transfer server 202. The e-mail notifications can include URL links to file transfer server 202 itself (opening this URL link commences the download) as well as the e-mail address of the cedent to which the quotation responses should be sent.

By maintaining file transfer server 202 apart from host server 201, the present invention ensures that reinsurers do not have access to confidential cedent information (e.g., risk data) stored in host server 201. The separate file transfer server 202 also simplifies file structures and helps avoid capacity problems that might arise if the dispatch files were stored together with the applications of host server 201. In addition, separating host server 201 and file transfer server 202 helps prevent an unauthorized user who has breached the security provisions of file transfer server 202 from reaching the applications operating on host server 201.

Of course, notwithstanding these benefits, one of ordinary skill in the art would appreciate that host server 201 and file transfer server 202 could be a single server. In addition, although FIG. 2A shows multiple functions provisioned on host server 201 and file transfer server 202, as one of ordinary skill in the art would appreciate, the functions could be distributed among multiple servers (e.g., tiered architecture).

With the reinsurance process of FIG. 1 and the system architecture of FIG. 2A in mind, FIG. 2B illustrates an exemplary system and method for performing dispatches to reinsurers and for receiving corresponding responses. These dispatches can involve, for example, requests for quotations, requests for written shares, or requests for final signed shares. The method begins with structuring the parameters of the dispatch on host server 201, including the selection of renewal programs and participants. Then, as shown in step 251 of FIG. 2B, the method continues by dispatching a program(s) from host server 201 to file transfer server 202. Then, in step 252, host server 201 forwards e-mail notifications to the reinsurers 208, informing them of the new dispatch and preferably providing a URL link through which to access (e.g., download or copy) the dispatch files.

In a specific implementation of the present invention, step 251 of FIG. 2B involves creating an Excel Spreadsheet (for “structured” data) for a reinsurer by querying relevant data from host server 201 and inserting this data into a new spreadsheet based on an Excel template. An XML file can also be created simultaneously. This process is performed by code in embedded in process engine 210. Process engine 210 then copies relevant folders out of document publishing folders into a staging area and zips them together with the Excel file into a self-extracting archive. The zipped file is then pushed onto file transfer server 202 and copied into the directory for each selected participant. The target directory on this server 202 is linked to the reinsurer recipient. Finally, host server 201 forwards to the reinsurer recipient an e-mail containing the URL of the appropriate download point on file transfer server 202.

Continuing in step 253, after preferably providing identifications and passwords necessary to connect to file transfer server 202, the reinsurers 208 download the dispatch data, including, for example, program documents and a spreadsheet file in which to enter a quotation. The reinsurers analyze the data, perform off-line calculations, and enter quotations in the spreadsheet file. Then, in step 254, each reinsurer e-mails the spreadsheet file to the cedent 206.

In step 255, cedent 206 imports the quotation from each reinsurer into host server 201. This import can simply involve the cedent 206 typing in the quotation manually into the reinsurance program stored on host server 201. Preferably, however, the import is at least partially automatic such that the content of the spreadsheet file is entered automatically into the reinsurance program. In this case, cedent would load the spreadsheet file into host server 201. The spreadsheet could include an identifier that indicates the program and cedent to which it pertains (this identifier would have been included in the download to the reinsurer in step 253). Then, recognizing this identifier, host server 201 would associate the quotations with the appropriate reinsurance program and cedent.

In a further embodiment of the present invention, before associating the quotation with the appropriate reinsurance program and cedent, host server 201 performs a plausibility check on the program structure and quotation to ensure that the program structure is unchanged and that the entered values make sense. For example, the plausibility check may test for overlapping deductibles or for an attachment point on a layer that is higher than the sum of the cover and the deductible on a preceding layer. If an error is found, host server 201 could alert the cedent, in which case the cedent could e-mail the request for quotation back to the appropriate reinsurer for correction, or do so manually.

With the quotations imported and re-associated with the program, host server 201 then provides cedent 206 with software tools for analyzing the quotations and continuing with the reinsurance placement process (for example, with further program dispatches and/or dispatches of requests for written shares and signed shares). As an optional step 256, after the quotations have been imported into host server 201, host server 201 can send an e-mail notification to one or more of the reinsurers confirming the processing of the quotations.

FIG. 2B illustrates a dispatch system architecture in which host server 201 and file transfer server 202 reside at the facilities of cedent 206 behind cedent firewalls 260 and 261. In an alternative embodiment, however, host server 201 and file transfer server 202 reside at the facilities of a third-party administrator. In this alternative architecture, both host server 201 and file transfer server 202 communicate with cedent computers 206 and reinsurer computers 208 through one or more firewalls (e.g., internal and external firewalls) and the Internet, network 204 and 205.

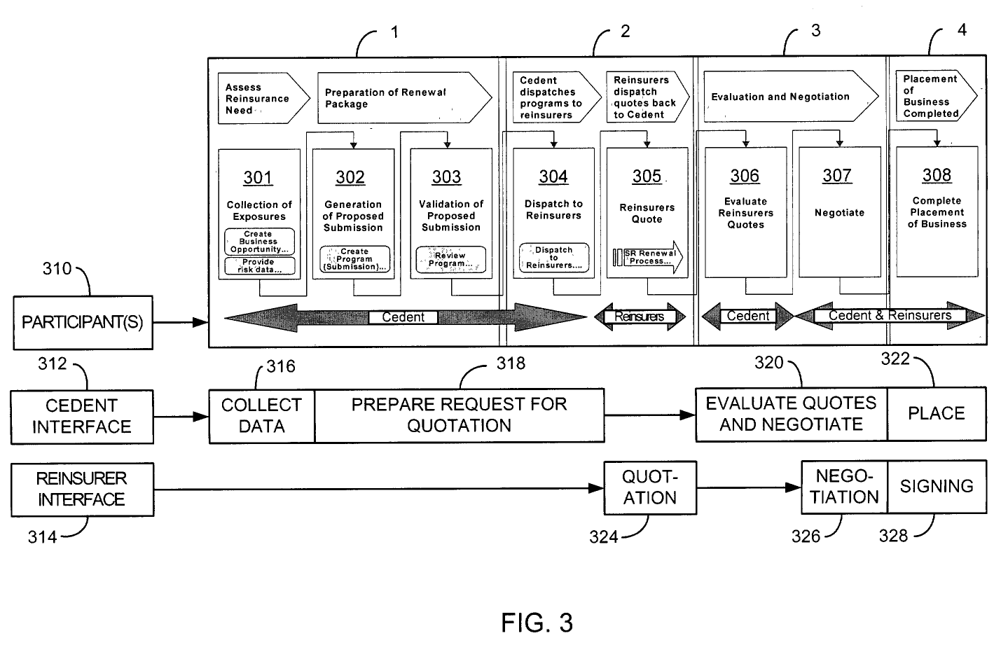

According to a further embodiment of the present invention, FIG. 3 illustrates in more detail the four phases 1, 2, 3, and 4 of the reinsurance process (as shown in FIG. 1). Specifically, FIG. 3 illustrates the individual steps of each phase of the reinsurance creation, management, and placement process, tracing the process from the assessment of a cedent's reinsurance needs through to the placement of the reinsurance business. FIG. 3 also shows the participants 310 involved in each step (i.e., the cedent and/or the reinsurer), the interface that a participant uses in each step (i.e., cedent interface 312 or reinsurer interface 314), and the particular phase in which the interface operates for a given step. To provide a graphical correlation, in FIG. 3, the participants and the interfaces corresponding to a step are listed under the block representing the step.

Within the processes of FIG. 3, the participants 310 that are completing the steps can freely move back to any previous action within a given phase (i.e., phases 1, 2, 3, and 4). This process flow allows loops and iterations to take place. In one embodiment, however, after a participant completes the steps of a phase, the steps of a previous phase cannot be performed again. In another embodiment, a participant cannot start a step without fully completing the prior step. This latter embodiment would prevent, for example, a user from entering a proposed submission before all risk data is collected and made available.

Cedent interface 312 and reinsurer interface 314 are the user interfaces through which participants 310 interact to complete the process of FIG. 3. As shown, the cedent interacts with cedent interface 312 through four stages: collect data 316, prepare request for quotation 318, evaluate quotes and negotiate 320, and place business 322. A reinsurer interacts with reinsurer interface 314 through three stages: quotation 324, negotiation 326, and signing 328.

By showing phases, steps, participants, and stages on concurrent lines of progression from left to right, FIG. 3 illustrates how each of the stages of cedent interface 312 and reinsurer interface 314 corresponds to phases 1-4, to steps 301-308, and to participants 310. The concurrent lines of progression also show how the stages of cedent interface 312 correspond to the stages of reinsurer interface 314. Thus, for example, FIG. 3 shows that step 307 is a part of phase 3, that the cedent and the reinsurers are the participants 310 involved in step 307, that the cedent interacts with stage 320 of the cedent interface 312 during step 307, and that the reinsurer interacts with stage 326 of the reinsurer interface 314 during step 307.

To encompass the various business models and idiosyncrasies of individual cedents and reinsurers, FIG. 3 identifies participants 310 in a general fashion (i.e., cedent or reinsurer). It should be understood, however, that these participants 310 could be further subdivided to describe, for example, the roles, responsibilities, and authorizations associated with a particular cedent or reinsurer. Thus, for example, a cedent could customize the process shown in FIG. 3 by associating particular job titles or roles to the performance of steps in the process. As an example of this customization, the following table provides exemplary roles within the cedent and reinsurer organizations, including the level at which each role is active, and the responsibilities assigned to each role. As shown in Table 1, the two principal roles within the cedent and reinsurer are the manager and the transactor. The manager is an organizational unit (e.g., a person or group of persons) that makes decisions about reinsurance structuring and sales. The transactor is an organizational unit (e.g., a person or group of persons) that performs the operational execution. The managers and transactors can be further divided into sub-roles of individuals or groups, as shown in Table 1 below.

TABLE 1
Cedent and Reinsurer Roles

| | | Exemplary | Exemplary | |
|---|---|---|---|---|
| Participant | Exemplary Role | Sub-role | Level | Responsibility |
| Cedent: | Cedent manager: | Reinsurance | Global/ | Coordinates data |
| | organizational unit | Officer (RO) | Regional | collection, |
| | making decisions | | | negotiations, and |
| | about structuring and | | | final data |
| | buying reinsurance | | | exchange; |
| | | | | Structures |
| | | | | proposals |
| | | Lead | Global/ | Signs off |
| | | Reinsurance | Regional | |
| | | Officer (LRO) | | |
| | Cedent Transactor: | Profit Center | Local | Provides data |
| | organizational unit | Manager | | |
| | performing the | (PCM) | | |
| | operational execution | Observer (OBS) | Global or | Just allowed to |
| | | | Local | comment |
| Reinsurer: | Reinsurer manager: | Global Client | Global/ | Coordinates all |
| | organizational unit | Officer (GCO) | Regional | interactions with |
| | making decisions | | | cedent |
| | about structuring and | Global Client | Global/ | Determines prices |
| | selling reinsurance | Manager | Regional | and shares and |
| | | (GCM) | | signs off |
| | | Local Client | Local | Determines prices |
| | | Manager | | and shares and |
| | | (LCM) | | signs off |
| | Reinsurer Transactor: | Underwriter | Local | Provides technical |
| | organizational unit | (UW) | | quotes |
| | performing the | Observer | Global or | Just allowed to |
| | operational execution | (OBS) | Local | comment |

The following description of the process of FIG. 3 incorporates these exemplary roles and sub-roles. As one of ordinary skill in the art would appreciate, even though following description may discuss specific sub-roles completing steps, those steps could generally be completed by others of the same role or participant. For example, a step completed by a lead reinsurance officer could generally be completed by another type of cedent manager. In addition, the particular names given to the roles and sub-roles should not be interpreted as limiting the invention. Indeed, it is common for different insurance and reinsurance organizations to use different terms. For example, reinsurance officers are sometimes referred to as cedent officers, profit center managers are sometimes referred to as underwriter managers, and lead reinsurance officers are sometimes referred to as reinsurance managers.

As shown in FIG. 3, the reinsurance creation, management, and placement process begins in step 301 with the collection of exposures and the assessment of reinsurance needs. Specifically, through cedent interface 312, a reinsurance officer of the cedent collects reinsurance requirements. The reinsurance officer initiates this process by creating a “business opportunity,” which is an umbrella record that encompasses any insurance business area that could use reinsurance. The reinsurance officer may request that certain profit center managers collect risk exposure data, including any renewal-relevant information and documents, and provide this risk exposure data to the reinsurance officer. Upon receipt of the risk data, the reinsurance officer collates the risk data and evaluates the potential for reinsurance. If the reinsurance officer sees a need, then the process continues. If no need exists, then the process ends.

Assuming an opportunity or need for reinsurance exists, then, in step 302, the reinsurance officer creates one or more proposed submissions, or reinsurance programs. The reinsurance officer may then ask the profit center managers to review and attach any additional related information to the programs. Upon approval by the profit center managers, the reinsurance officer further consolidates the documentation and renewal data. At this any stage prior to dispatching the request to the marketplace, the reinsurance officer may optionally choose to electronically forward the draft reinsurance programs to certain reinsurers and/or brokers to solicit their feedback on the program structure and supporting documentation.

After the reinsurer/broker feedback is received and incorporated, in step 303, the receiving officer validates the proposed reinsurance programs by requesting a review of the programs by the lead reinsurance officer. In response to the lead reinsurance officer's review comments, the reinsurance officer modifies the proposed programs and designates the programs as ready for dispatch.

In step 304, the reinsurance officer or the lead reinsurance officer selects which programs, from among the pool of approved, released programs, should be dispatched to which reinsurer. In response, a communication (e.g., an e-mail) is sent to the corresponding reinsurers, making available a request for quotation package that contains the selected programs.

In step 305, the reinsurer reviews the request for quotation, prepares a quotation in response to the request, and returns the quotation to the cedent.

In step 306, the reinsurance officer of the cedent receives and compares the quotations from the reinsurers.

In step 307, the reinsurance officer consults with the reinsurers and negotiates the precise details and price of the reinsurance program(s). At the conclusion of these negotiations, the reinsurance officer captures the final program structure and prices. The reinsurance officer then selects reinsurers from whom the reinsurance officer wishes to receive a written share proposal and dispatches a request for written share to the selected reinsurers. In response, the reinsurers forward their written share proposals to the reinsurance officer.

In step 308, the reinsurance officer of the cedent receives and compares the written share proposals from the reinsurers, interacts further with the reinsurers as necessary, selects the final shares, and notifies the reinsurers of the placement of the reinsurance business. The reinsurance officer captures the final shares and dispatches these values plus any final electronic placement or contract data to the reinsurers. The result is a definite signed share and price. The reinsurance placement process concludes with the selection of final shares and notification of placement of the reinsurance business.

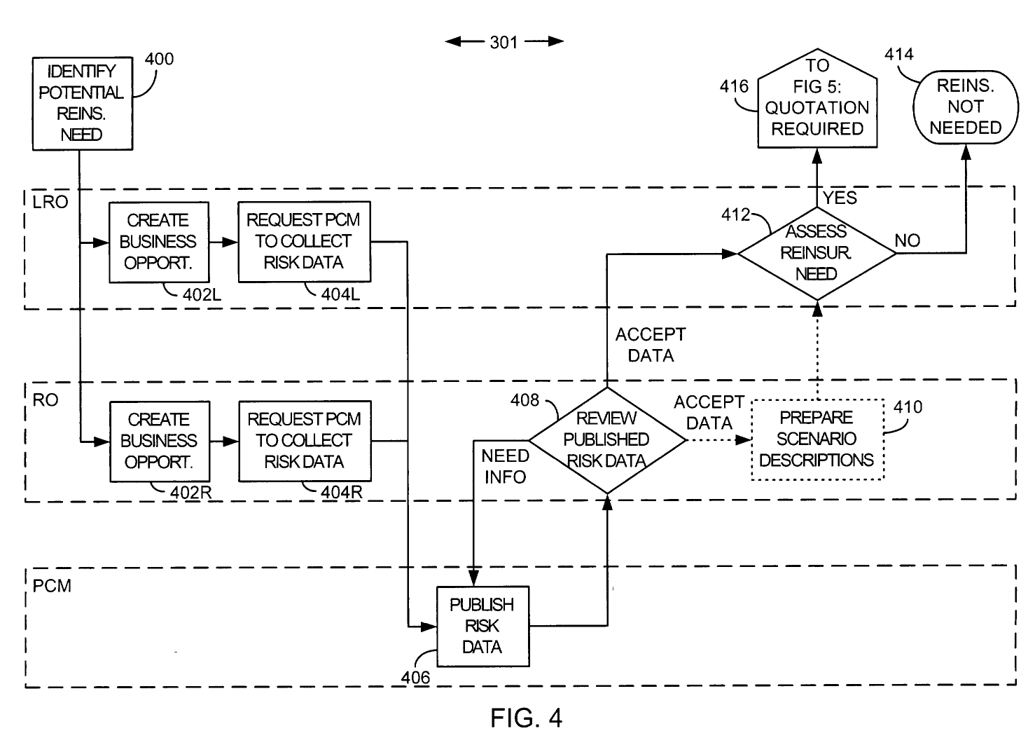

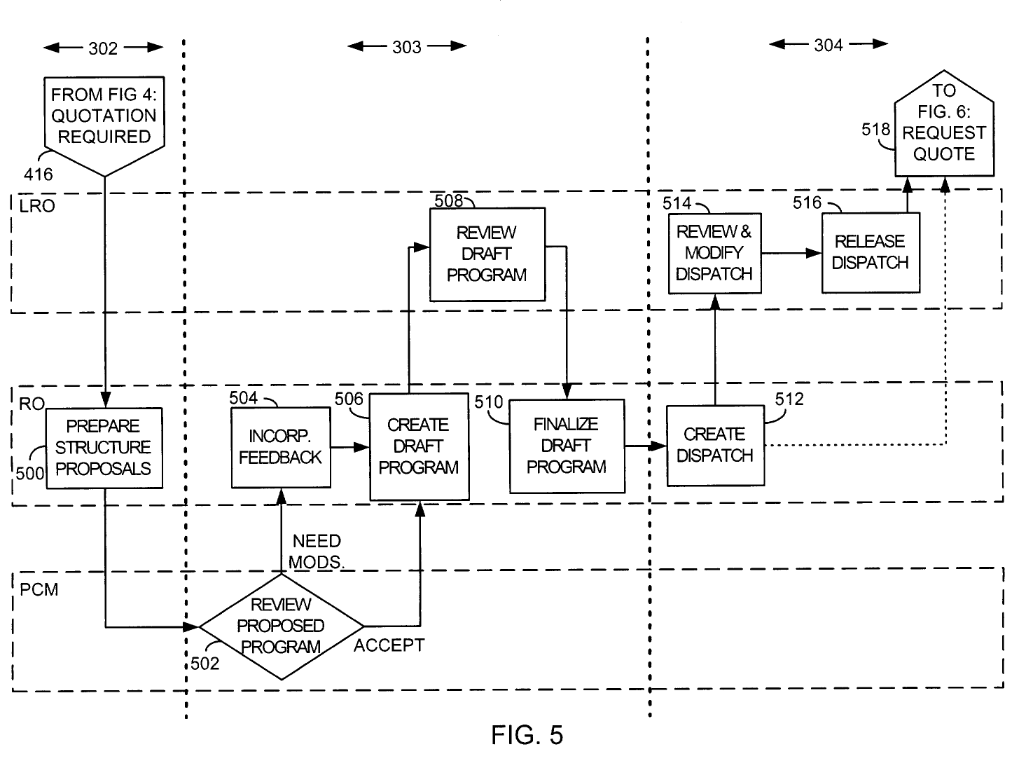

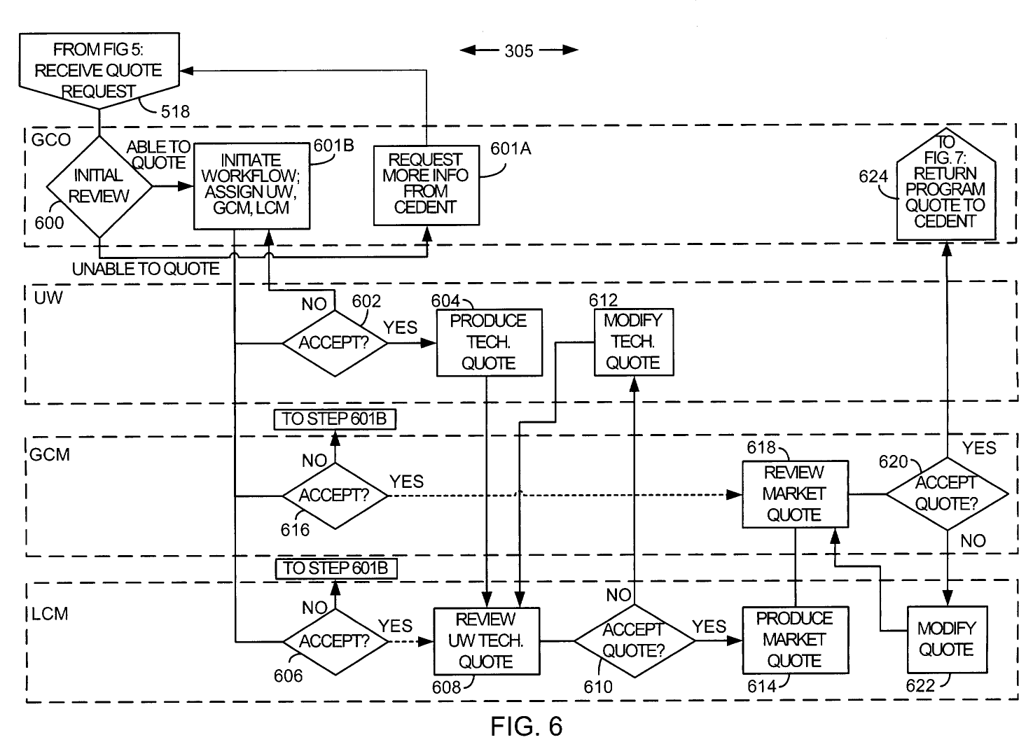

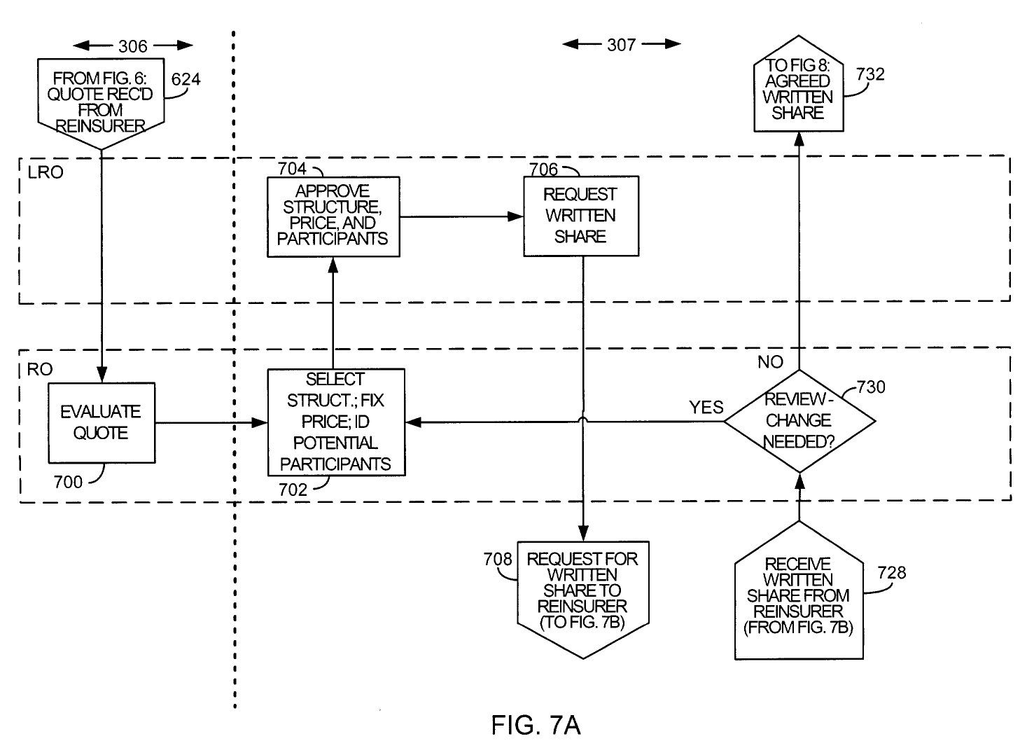

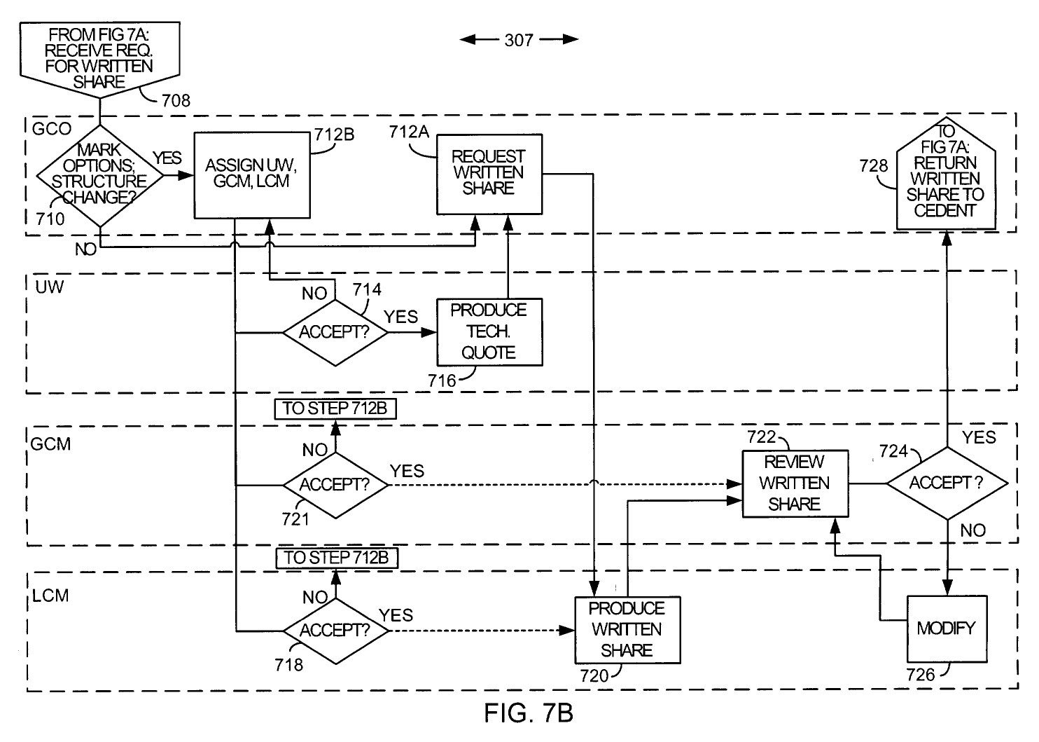

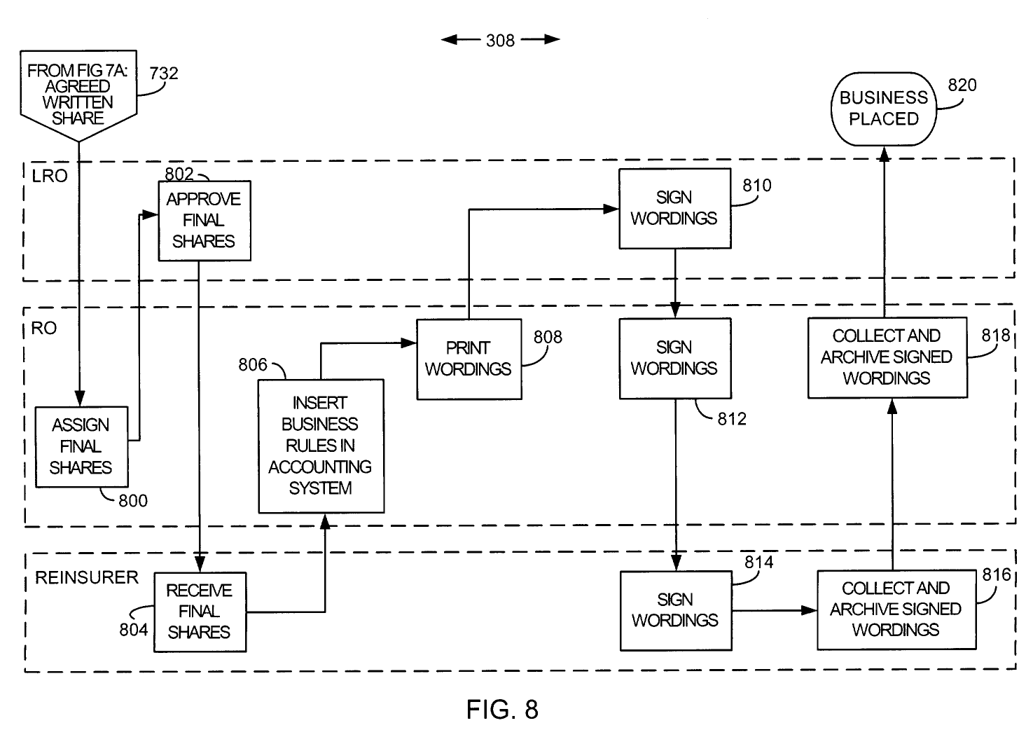

In a further embodiment of the present invention, FIGS. 4-8 describe in more detail steps 301-308 of FIG. 3. FIG. 4 is a flowchart describing an exemplary method for completing step 301 (i.e., collection of risk data and assessment of reinsurance needs). FIG. 5 is a flowchart describing an exemplary method for completing steps 302, 303, and 304 (i.e., preparation of a renewal package and dispatching of the package to reinsurers). FIG. 6 is a flowchart describing an exemplary method for completing step 305 (i.e., reinsurers quote). FIGS. 7A and 7B are flowcharts describing an exemplary method for completing steps 306 and 307 (i.e., evaluation of quotes and negotiation). Finally, FIG. 8 is a flowchart describing an exemplary method for completing step 308 (i.e., placement of business).

For purposes of the following descriptions relating to FIGS. 4-8, the term “unstructured” refers to data that is in no specific format. For example, unstructured data could be an unlimited amount of text or an attachment file. In this manner, a user can attach data in any format and can receive data in any format. In contrast to unstructured data, the term “structured” refers to data that adheres to a specific format. For example, structured data could be data entered into a data field of a limited length, data entered into a formatted list, or data entered into a formatted file. In this manner, a user can be required to enter data according to a specific format.

According to an embodiment of the present invention, at any stage within the entire processes of FIG. 3 (and the subprocesses of FIGS. 4-8), unstructured comments can be added and associated with a renewal. Any entered structured or unstructured data is permanently stored for historical review.

Phase 1, Steps 301-303

FIG. 4 outlines an exemplary method for the collection of data and the assessment of reinsurance needs (step 301 of FIG. 3). As shown, the method begins in step 400 with the selection of an insurance business that may be of a potential reinsurance need, which triggers the initiation of data requests in order to determine whether there is sufficient business or risk to initiate the reinsurance process. At this initial step, the cedent recognizes a potential need to transfer a part of the hazards or risks that the cedent has assumed to a second insurance carrier (the reinsurer).

After identifying a potential reinsurance need, the cedent manager of the cedent (e.g., either the lead reinsurance officer or the reinsurance officer) creates a business opportunity, as shown respectively in steps 402L and 402R. (The horizontal rows of FIG. 4 indicate which participant role (e.g., lead reinsurance officer, reinsurance officer, or profit center manager) within the cedent is completing the step.) The business opportunity defines the potential reinsurance need and serves as an umbrella record in which to organize and manage information relevant to the potential reinsurance need. The scope of the business opportunity is flexible and is defined by the cedent manager (e.g., the lead reinsurance officer or reinsurance officer). The business opportunity can lead to one or more future requests for quotation and reinsurance programs. In creating the business opportunity, the cedent manager can define specific qualifiers associated with the potential reinsurance need, such as lines of business or geographical areas. Unstructured data, such as questionnaires, documents, or templates of any file format, can be attached to the business opportunity.

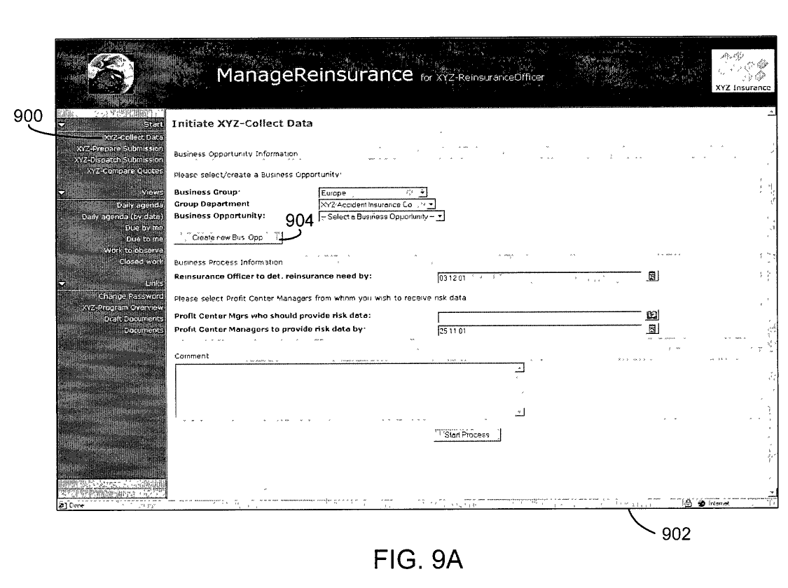

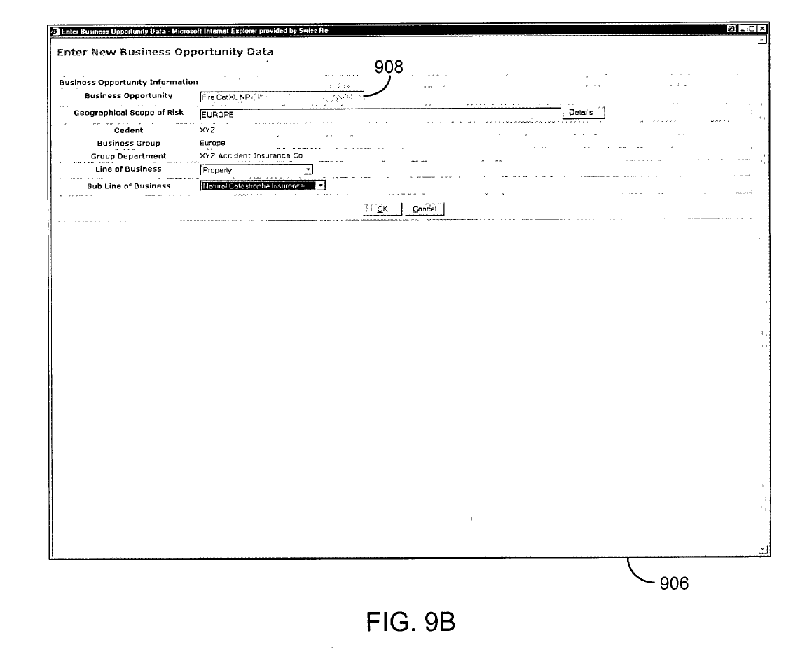

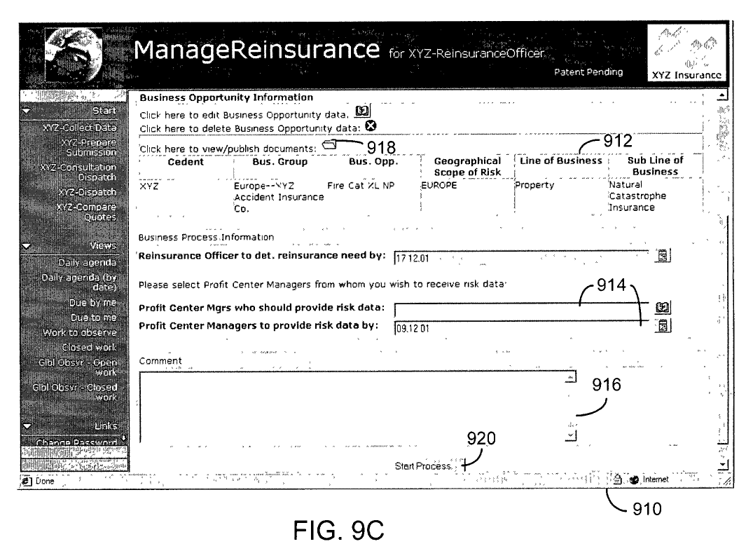

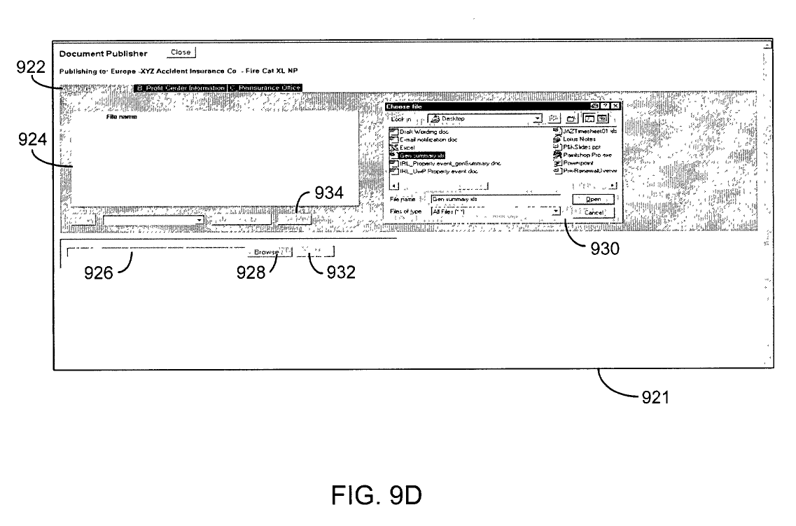

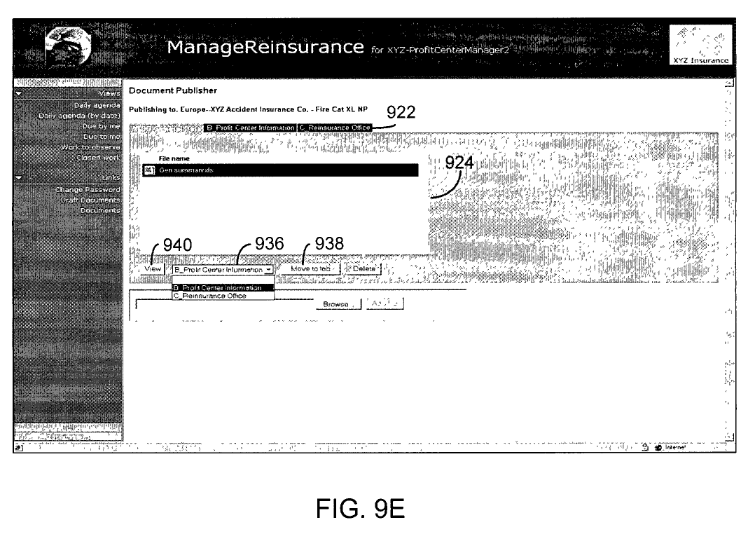

FIGS. 9A-9E illustrate a series of exemplary graphical user interfaces through which a cedent manager (e.g., a lead reinsurance officer or reinsurance officer) creates a business opportunity (i.e., completes step 402L or 402R). As shown in FIG. 9A, a user (e.g., cedent manager) first clicks on collect data button 900 to open the “Collect Data” screen 902. The user then selects an appropriate organizational structure and clicks on the “Create new Bus. Opp.” button 904. In response, the system presents the user with an “Enter New Business Opportunity Data” screen 906, as shown in FIG. 9B. The user is required to enter a business opportunity name in data field 908. The remaining data fields (e.g., geographical scope of risk, line of business, and sub line of business) can be left empty if unknown at this stage. Completion of these fields is required later if the user determines that reinsurance is necessary and creates one or more related programs. The data fields of FIG. 9B require structured input.

After the user names the business opportunity, the system presents the screen 910, as shown in FIG. 9C. In this screen 910, the cedent manager can add documents to the business opportunity and can designate the profit center managers who should provide the risk data. As shown, screen 910 provides a table 912 that summarizes the data associated with the business opportunity with which the user is working. Screen 910 provides data fields 914, in which the user selects the profit center managers responsible for providing risk data and specifies a deadline by which the profit center managers should return the data. Screen 910 also provides a comment data field 916, in which the user can add supplemental notes to be included in an e-mail communication sent to the selected profit center managers. The data fields of FIG. 9C require structured input.

Screen 910 also provides a document link 918. The user clicks on link 918 to access a document publishing feature, and to add documents to or view existing documents of the business opportunity. In response to the user's selecting link 918, the system presents a document publishing window 921, as shown in FIG. 9D. Through window 921, the user can add any type of document to the business opportunity. The documents are published into folders. The user clicks on one of folder tabs 922 to select a folder and display the contents of the folder in contents window 924 (which contains no documents in the example of FIG. 9D).

To locate a desired file, the user either types the path and filename in field 926 or clicks on the browse button 928. If the browse button 928 is activated, the system provides a browse window 930. The user navigates through window 930 and selects the desired file to be attached, which is then listed in field 926. Once the desired file is listed in field 926 (either by typing it or browsing and selecting), the user clicks the add file button 932 to attach the desired file to the business opportunity. The desired file is then listed in contents window 924.

To remove a file listed in contents window 924, the user highlights the file and clicks the delete button 934. As shown in FIG. 9E, an uploaded file can also be moved between folders 922 by highlighting the file in contents window 924, select the new folder to receive the file in drop down menu 936, and clicking the move button 938. To view a file, a user selects the file in contents window 924 and clicks the view button 940.

After the user adds the desired documents to the business opportunity, the user closes document publishing window 921 and returns to screen 910 of FIG. 9C. The user then clicks the start process button 920 to forward the business opportunity and its associated documents to the selected profit center managers. The selected profit center managers receive an e-mail notification. Returning to FIG. 4, this e-mail notification corresponds to step 404 L or 404 R, depending on whether a cedent manager (e.g., a lead reinsurance officer or a reinsurance officer) has created the business opportunity.

Continuing in FIG. 4, in response to the e-mail notification requesting risk data, in step 406, the profit center managers access the cedent interface, review any documents and data provided with the business opportunity, and then attach their own files containing reinsurance data pertinent to the business opportunity.

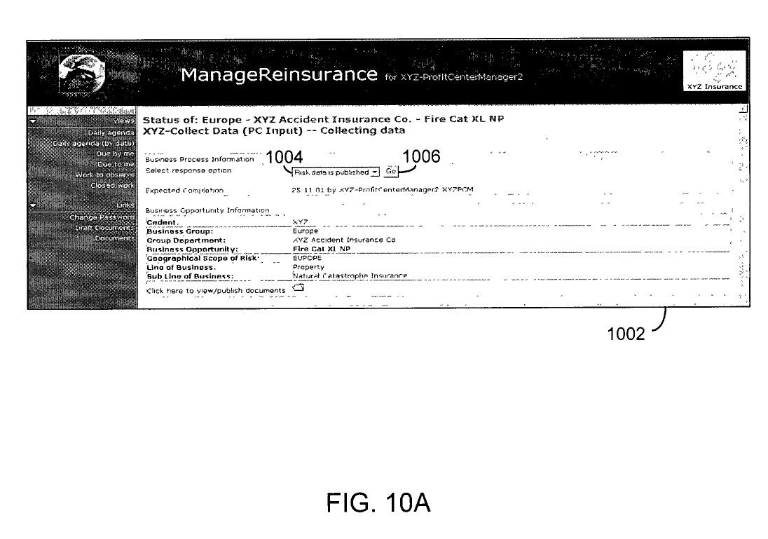

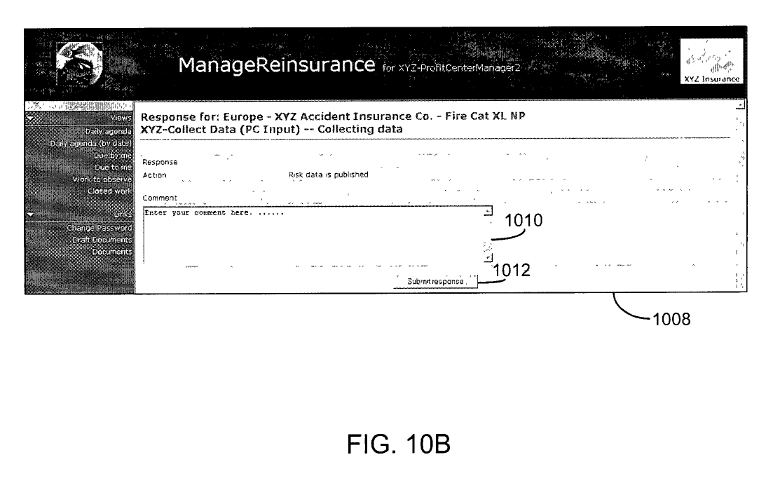

FIGS. 10A and 10B illustrate a series of exemplary graphical user interfaces through which a profit center manager collects and publishes risk data in completing step 406. To attach risk data, the profit center manager uses graphical user interfaces substantially identical to those described above for document publishing by a lead reinsurance officer or a reinsurance officer (steps 404L and 404R, and FIGS. 9C-9E). After the profit center manager has collected and attached the risk data, cedent interface 312 presents a collecting data screen 1002, as shown in FIG. 10A. Then, to publish the risk data, the profit center manager selects the “Risk data is published” option in the “Select response option” data field 1004 and clicks the “Go” button 1006.

In response, the system displays a comment screen 1008 as shown in FIG. 10B. In screen 1008, the profit center manager can enter a comment in data field 1010 to be sent to the reinsurance officer along with the published risk data. Clicking the “submit response” button 1012 sends the risk data and any comment(s) back to the reinsurance officer. In a representative embodiment of the present invention, the document publishing tool that the profit center managers use to attach documents and publish risk data prevents the profit center managers from viewing each others documents and risk data.

Returning to FIG. 4, after the profit center manager submits the risk data, in step 408, the reinsurance officer reviews the information to determine if the quality, completeness, accuracy, and detail of the information are acceptable.

If, in step 408, the reinsurance officer finds the risk data unacceptable, then the reinsurance officer requests that the profit center manager provide additional or corrected data, and the process returns to step 406. If the risk data is acceptable, then the reinsurance officer has two options for proceeding: either completing step 410 and then 412, or skipping optional step 410 and proceeding directly to step 412. Step 410 is depicted in FIG. 4 with dash lines to indicate that it is an optional step.

In optional step 410, as part of the reinsurance officer's analysis of the business opportunity and the associated data returned by the profit center manager, the reinsurance officer models specific descriptions that outline possible reinsurance purchasing scenarios. These scenario descriptions help the lead reinsurance officer or reinsurance officer in deciding whether reinsurance is needed and in better understanding the different possible approaches to purchasing the reinsurance.

In step 412, the lead reinsurance officer reviews the published risk data and the scenario descriptions (if applicable) and decides whether the cedent needs reinsurance, and, if so, what type of reinsurance. Optionally, instead of the lead reinsurance officer, the reinsurance officer can make this assessment.

If it is determined that the cedent does not need reinsurance, then the process ends at step 414. If, however, the cedent does need reinsurance, then the process continues in step 416, in which the cedent recognizes that a quotation for reinsurance is required. Step 414 marks the end of the exemplary method for the collection of data and the assessment of reinsurance needs (step 301 of FIG. 3), as well as the data collection stage 316 (FIG. 3) of cedent interface 312.

Returning to FIG. 3, after the cedent has determined that a need for reinsurance exists (in step 301), the reinsurance creation, management, and placement process continues in step 302 with the generation of proposed submissions. Step 302 also marks the beginning of stage 318 (prepare request for quotation) of cedent interface 312.

FIG. 5 outlines an exemplary method for completing step 302 (as well as steps 303 and 304 of FIG. 3). As shown, the method begins in step 500 with the reinsurance officer preparing structure proposals. Specifically, the reinsurance officer analyzes the published risk data, determines the reinsurance needs, and defines reinsurance programs. The programs are treated as structured data. A “program” consists of related reinsurance treaties and covers (non-proportional and proportional). The programs that the reinsurance officer enters consist of a series of structured data (e.g., fixed database fields detailing characteristics of the reinsurance covers), as well as unstructured data or attachments (e.g., document attachments such as Microsoft Word™ files, Excel™ files, and PDF files). Some of the files can be released directly to reinsurers as part of the request for quotation, while other files can by retained in special private folders. The reinsurance officer can also define program or layer options, which are alternatives to the reinsurance covers within a program, for which the reinsurance officer wishes to receive separate quotations. At the conclusion of step 500, the reinsurance officer sends the structure proposals to the profit center manager.

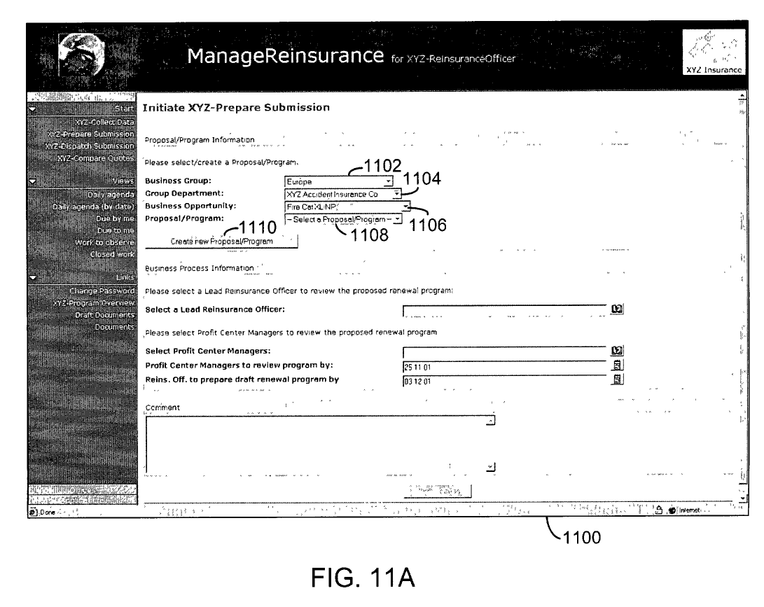

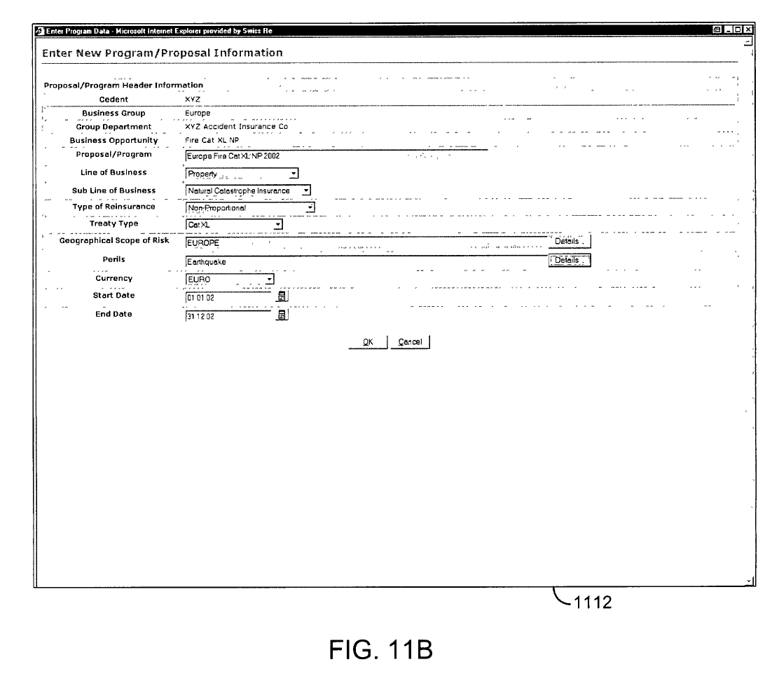

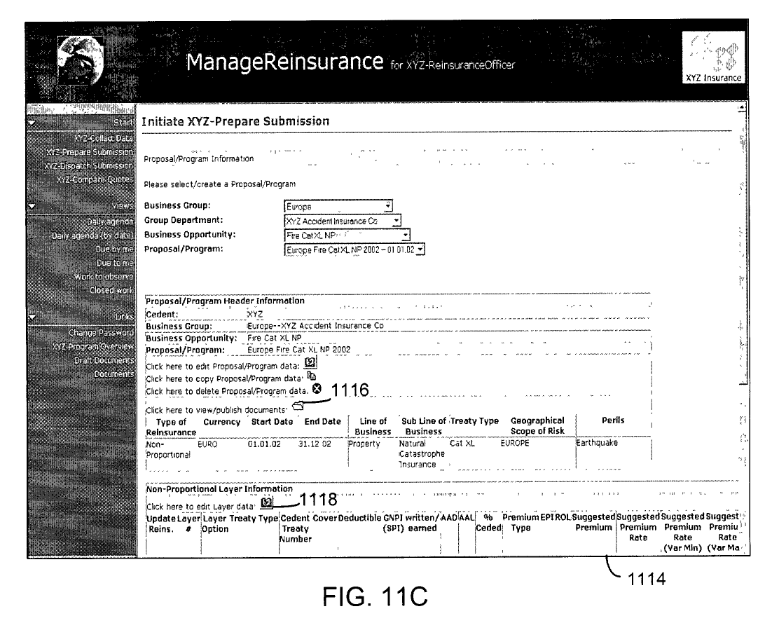

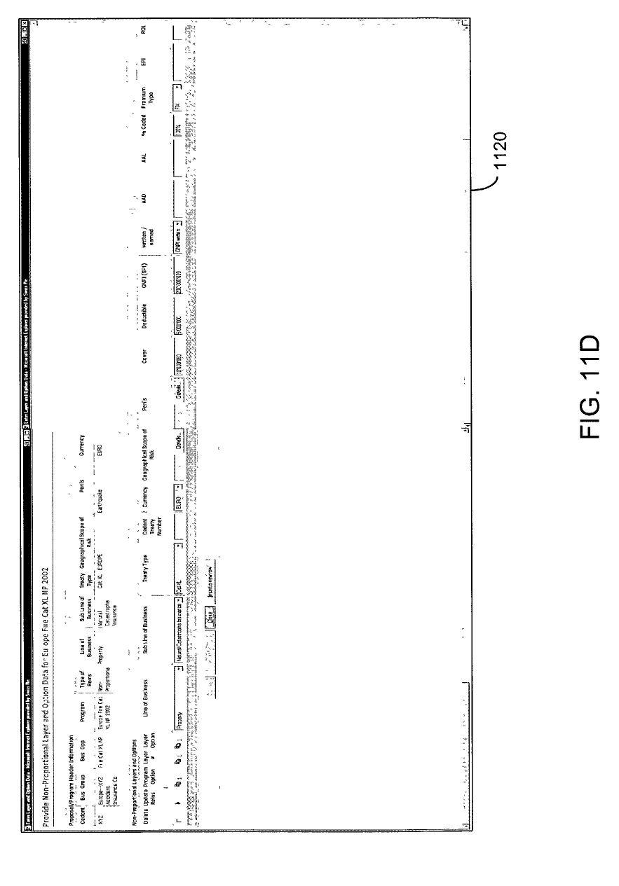

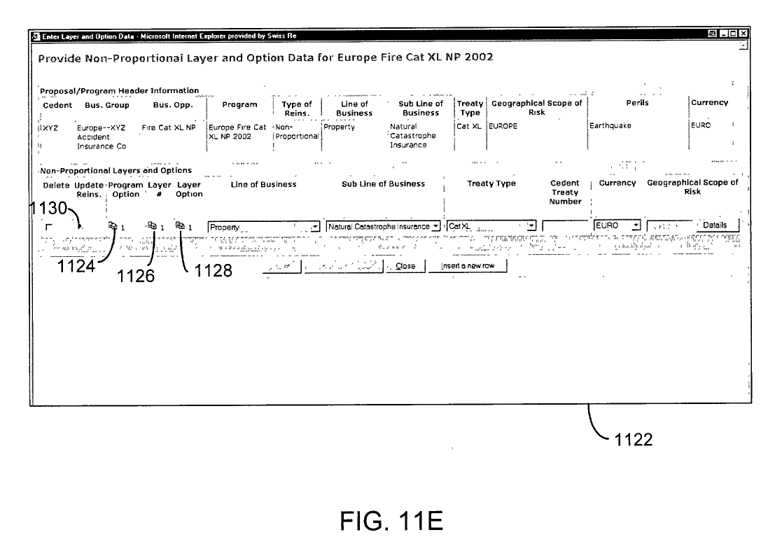

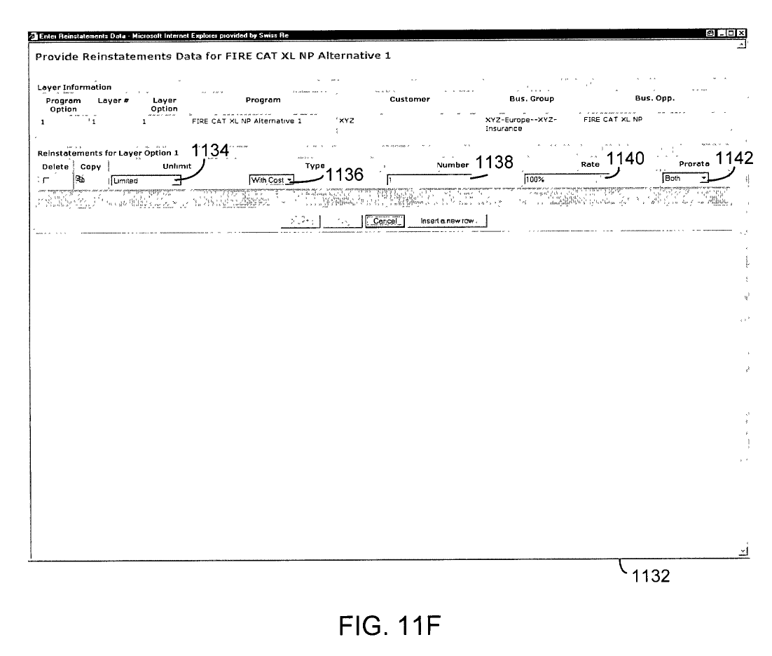

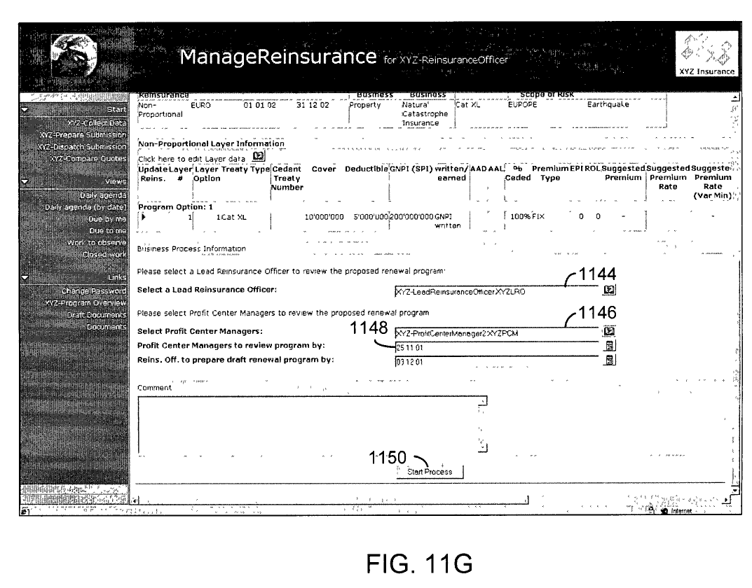

FIGS. 11A-11G illustrate a series of exemplary graphical user interfaces through which a reinsurance officer prepares and sends a structure proposal (i.e., step 500). As shown in FIG. 11A, the system presents a “prepare submission” page 1100, through which the reinsurance officer can create reinsurance programs. To enter a new reinsurance program, the reinsurance officer selects the business area, which is the hierarchical or geographic corporate structure of the cedent, from the business group field 1102 and the group department field 1104, which is a second level of hierarchical structure based on the corporate or geographical structure of the cedent, and selects a previously created business opportunity from the business opportunity field 1106. If the reinsurance officer wants to edit or copy an existing proposal/program, the reinsurance officer can select the desired proposal/program from proposal/program field 1108. But, for this example, the reinsurance officer is creating a new proposal, and therefore clicks on the “Create new Proposal/Program” button 1110.

In response, the system displays the window 1112 shown in FIG. 11B. Here, the reinsurance officer enters header information for the new proposal/program, including, for example, the name of the proposal/program, the line of business, the sub line of business, the type of reinsurance, the treaty type, the geographical scope of risk, the perils, the currency, and the start and end date of coverage.

After defining the program through window 1112, the system presents another “Prepare Submission” screen 1114 through which the reinsurance officer can enter program structure details, as shown in FIG. 11C. These details can include documents, which can be attached to the program. For example, the reinsurance officer can click on document link 1116 to add documents to the program, as described above for document publishing (with reference to steps 404L and 404R, and FIGS. 9C-9E). In addition, the reinsurance officer can click on layer data link 1118 to edit layer data (in the case of non-proportional reinsurance) or option data (in the case of proportional reinsurance).

If the reinsurance officer clicks on layer data link 1118, the system responds by displaying layer and option data screen 1120, as shown in FIG. 11D. Through screen 1120, the reinsurance officer can enter layer and structure data related to the treaty, such as line of business, sub line of business, treaty type, cedent treaty number, currency, geographical scope of risk, perils, cover, deductible, GNPI, written/earned, AAD, AAL, percent ceded, premium type, EPI, and ROL.

As part of step 500, the system also provides the reinsurance officer with the ability to copy entire programs or structures within a program. The options available in copying data within an existing program depend on the treaty type (i.e., non-proportional and proportional). FIG. 11E illustrates a screen 1122 through which the reinsurance officer can copy data in non-proportional programs. For a non-proportional program, data can be copied at a number of different levels. By clicking on the program option link 1124, the layer number link 1126, or the layer option link 1128, the treaty is copied at either the program option, layer, or layer option, respectively.

For a proportional program, in this embodiment, the existing structure can be copied at only one program option level. Therefore, in FIG. 11E, the reinsurance officer clicks on the program option 1124 to copy data at the program option level.

Also as part of step 500, the system provides the reinsurance officer with the ability to insert reinstatement data to a particular non-proportional treaty. The reinsurance officer activates this function by clicking on the update reinstatement icon 1130 in screen 1122 of FIG. 11E. In response, as shown in FIG. 11F, the system displays a reinstatement data page 1132 through which the reinsurance officer can insert reinstatement data, including, for example, whether or not there is a limit on the number of reinstatements per treaty year in any given year (field 1134), whether the reinstatement is free or payable (field 1136), the number of times (reinstatements) per any one treaty year reinstatement is free or payable (field 1138), the rate of the reinstatement premium in relation to the original premium (field 1140), and whether the premium is “capita” (linked to the ratio between the loss suffered divided by the cover), is “temporis” (linked to the ratio of time left on the treaty divided by the number of days a year), or both capita and temporis (linked to both the ratio of time and amount in relation to the original premium) (field 1142).

After preparing the proposed renewal program, the reinsurance officer is ready to send it for review to one or more profit center managers, and eventually to a lead reinsurance officer. FIG. 11G illustrates an exemplary screen through which the reinsurance officer selects the reviewing profit center manager(s) and lead reinsurance officer. As shown, the reinsurance officer selects the lead reinsurance officer in field 1144, selects the profit center manager(s) in field 1146, and identifies the date by which the profit center manager(s) must review the program in field 1148. To send the program and start the review process, the reinsurance officer clicks on “Start process” button 1150.

Returning to FIG. 5, after the reinsurance officer has defined the structure proposals, has prepared the reinsurance documentation, and has sent the material to the profit center manager, in step 502, the profit center manager reviews the proposed program. This review marks the beginning of step 303 of the reinsurance placement process shown in FIG. 3, i.e., the validation of proposed submissions. Step 303 coincides with stage 318 (prepare request for quotation) of cedent interface 312, and with phase 1 of the overall reinsurance process.

In step 502, the profit center manager reviews the structured data and associated documents of the proposed program. The profit center manager is prompted to provide feedback and any additional information that is relevant to the proposed reinsurance program. Optionally, as mentioned above, the reinsurance officer may request feedback from multiple profit center managers. Typically, the number of profit center managers reviewing the proposed program in step 502 would depend on the scope of the reinsurance program.

After reviewing the proposed renewal program, if the profit center manager determines that modifications are needed, then, in step 504, the profit center manager conveys the required modifications (as unstructured data) to the reinsurance officer, who then makes the necessary changes to the renewal program (to both unstructured and structured data). The reinsurance officer then proceeds by creating a draft renewal program in step 506.

If, in step 502, the profit center manager accepts the proposed program without modification, then the profit center manager relates this acceptance to the reinsurance officer and the reinsurance officer proceeds, without modifying the program, to step 506 for the creation of a draft renewal program.

In step 506, in creating the draft renewal program, the reinsurance officer creates and attaches additional common documentation, such as slips and treaty presentations. The reinsurance officer then forwards the renewal program to the lead reinsurance officer for review.

In step 508, the lead reinsurance officer reviews the renewal program and its associated documentation for completeness and quality, provides comments and/or approval as appropriate, and returns the program and comments (if applicable) to the reinsurance officer. The comments can be either in a structured or unstructured format.

In step 510, based on the feedback from the lead reinsurance officer, the reinsurance officer modifies and supplements the documentation of the reinsurance program, and flags the program as being ready for release. The modifications can involve either structured or unstructured data.

The process of steps 500 through 510 can repeat such that several finalized programs are available at the conclusion of step 510. Or, optionally, each step can be performed on multiple programs so that several finalized programs are available at the conclusion of step 510.

The completion of step 510 marks the end of the validation of the proposed renewal program (step 303 of FIG. 3), as well as the end of phase 1 of the overall reinsurance process (see FIGS. 1 and 3).

Phase 2, Steps 304-305

Returning to FIG. 3, after validating the proposed renewal program(s) in step 303, the reinsurance placement process continues in step 304 with the dispatch of a renewal package to reinsurers. Step 304 marks the beginning of phase 2 of the overall reinsurance process, in which the cedent dispatches the renewal package to the reinsurers and, in response, the reinsurers dispatch quotes to the cedent. Step 304 also coincides with stage 318 (prepare request for quotation) of cedent interface 312.

Referring to FIG. 5, after finalizing the renewal program(s) in step 510, the reinsurance officer creates a request for quotation dispatch in step 512. Specifically, the reinsurance officer selects from the pool of finalized programs eligible to be selectively included in the request for quotation and determines to which reinsurers/brokers each reinsurance program should be released. The request for quotation dispatch may therefore contain multiple reinsurance programs, and the cedent may request the reinsurers/brokers to quote the same set or different sets of programs. Optionally, releases to brokers may be in the form of a broker/reinsurer pair, in which case the broker is expected to return a quotation specific to the reinsurer named.

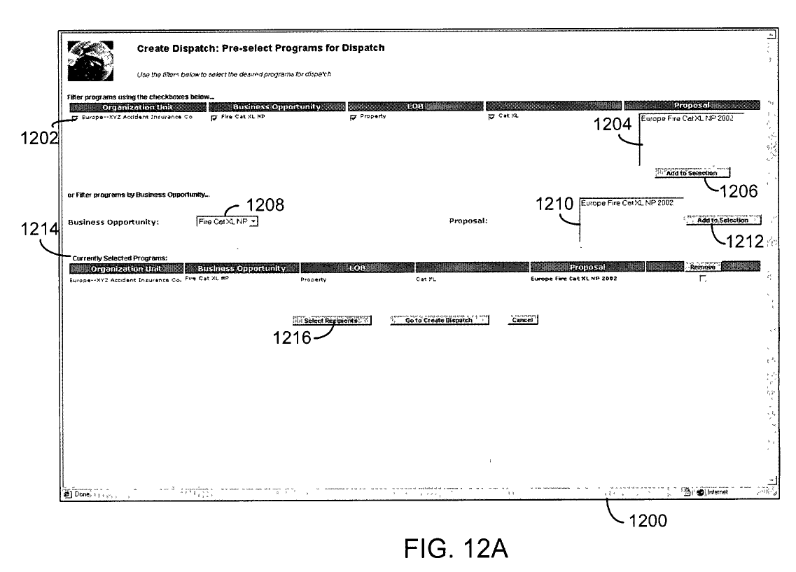

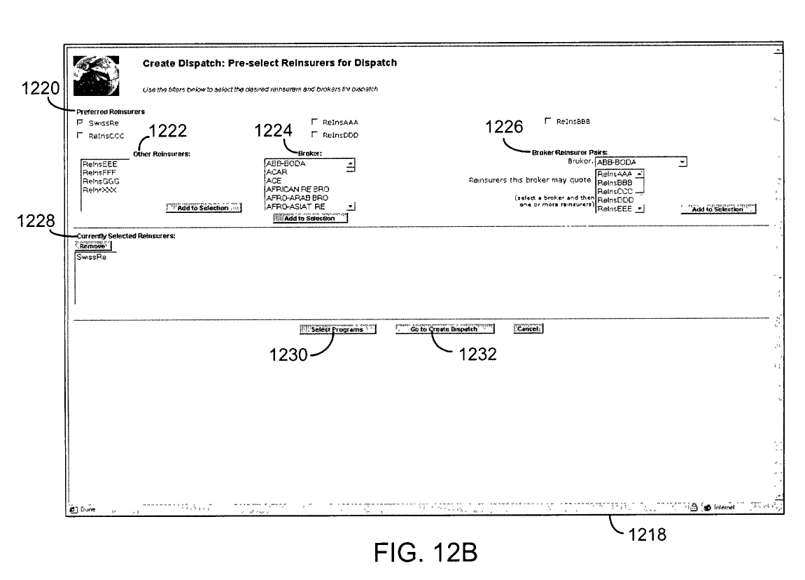

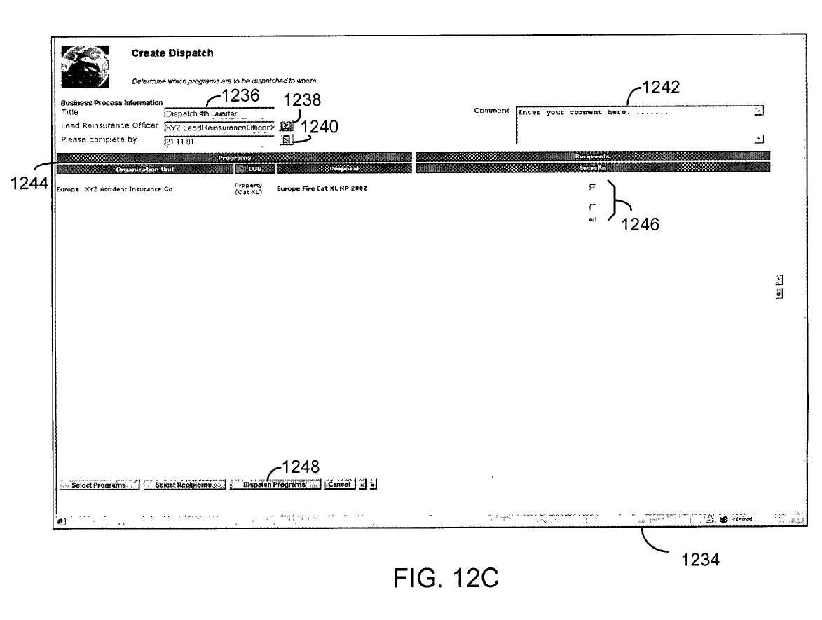

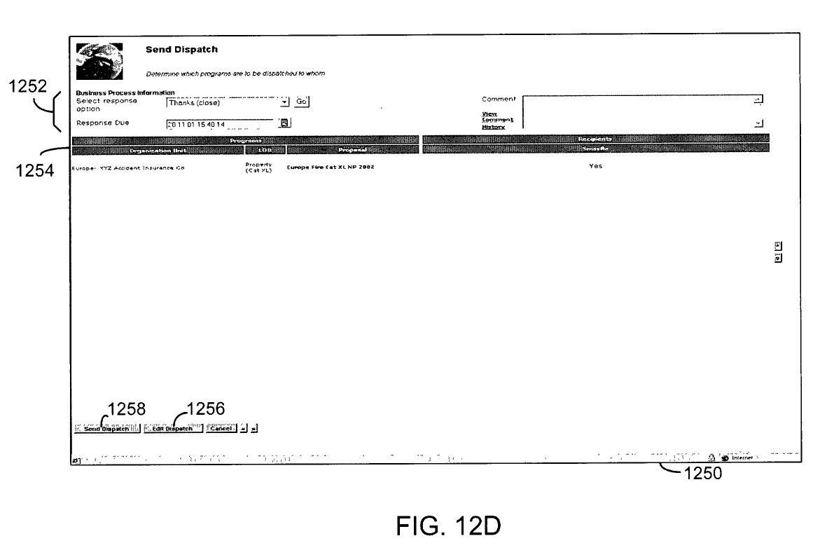

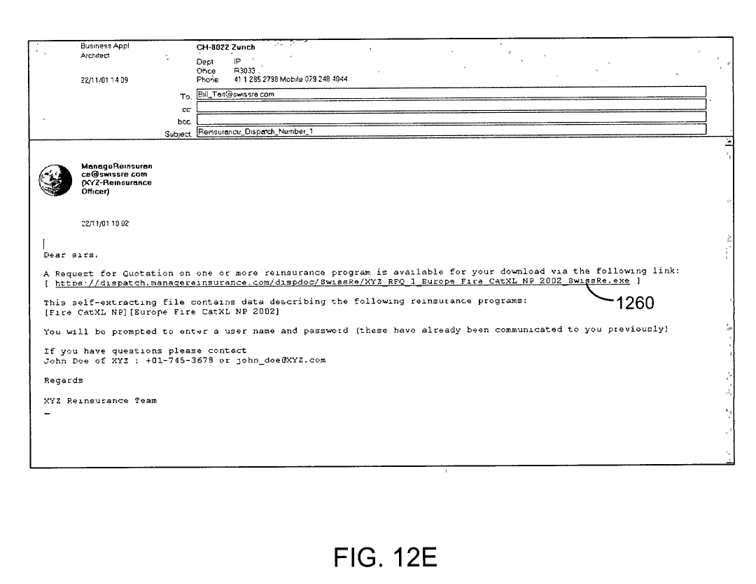

FIGS. 12A-12E illustrate a series of exemplary graphical user interfaces through which a reinsurance officer creates a request for quotation dispatch in step 512, using structured data fields. The dispatch process enables the reinsurance officer to select individually or en masse the programs to be sent to the reinsurers/brokers. FIG. 12A illustrates an exemplary program selection screen 1200 through which the reinsurance officer identifies all of the programs to be dispatched. As shown, the reinsurance officer can locate desired programs by using checkboxes 1202 to filter the programs by organization unit, business opportunity, line of business, or type. The resulting programs for this filter are listed in data field 1204, and can be selected by highlighting their entries in field 1204 and clicking the “Add to Selection” button 1206. The reinsurance officer can also locate desired programs by filtering the programs by business opportunity only. In this case, the reinsurance officer specifies a business opportunity in field 1208, highlights a program listed in field 1210, and clicks on the “Add to Selection” button 1212.

The selected programs are listed under heading 1214. After the reinsurance officer has selected all desired programs, the reinsurance officer clicks on the “Select Recipient(s)” button 1216 to continue with the dispatch process.

FIG. 12B illustrates an exemplary recipient selection screen 1218 through which the reinsurance officer selects the reinsurers/brokers that are to receive programs. As shown, screen 1218 provides a preferred reinsurer area 1220 from which the reinsurance officer can select preferred (e.g., often used) reinsurers simply by checking a box. Screen 1220 also provides an “other reinsurer” list 1222, a broker list 1224, and a broker/reinsurer pair list 1226 from which the reinsurance officer can select additional recipients of the programs. Screen 1218 lists the selected reinsurers under heading 1228. To return to program selection screen 1200, the reinsurance officer can click on the “Select Programs” button 1230. To proceed with the dispatch process and select which programs are to go to which reinsurers/brokers, the reinsurance officer clicks on the “Go to Create Dispatch” button 1232.

FIG. 12C illustrates an exemplary program-recipient matrix screen 1234 through which the reinsurance officer can map the selected programs to the selected reinsurer recipients. As shown, the reinsurance officer can specify a title for the dispatch in title field 1236, assign a lead reinsurance officer to review the dispatch in field 1238, select a desired completion date in field 1240, and include comments to accompany the dispatch in field 1242. Screen 1234 provides a matrix 1244 listing programs on one side and recipient reinsurers on the other. For each program, the reinsurance officer checks checkboxes 1246 to select the reinsurers/brokers that are to receive the program. After the reinsurance officer has matched selected programs to selected reinsurer recipients, the reinsurance officer starts the dispatch by clicking the “Dispatch Programs” button 1248. In response, the system sends an e-mail notification to the lead reinsurance officer that was specified in field 1236 of FIG. 12C. The notification informs the lead reinsurance officer that she has a dispatch to review. Although FIG. 12C only shows one program, it should be understood that matrix 1244 could and would, in most instances, include multiple programs.

As shown in FIGS. 12C, a significant benefit of the present invention is the tracking function provided by matrix 1244. According to prior art methods, cedents dispatch renewal packages by mail or e-mail and lack any systematic authority check for releasing only approved programs and (later) monitoring which reinsurers have received which programs. For example, to determine the status of a dispatched renewal package, a cedent using these conventional methods might have to search haphazardly through sent e-mails. With the present invention, however, the dispatches are easily assigned (as in matrix 1244) and then later easily retrieved for review (e.g., through a daily agenda screen or a quotation comparison screen, discussed below).

Returning to FIG. 5, after the reinsurance officer creates the dispatch and makes it available for review, in step 514, the lead reinsurance officer reviews the selections made by the reinsurance officer and modifies them, if necessary. The modifications can involve structured data. After approving of the original or modified dispatch, the lead reinsurance officer releases the dispatch in step 516. In response, the system electronically forwards requests for quotation to the selected reinsurers/brokers in step 518. For example, the system forwards an e-mail notification to a global client officer of a reinsurer with a notification of intent and a link to the file server storing the data (structured or unstructured).

FIG. 12D illustrates an exemplary dispatch screen 1250, which prompts the lead reinsurance officer to review a newly created dispatch. As shown, screen 1250 provides a response area 1252 in which the lead reinsurance officer can specify a response option, a response due date, and response comments. The lead reinsurance officer can review the matrix 1254 prepared by the reinsurance officer and can review a program's structure by clicking on its name listed in the matrix 1254. By clicking the “Edit Dispatch” button 1256, the lead reinsurance officer can edit the dispatch to change the recipients or the list of programs being dispatched. Once the dispatch is acceptable, the lead reinsurance officer clicks the “Send Dispatch” button 1258, which causes the system to send e-mail notifications to each of the reinsurer or broker recipients, prompting them to download their request for quotation files.

FIG. 12E illustrates an exemplary e-mail notification to a reinsurer. The e-mail includes a link 1260 through which to download the request for quotation (preferably also requiring a user name and password for security). Once downloaded, the reinsurer can access the spreadsheet (structured) containing the cedent's program structure and any attached documentation (unstructured). The reinsurer would then enter quotation information in the appropriate fields, save the file, and return the file to the cedent as an attachment to an e-mail (described below in reference to the reinsurer's quotation step 305).

Referring to FIG. 5, an alternative dispatch process occurs if, in step 512, the reinsurance officer does not specify a lead reinsurance officer to review the dispatch (in field 1236 of FIG. 12C). In this case, when the reinsurance officer starts the dispatch by clicking the “Dispatch Programs” button 1248 (FIG. 12C), the dispatch process proceeds directly to step 518 to send e-mail notifications to the selected reinsurers/brokers. The dash lines connecting steps 512 and 518 in FIG. 5 indicate this alternative process.

In an alternative embodiment of the present invention, before the request for quotation is dispatched to a group of reinsurers, the cedent initially presents the dispatch to a selected reinsurer (or broker) in what is referred to herein as a consultation dispatch. This consultation dispatch would involve the same steps described herein for a dispatch to a group of reinsurers, but would only involve the selected reinsurer (or broker). The intent of the consultation dispatch is to obtain initial feedback on the reinsurance program and to make any necessary adjustments before distributing the program to a large group of reinsurers.

The conclusion of step 518 marks the end of step 304 of FIG. 3 (dispatch to reinsurers), as well as the end of stage 318 (prepare request for quotation) of the cedent interface 312.

Referring to FIG. 3, after the renewal package has been dispatched to the reinsurers, the reinsurance placement process continues in step 305 with the reinsurers providing quotations. Step 305 also marks the beginning of quotation stage 324 of reinsurer interface 314.

FIG. 6 outlines an exemplary method for completing step 305. As shown, the method begins in step 518 with the reinsurer receiving a notification requesting a quotation. The notification could be, for example, an e-mail notification with a link to reinsurer interface 314 and to structured data stored on host server 201 (FIG. 2). The reinsurer then accesses the renewal package using reinsurer interface 314, at stage 324. Through reinsurer interface 314, the reinsurer connects to file transfer server 202 and retrieves, for example, spreadsheet files (structured data) and documentation attachments (unstructured data).

In a representative embodiment of the present invention, reinsurer interface 314 supports two business process models: centralized and decentralized. The process flows for these models are the same, except for the roles used in executing the steps. Table 2 below outlines the differences between the centralized and decentralized models.

TABLE 2
Centralized versus Decentralized

| | Centralized Process | Decentralized Process |
|---|---|---|
| Roles Used | GCO, GCM, LCM, UW, | LCM, UW, Observer |
| | Observer | |
| Workflow Initiator | GCO | LCM, UW |
| Role that returns | GCO | LCM |
| quote to cedent | | |
| Who reassigns task | GCO | LCM, UW |
| if user declines to | | |
| do it? | | |

As shown in Table 2, a global client office only exists in the centralized model. For the decentralized model, either an underwriter or a local client manager is able to set up the proposal through reinsurer interface 314. The initiator is the person who sets up the proposal and assigns the performers. The initiator is responsible for re-assigning the proposal if a performer declines to do the work.

Global client manager is part of the workflow in the centralized model. In the decentralized model, the global client manager is not part of the workflow, but is instead assigned as an observer.

For clarity, the descriptions herein of the stages 324, 326, and 328 of reinsurer interface 314 trace the reinsurer's workflow according to the centralized model. It should be understood, however, that the descriptions also apply to the decentralized model, but with the role substitutions and differences noted above in reference to Table 2.

Referring to FIG. 6, in step 518, the global client office receives all of the treaty renewal information prepared by the cedent. Preferably, the treaty data is electronically transmitted to the reinsurer. For example, the global client office receives an e-mail reporting that a request for quotation is pending, as shown in FIG. 12E. The global client office then accesses a compressed reinsurance package stored on file transfer server 202 (FIGS. 2A and 2B), using a unique user name and password. The global client office downloads the package and extracts the files. The files include, for example, any documents that the cedent chose to attach (e.g., treaty presentations, slips, loss statistics, and underwriting policy descriptions), as well as a copy of the program's structured data in spreadsheet format, with data fields in which to provide quotes.

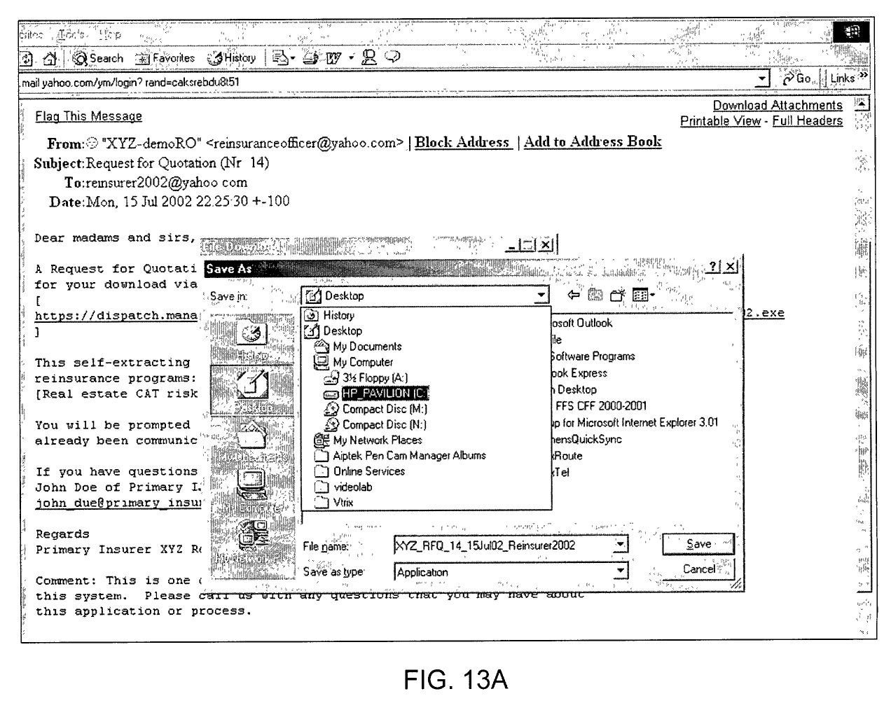

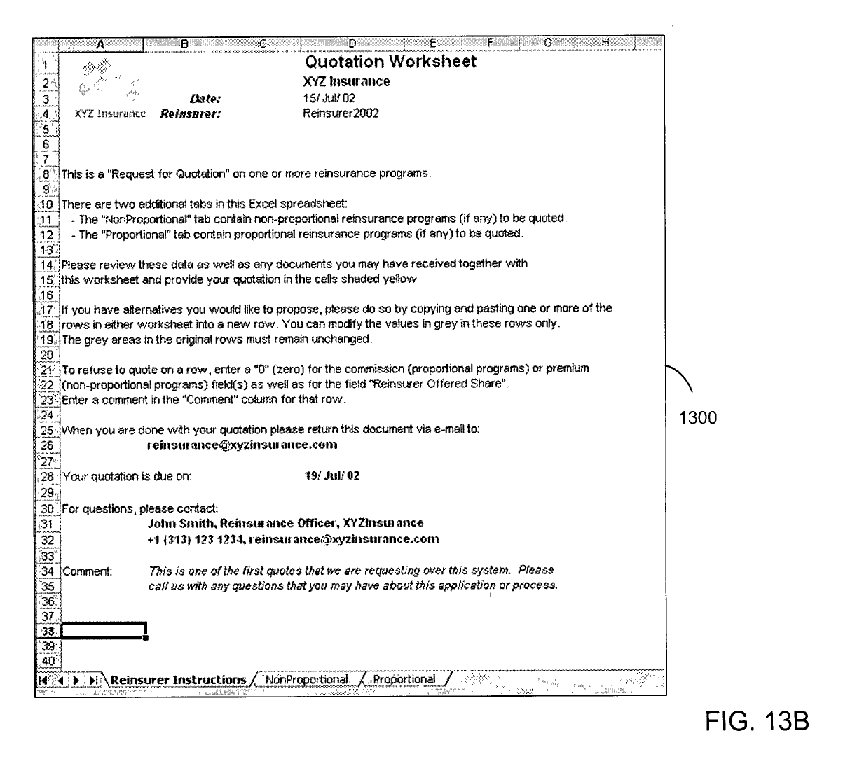

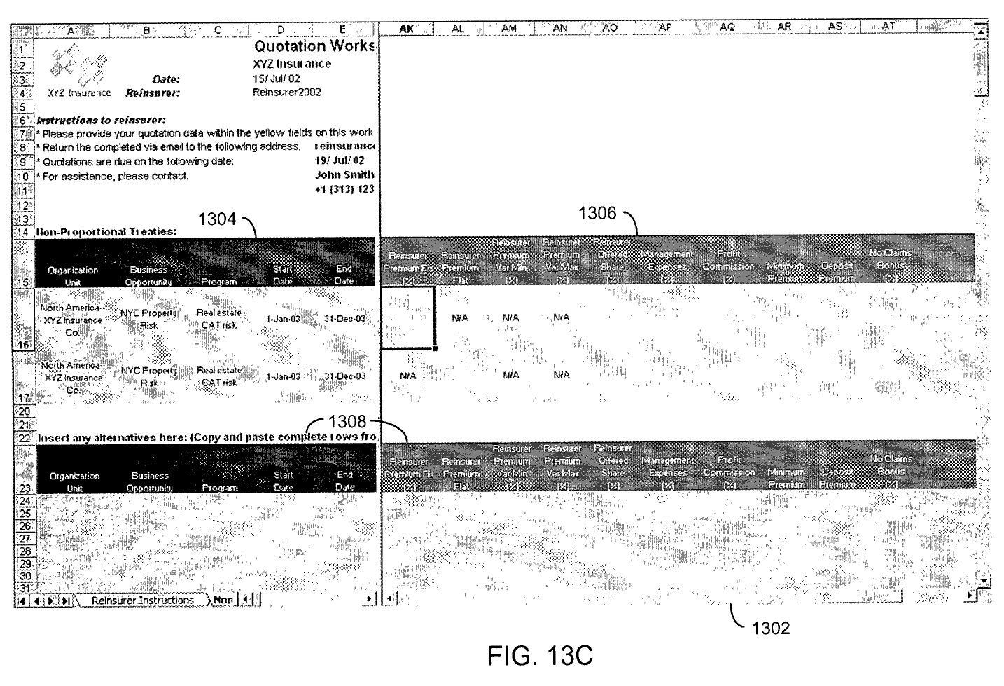

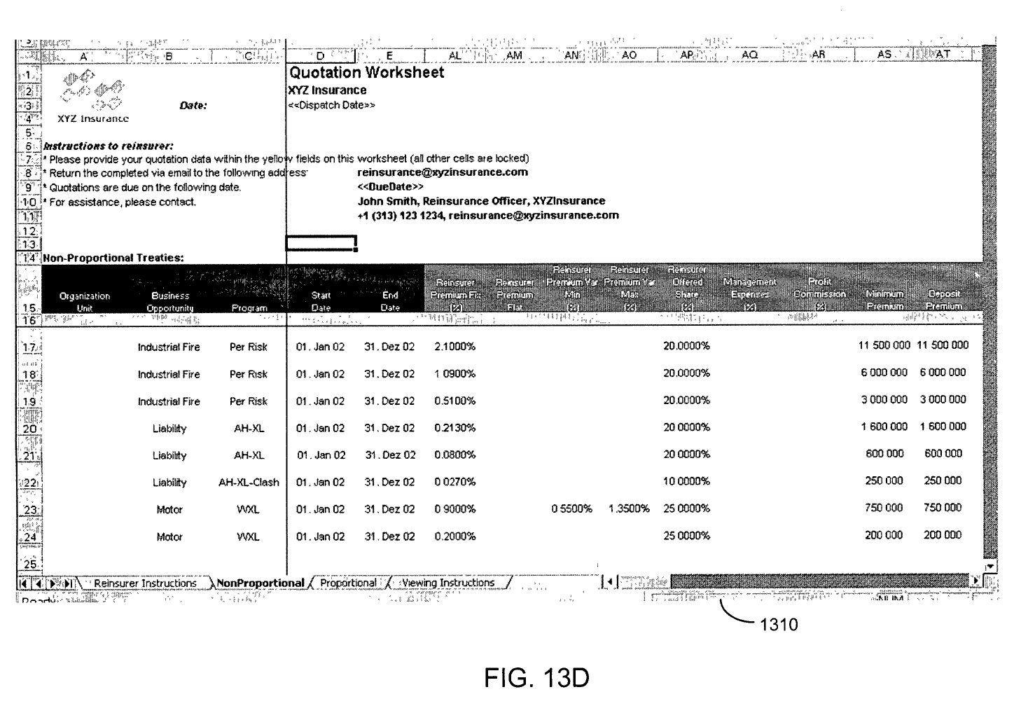

FIGS. 13A-13D illustrate a series of exemplary graphical user interface screens through which the reinsurer provides a quotation for the renewal package proposed by the cedent. After receiving the e-mail notification of FIG. 12E, the reinsurer clicks on the link 1260 embedded in the e-mail to download the request for quotation. As shown in FIG. 13A, link 1260 launches a file download application, which locates the reinsurer's files on the file transfer server 202. The reinsurer specifies a location at which to save the files on the hard drive of reinsurer computer 208. Preferably, file transfer server 202 requires the reinsurer to furnish its unique user name and password as a condition to connect to file transfer server 202 and download the files.

FIGS. 13B-13D illustrate the contents of an exemplary downloaded file. As shown, the file includes an Excel workbook having multiple worksheets. The first sheet 1300, as shown in FIG. 13B, provides the reinsurer with the background on the request for quotation, instructions for submitting a quotation, and contact information of the cedent. These exemplary instructions explain that the workbook is a request for quotation on one or more reinsurance programs, and that the workbook contains a “non-proportional” tab and a “proportional” tab. The non-proportional tab contains non-proportional programs (if any) to be quoted. The proportional tab contains proportional programs (if any) to be quoted. The instructions ask the reinsurer to review the different worksheets of the workbook along with any documents that may have been forwarded with the workbook. The instructions ask the reinsurer to provide its quotation in designated fields (e.g., shaded yellow). The instructions also explain how to propose alternatives, how to refuse to quote, how to return the document to the cedent when the quotation is complete, when the quotation is due, and who to contact with questions. This first sheet 1300 of the workbook can also include general comments related to completing the quotation.

FIG. 13C illustrates an exemplary worksheet 1302 for entering a quotation for non-proportional treaties. Although FIG. 13C shows only a portion of worksheet 1302, which contains a few selected fields, one of ordinary skill in the art would appreciate that worksheet 1302 could contain many other fields as dictated, for example, by the cedent's particular request for quotation. As shown, the left portion 1304 of the spreadsheet lists the structured treaty data (e.g., dates, layering numbers, lines of business, deductibles, reinstatements, and suggested rates) describing the treaties, as entered previously by the cedent. Preferably, the data fields in the left portion 1304 of the spreadsheet are protected and cannot be overwritten by the reinsurer. The right portion 1306 of the spreadsheet provides the data fields in which the reinsurer enters a quotation. These fields include, for example, rate, share, management expenses, premiums, new premiums, and deposit premiums. The lower portion 1308 of the spreadsheet provides data fields in which the reinsurer can propose alternatives to the programs presented by the cedent. For example, the reinsurer may suggest a different way to structure a program, such as differently organized layers.

FIG. 13D illustrates an exemplary worksheet 1310 with quotations entered by the reinsurer. Although FIGS. 13C and 13D illustrate non-proportional worksheets, the proportional worksheets would look substantially similar and would operate in substantially the same manner.

Although the spreadsheets greatly increase the efficiency of dispatching requests for proposals, in some instances, electronic transmission of the requests may not be possible. For example, although a reinsurer may receive the electronic transmission of the requests, the reinsurer may not have an internal electronic system for the placement of renewal business or may not be interfaced into the reinsurer internal system. In this case, step 518 further involves the reinsurer's registering the business described in the request for quotation by entering the treaty data and structure information into reinsurer interface 314. Reinsurer interface 314 enables a global client office to create and view a business opportunity and program in the centralized process. (For the decentralized process, an underwriter, local client manager, or global client manager creates the business opportunity and program.) The global client office enters the name of the business opportunity, the priority of the opportunity, the profit center code, the program name, the program number client, and other program data (e.g., line of business, inception date, geographical scope, brokers, peril inclusions/exclusions, and geographical inclusions/exclusions).

In response, reinsurer interface 314 displays an overview of the program, which shows non-proportional and proportional elements available for the structured data of the program. Through reinsurer interface 314, the global client office enters the treaty data the non-proportional and proportional elements (in the centralized process). (In the decentralized process, the underwriter or local client manager enters the treaty data.)

At this point in the process, the reinsurer has the request for quotation information from the cedent, either contained in a spreadsheet downloaded (perhaps, with other unstructured documentation) from file transfer server 202 or entered manually into reinsurer interface 314. The reinsurer is therefore ready to review and quote on the renewal package. The following steps 600-624 of FIG. 6 illustrate an exemplary process through which a reinsurer reviews and quotes on the renewal package. As one of ordinary skill in the art would appreciate, the individual practices of reinsurers may vary from the generic process shown in steps 600-624.

Referring to FIG. 6, having obtained the treaty data in step 518 (either electronically via an e-mail and link, or entered manually into reinsurer interface 314), the global client office, in step 601B, initiates the quotation stage 324 business process by performing an initial review of the treaty renewal information received from the cedent. If the data provided by the cedent is insufficient, such that the reinsurer is unable to provide a quote, then, in step 601A, the global client office requests more information from the cedent. The cedent then addresses the inadequacies and, returning to step 518, provides the reinsurer with a revised request for quotation. This initial review process of steps 518, 600, and 601A repeats until the reinsurer has the information necessary to provide a quote.

Assuming the reinsurer receives adequate data, in step 601B, the members of the global client office set up the proposal internally to their organization (perhaps, through reinsurer interface 314) and assign the people responsible for completing the work on each program. The global client office assigns an underwriter, a local client manager, and a global client manager. In the centralized process, the global client office sends the program to the underwriter, local client manager, and global client manager. In the decentralized process, the person who created the structured program may assign the program to the underwriter and local client manager involved in the program. The global client office can also assign observers to a program, who can monitor the entire process and offer comments. The reinsurer can assign different underwriters for the non-proportional and proportional elements of the program. The reinsurer can select appropriate users for each of the roles and can assign acceptance deadline and completion deadline dates.

Referring to FIG. 6, after the quotation phase has been initiated and the responsible persons have been assigned, in step 602, the underwriter decides whether to agree to work on the quotation. The underwriter may decline the work if, for example, she has been incorrectly assigned or is unavailable because of holiday or work commitments. If the underwriter does decline the work, then the underwriter notifies the global client office of the refusal and, returning to step 601B, the global client office assigns another underwriter.

If, in step 602, the underwriter accepts the work, then, in step 604, the underwriter reviews the program detailed in the request for quotation and produces a technical quote. The technical quote can possibly reflect the outcome of capacity allocation and can possibly include new structures. The underwriter produces the technical quote by calculating off-line and entering the appropriate values in the spreadsheet of FIGS. 13A-13D or in the interface provided by reinsurance interface 314. In a common scenario, the offered share and offered rate would not be entered at this point, as these values are the responsibility of the local or global client manager. As part of producing the technical quote (step 604 of FIG. 6), the underwriter can also complete registration of cat capacity amounts.

After the underwriter has created and submitted the technical quote, the quote is ready to be presented to the local client manager for review. First, however, the local client manager must agree to review the program, as assigned by the global client office in step 601B. Thus, in step 606, the local client manager decides whether to accept the task of reviewing the program.

If the local client manager does not accept the work, then the global client office is notified of the refusal and, returning to step 601B, assigns a new local client manager. Assuming the local client manager accepts the work, then, in step 608, the local client manager reviews the technical quote prepared by the underwriter.

After reviewing the technical quotation, in step 610, the local client manager either accepts or rejects the quote. If the local client manager rejects the technical quotation, then, in step 612, reinsurer interface 314 notifies the underwriter of the rejection and gives the underwriter the opportunity to revise the technical quotation. After the revisions are made, returning to step 608, the local client manager reviews the revised technical quotation, and then decides whether it is acceptable in step 610. This review process (steps 608, 610, and 612) repeats until the local client manager accepts the technical quotation.

Once the local client manager accepts the technical quotation in step 610, then, in step 614, the local client manager produces a market quote (e.g., offered share and offered rate), which proposes price adjustments according to market realities. As part of entering the offered share, the local client manager can calculate cat capacity allocation amounts. The local client manager can also check to ensure that an adequate budget exists, and, if not, can change the offered share to adjust the amount of capacity being allocated.

After the local client manager has produced the market quote by entering the offered share and offered rate, the market quote is ready for review by the global client manager. First, however, the global client manager must agree to review the market quote, as assigned by the global client office in step 601B. Thus, in step 616, the global client manager decides whether to accept the task of reviewing the market quote.

If the global client manager does not accept the work, then the global client office is notified of the refusal and, returning to step 601B, assigns a new global client manager.

Assuming the global client manager accepts the work, then, in step 620, the global client manager reviews the market quote prepared by the local client manager.

After reviewing the market quote, in step 618, the global client manager either accepts or rejects the quote. If the global client manager rejects the quote, the global client manager can include comments in the response, for example, to propose price adjustments based on market realities.

If the global client manager rejects the market quote, then, in step 622, reinsurer interface 314 notifies the local client manager of the rejection and gives the local client manager the opportunity to revise the market quote. The local client manager may also discuss the required changes with the global client manager.

After the revisions are made, returning to step 618, the global client manager reviews the revised market quote, and then decides whether it is acceptable in step 620. This review process (steps 618, 620, and 622) repeats until the global client manager accepts the market quote.

Once the global client manager accepts the market quotation in step 620, then, in step 624, the global client office returns the program quotes back to the cedent. The program quotes include, for example, spreadsheet files (structured) and documentation attachments (unstructured), as discussed above in reference to FIGS. 13A-13D.

Referring to FIG. 3, the conclusion of step 624 marks the end step 305 (reinsurers quote), the end of the quotation stage 324 of reinsurer interface 314, and the end of phase 2 (dispatch of programs and program quotes) of the overall reinsurance placement process.

Phase 3, Steps 306-307

With the program quotes returned to the cedent, the reinsurance process continues in step 306 with evaluation of the quotes by the cedent. The start of this evaluation also marks the start of the evaluation and negotiation stage 320 of cedent interface 312, and the start of evaluation and negotiation phase 3 of the overall reinsurance placement process.

FIG. 7A outlines an exemplary method for completing the evaluation step 306 (as well as the cedent-portion of negotiation step 307 of FIG. 3). As shown, after the cedent receives the reinsurer quotes in step 624, the reinsurance officer of the cedent evaluates the quotes in step 700. Specifically, the reinsurance officer imports the quotes (structured data) into cedent interface 312, which provides special screens that summarize the reinsurance quotations returned by the reinsurers and provide access to the details of each quotation. Optionally, the evaluation of step 700 may involve correspondence between the cedent and the reinsurers/brokers.

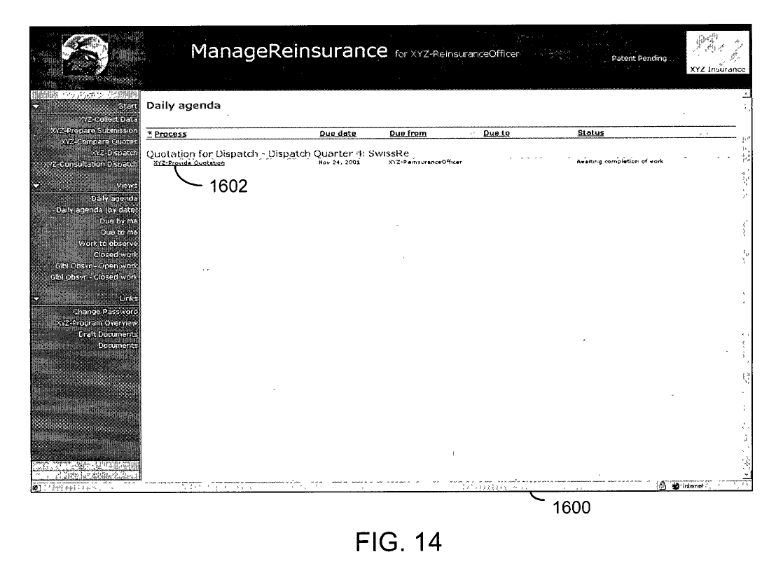

FIGS. 14, 15, 16A, and 16B illustrate an exemplary series of screens through which the cedent receives quotations returned by reinsurers. Typically, a reinsurer would return the quotation by e-mail and the cedent would detach the quotation file from the e-mail and import it to host server 201 (as described in reference to FIG. 2B). The reinsurance officer of the cedent would review the file to ensure that it is intact and that the quotation makes sense. The reinsurance officer would then process the quotation using reinsurer interface 312 as shown in FIGS. 14, 15, 16A, and 16B.

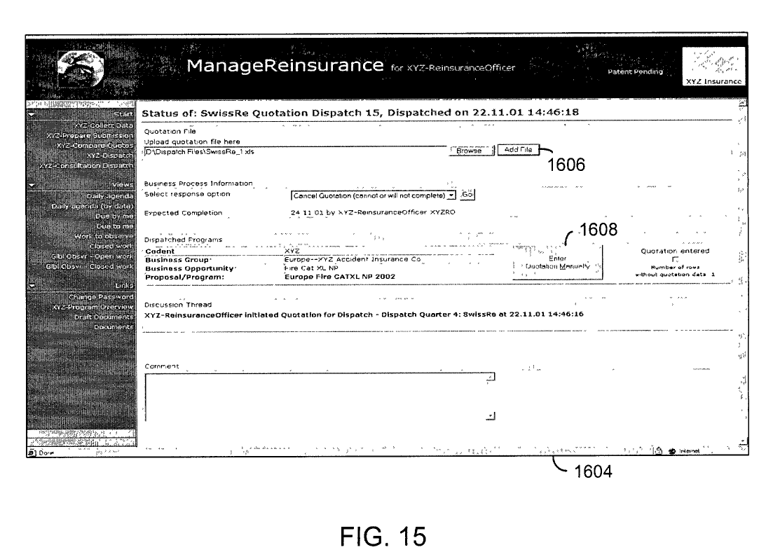

As shown in FIG. 14, a first screen 1600 shows, on a separate line, each reinsurer that has been selected as a dispatch recipient of the program. To view a quotation, the reinsurance officer clicks on link 1602. As shown in FIG. 15, another screen 1604 enables the reinsurance officer to upload the quotation file using the “Add File” button 1606. Alternatively, the reinsurance officer can click the “Enter Quotation Manually” button 1608 to enter the quotation manually. This feature is particularly useful if the reinsurer has returned a quotation by telephone or facsimile, rather than completing the quotation spreadsheet, or has proposed changes or additions to the program structure.

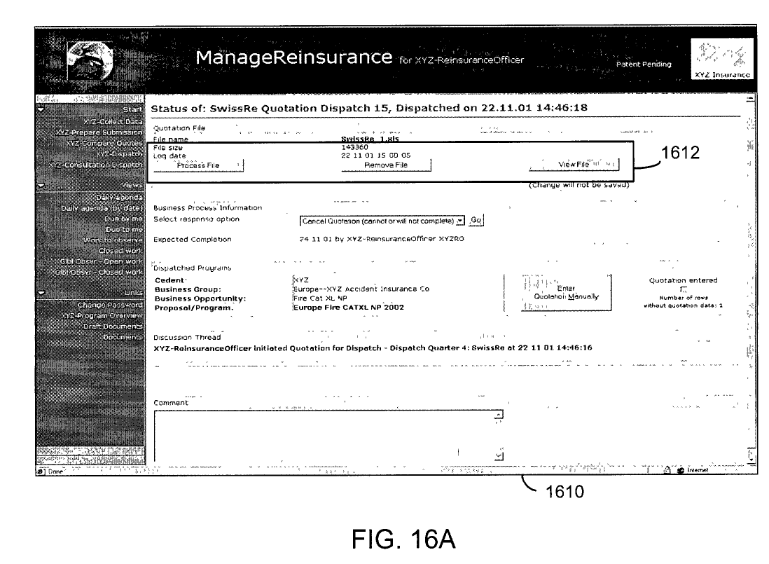

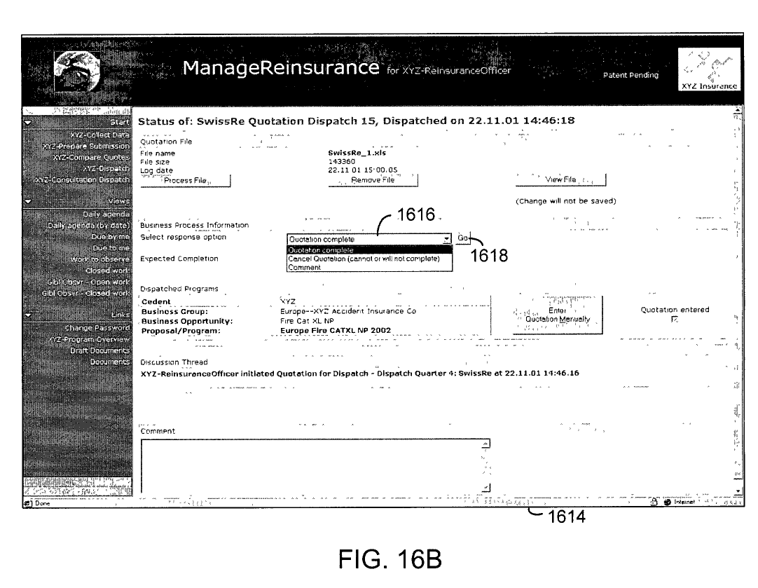

After locating a file and clicking button 1606 or entering the quotation manually using button 1608, the reinsurer interface 312 displays screen 1610, as shown in FIG. 16A. Using the buttons in area 1612, the reinsurance officer can then view the file, remove the file (if, for example, the wrong file was selected), or upload the file (i.e., process file). Then, as shown in screen 1614 of FIG. 16B, the reinsurance officer selects “Quotation complete” in field 1616 and clicks on the “Go” button 1618.

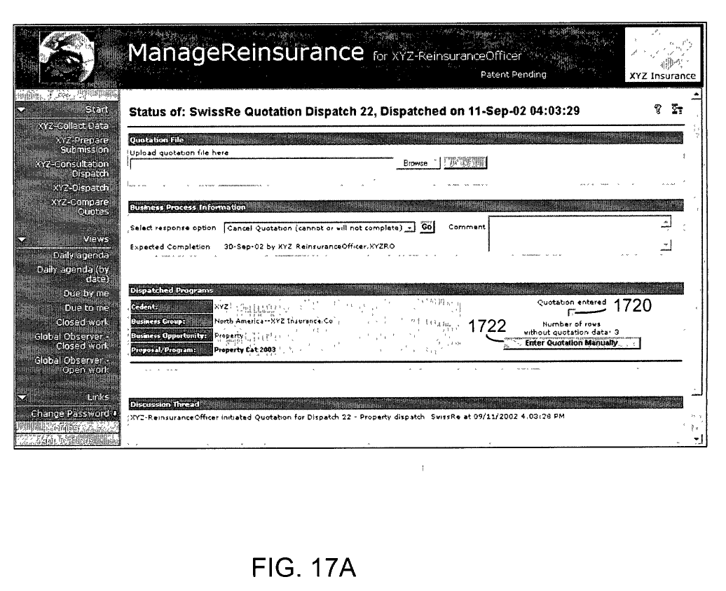

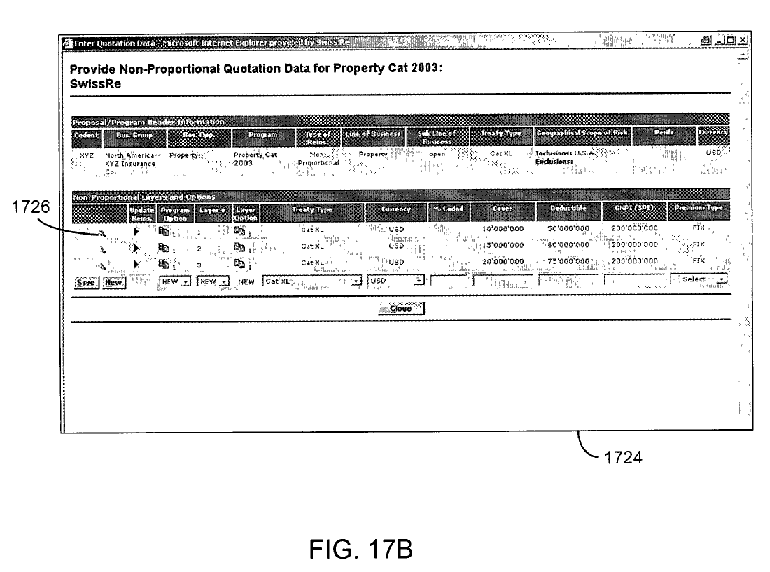

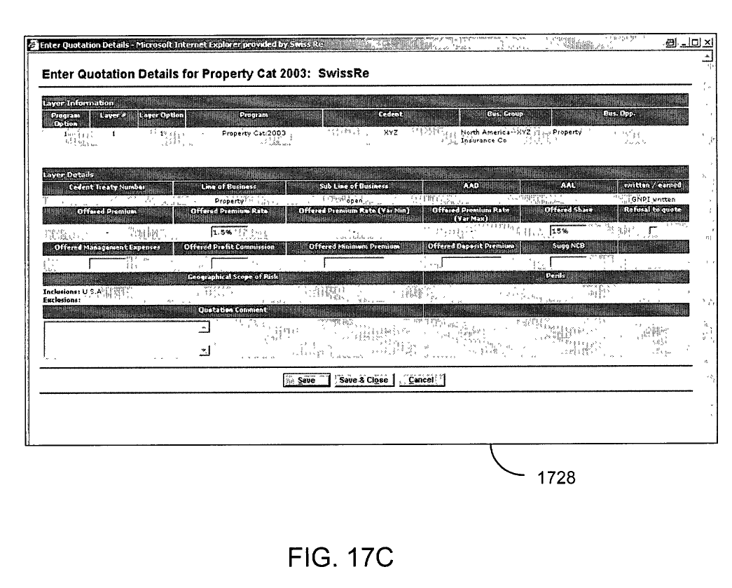

In some cases, the cedent may not receive a reinsurer's quotation electronically and must therefore manually enter the quotation into cedent interface 312. For example, some reinsurers may insist on the conventional methods of mailing or faxing quotations to the cedent. FIGS. 17A-17C illustrate this scenario in which quotations are entered manually. FIG. 17A shows the status page for a program that has been dispatched. As shown by box 1720, the cedent has not received a quotation from the listed reinsurer for this program. Assuming that the cedent then receives the quotation by fax, then the cedent must manually enter the quotation. Thus, the cedent clicks on the “Enter Quotation Manually” button 1722 (which corresponds to button 1608 of FIG. 15).

In response, as shown in FIG. 17B, cedent interface 312 displays an enter quotation data page 1724 for the particular reinsurer, which lists the program information and the proposed layers and options. To enter the reinsurer's quotation for a particular option/layer, the cedent clicks on icon 1726. In response, as shown in FIG. 17C, cedent interface 312 displays an enter quotation details page 1728 in which the cedent can enter the reinsurer's quoted layer details, including the reinsurer's offered rate and share.

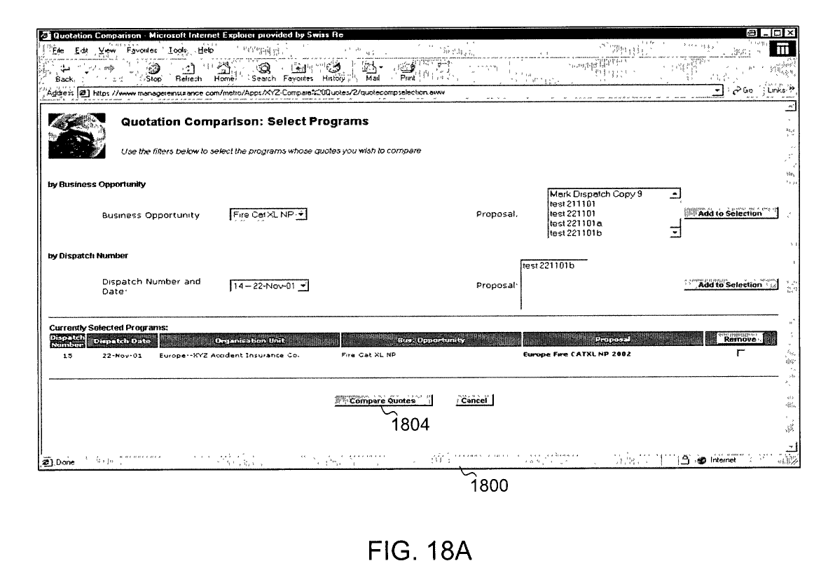

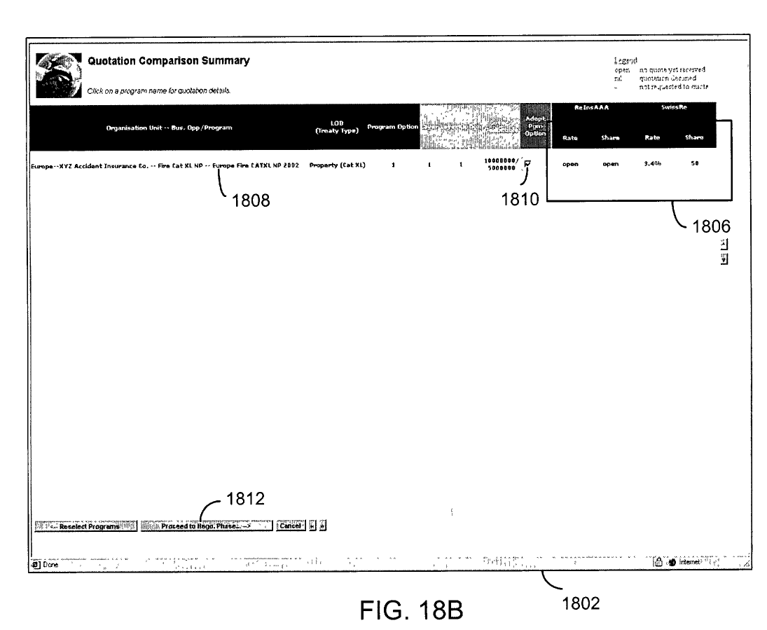

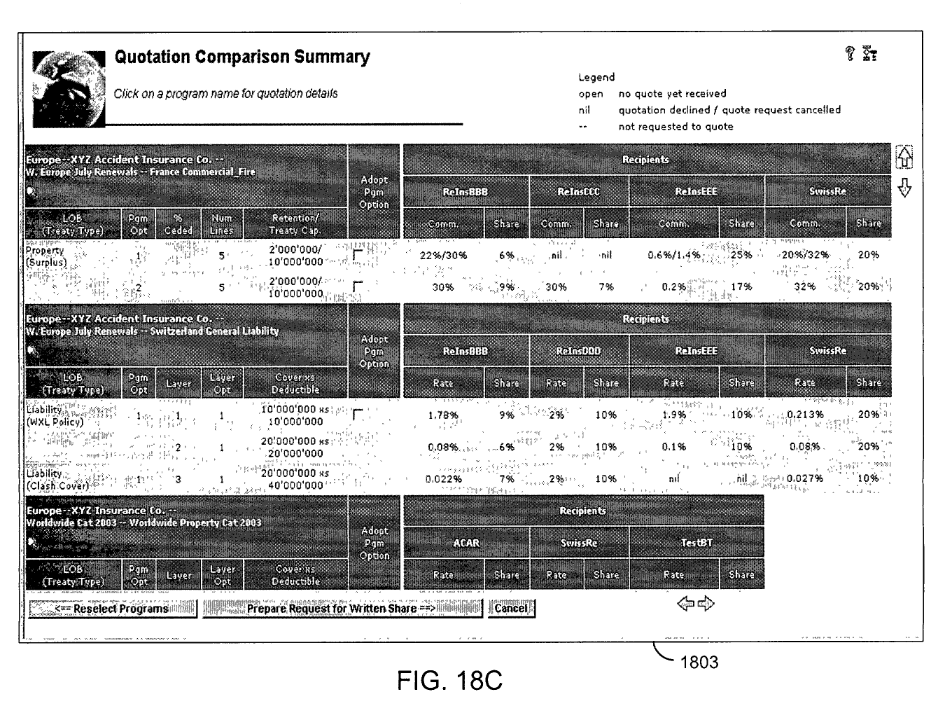

FIGS. 18A-18C illustrate exemplary screens 1800, 1802, and 1803, respectively, through which a reinsurance officer can compare quotations to complete the evaluation of step 700. As shown in FIG. 18A, screen 1800 allows the reinsurance officer to define for which of the programs the reinsurance officer would like to view quotations. The reinsurance officer can search for programs by business opportunity or dispatch number. After locating and selecting a program, the reinsurance officer clicks on the “Compare Quotes” button 1804 to view all of the quotations received for the selected program.

In response, as shown in FIG. 18B, cedent interface 312 displays screen 1802, which indicates, in area 1806, the program and the rate and share provided by the reinsurers/brokers who have been requested to provide a quotation. Area 1806 shows all reinsurers that were initially set as a dispatch recipient. An entry reading “open” indicates a reinsurer that has not returned a quotation. An entry reading “nil” indicates a reinsurer that has declined to quote. The reinsurance officer can click on the program name 1808 to review the details of the quotation.

FIG. 18C illustrates another example of a quotation comparison screen 1803. This example shows three programs, each distributed to multiple reinsurers. The matrix of screen 1803 helps the cedent compare all reinsurer offers in a single, convenient view and serves as a valuable tracking tool in managing the dispatch of the various requests for proposals for multiple programs and multiple reinsurers. Conventional methods of completing this step have traditionally involved mailing or e-mailing requests for quotations, which often leads to uncertainties about which requests and which versions of the requests have been sent to which reinsurers. The tracking advantages of the present invention eliminate this confusion.

After the reinsurance officer of the cedent has finished the evaluation, the cedent is ready to set a final price and negotiate written shares with selected reinsurers. Thus, the conclusion of step 700 marks the end of the evaluation step 306 of FIG. 3. The remaining steps 307 and 308 of the overall reinsurance placement process involve negotiation and collaboration between the cedent and reinsurers. During this negotiation and collaboration, the cedent works through cedent interface 312 in the evaluation and negotiation stage 320 and the placement stage 322, while the reinsurers work through reinsurer interface 314 in the negotiation stage 326 and the signing stage 328.

FIGS. 7A and 7B outline an exemplary method for completing negotiation step 307 of FIG. 3. FIG. 7A illustrates the steps completed by the cedent in negotiating with the reinsurer. FIG. 7B illustrates the steps completed by the reinsurer in negotiating with the cedent. Starting with FIG. 7A, after the cedent reinsurance officer has evaluated the reinsurer quotes, in step 702, the cedent reinsurance officer establishes the final structure of the program (through structured data input). Specifically, the cedent reinsurance officer determines which of the program/layer options will be adopted, in essence, solidifying the “structure” of the reinsurance program, which up until this point, may have consisted of multiple mutually exclusive options. The cedent reinsurance officer also enters the common price the cedent will pay reinsurers for the chosen covers. The cedent reinsurance officer also determines which reinsurers and brokers will be requested to provide a written share quotation. In the case of a broker, the cedent reinsurance officer can request that the broker provide a written share quotation for a specific reinsurer. Alternatively, the cedent reinsurance officer can request the broker to contact and quote from a pool of “approved” reinsurers based on the cedent's standards and policies for reinsurer creditworthiness.

FIG. 18B illustrates a screen 1802 through which the reinsurance officer can establish the final structure of the program (step 702). As shown, to select program and layer options to be a part of the final structure, the cedent reinsurance officer selects checkbox 1810. As part of a plausibility check, cedent interface 312 provides a warning message if the cedent reinsurance officer selects an incorrect mix of program/layer options. After selecting the final structure, the cedent reinsurance officer clicks on the “Proceed to Negotiation Phase” button 1812.

Returning to FIG. 7A, once the final structure is set, in step 704, the lead reinsurance officer reviews the program structure, final price, and reinsurer/broker selections made by the cedent reinsurance officer. The lead reinsurance officer enters modifications if necessary (as structured data).

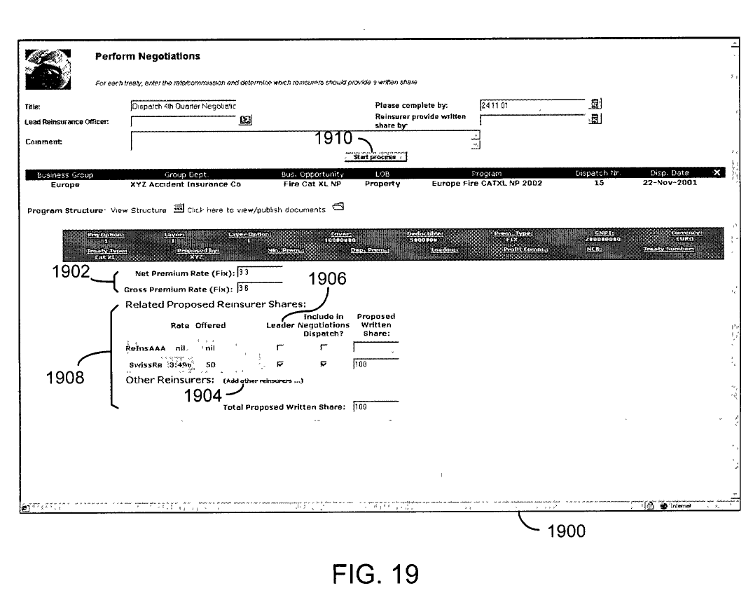

FIG. 19 illustrates an exemplary negotiation screen 1900 through which the lead reinsurance officer can enter final net and gross rates in data fields 1902, designate preferred participants in the negotiation through link 1904, select a leader in fields 1906 (i.e., the reinsurer(s) with the largest share of the treaty), and suggest a proposed written share to the reinsurer/broker in fields 1908.

Referring to FIG. 7A, in step 706, the lead reinsurance officer requests a written share from the selected reinsurers/brokers (by clicking on the “Start Process” button 1910 of FIG. 19). The lead reinsurance officer releases a request for written share dispatch using the same technical mechanisms/processes described above for dispatch of requests for quotation. For example, the request for written share dispatch may involve multiple reinsurance programs, all of whose documents (unstructured) together with automatically prepared quote spreadsheet (structured) are compressed into a package file for the specified reinsurer or broker.

After the lead reinsurance officer releases the request for written share, in step 708, the request is sent to the participant reinsurers. The request is, for example, an e-mail asking a reinsurer to download a reinsurance package. The package can include attached documents (unstructured) and formatted quote spreadsheet files (structured) in which to specify written shares. This dispatch is performed in the same manner as described above in reference to dispatching requests for quotation.

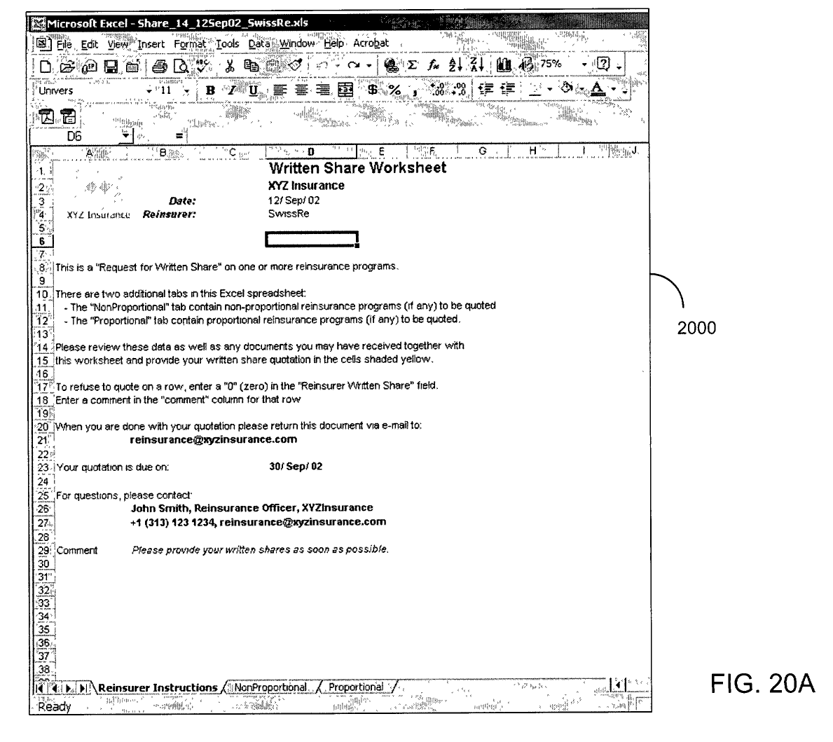

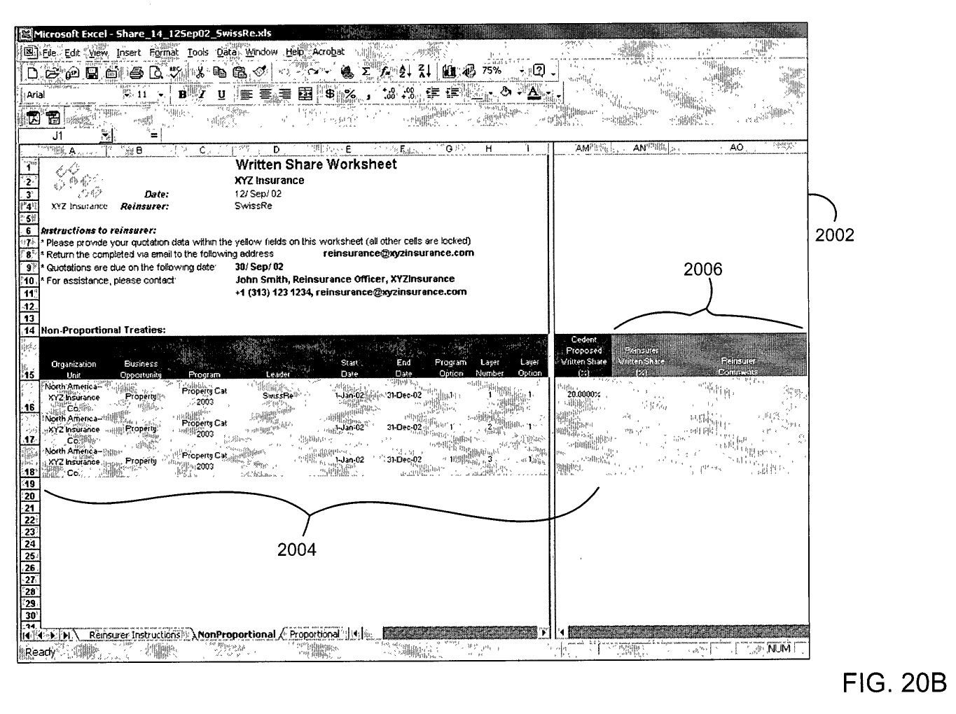

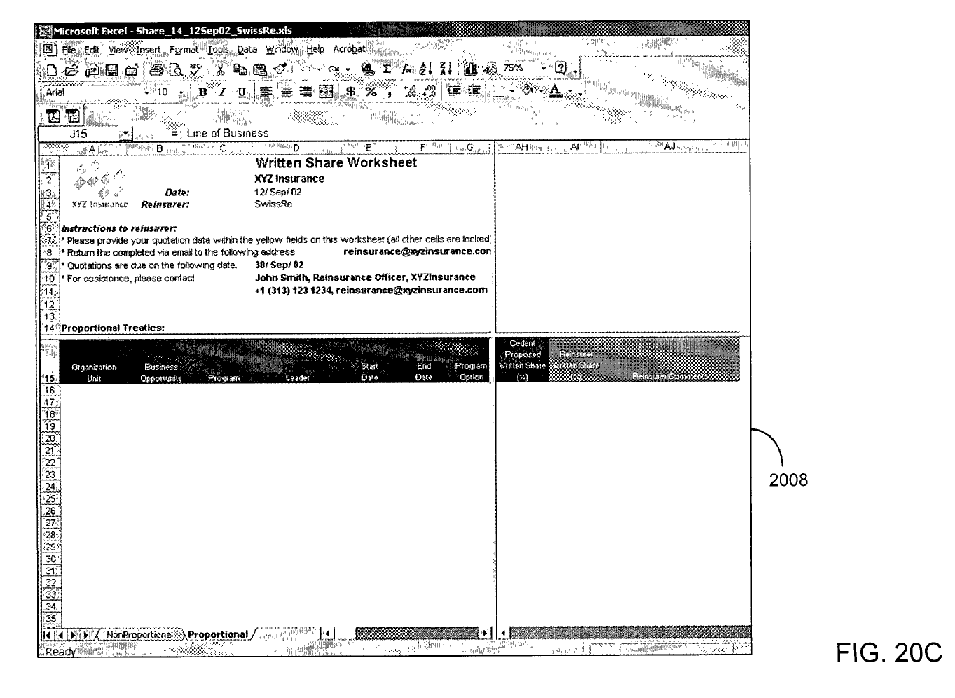

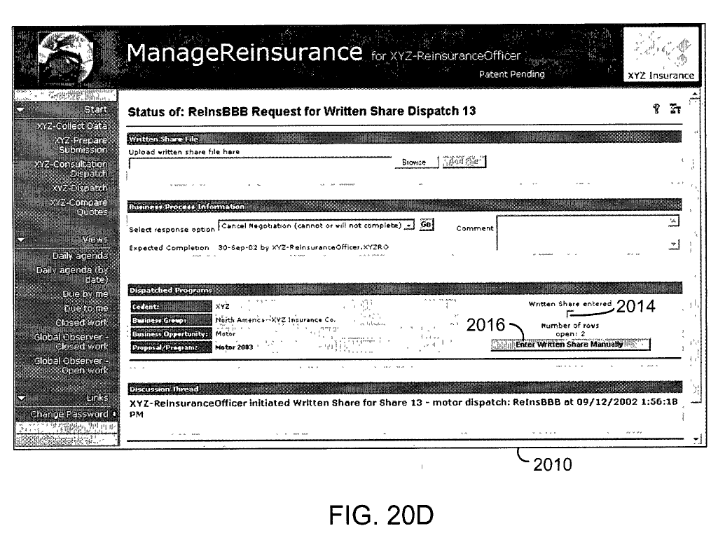

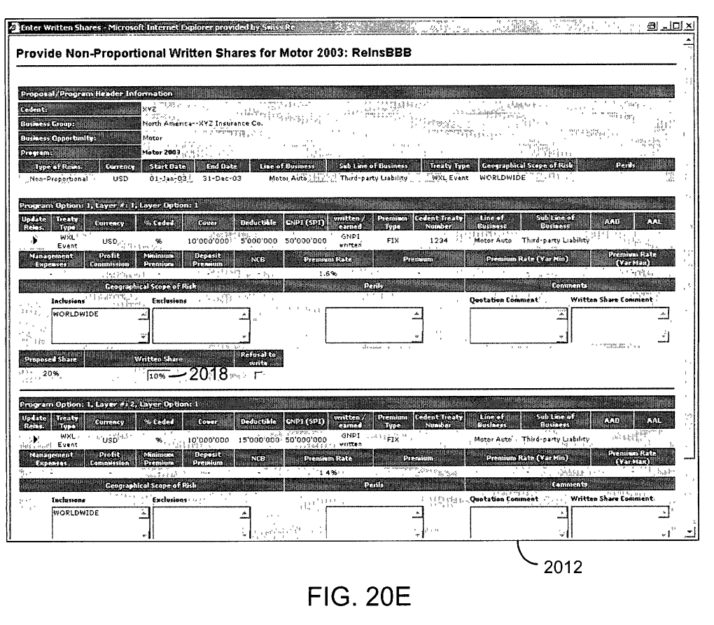

FIGS. 20A-20C illustrate the contents of an exemplary downloaded file for the request for written share. The file includes an Excel workbook having multiple worksheets. The first sheet 2000, as shown in FIG. 20A, provides the reinsurer with the background on the request for written share, instructions for submitting a written share, and contact information of the cedent. These exemplary instructions explain that the workbook is a request for written share on one or more reinsurance programs, and that the workbook contains a “non-proportional” tab and a “proportional” tab. The non-proportional tab contains non-proportional programs (if any) that require written shares. The proportional tab contains proportional programs (if any) that require written shares. The instructions ask the reinsurer to review the different worksheets of the workbook along with any documents that may have been forwarded with the workbook. The instructions ask the reinsurer to provide its written share in designated fields (e.g., shaded yellow). The instructions also explain how to refuse to participate, how to return the document to the cedent when the written share is complete, when the written share is due, and who to contact with questions. This first sheet 2000 of the workbook can also include general comments related to completing the written share.

FIG. 20B illustrates an exemplary worksheet 2002 for entering a written share for non-proportional treaties. The left portion 2004 of the spreadsheet lists the structured treaty data (e.g., dates, layering numbers, lines of business, deductibles, reinstatements, and suggested rates) describing the treaties, as entered previously by the cedent. The data fields in the left portion 2004 of the spreadsheet are protected and cannot be overwritten by the reinsurer. The right portion 2006 of the spreadsheet provides the data fields in which the reinsurer enters a written share. Similar to the non-proportional worksheet 2002, FIG. 20C illustrates an exemplary worksheet 2008 for entering a written share for proportional treaties.

As shown in FIG. 7B, after the reinsurer receives the request for written share, in step 710, the global client office of the reinsurer determines whether the program structure has change significantly in comparison to the one that was originally quoted. The global client office also marks the options that will be the subject of negotiation and enters the final rates for each treaty.

If, in step 710, the structure has not changed significantly, then the process skips ahead to step 712A, at which point the global client office is ready to request the production of a written share by the local client manager (discussed below). If, however, the structure has changed significantly, then, in step 712B, the global client office assigns an underwriter, global client manager, and local client manager to work on the written share, and requests that the underwriter provide a new written share quotation. As in the quotation phase 2 (see step 602 of FIG. 6), the underwriter decides whether to agree to work on the quotation. If the underwriter declines the work, then the underwriter notifies the global client office of the refusal and, returning to step 712B, the global client office assigns another underwriter. Instead of reassigning the work, the global client office could insist that the originally assigned underwriter do the work.

If the underwriter accepts the work, then, in step 716, the underwriter produces a new technical quote.

After the new technical quote is complete (or after the global client office has determined that the structure has not changed significantly in step 710), in step 712A, the global client office requests a written share from the local client manager. But, before the local client manager produces the written share, the local client manager must accept the work as assigned by the global client office in step 712B. Thus, in step 718, the global client manager decides whether to accept the task of preparing a written share.

If the global client manager does not accept the work, then the global client office is notified of the refusal and, returning to step 712B, assigns a new global client manager. Instead of reassigning the work, the global client office could insist that the originally assigned global client manager do the work.

Assuming the global client manager accepts the work, then, in step 720, the global client manager enters the written share (structured data) based on the cedent's final rate. In deciding on the written share, the local client manager may consult with the cedent. Additionally, the local client manager can discuss the treaty with the underwriter who provided the original quotation.

After the local client manager produces the written share, in step 722, the global client manager reviews the written share. In step 724, the global client manager either accepts the written share or rejects the written share and requests an amendment.

If the global client manager rejects the written share, then, in step 726, reinsurer interface 314 notifies the local client manager of the rejection and gives the local client manager the opportunity to revise the written share.

After the revisions are made, returning to step 722, the global client manager reviews the revised written share, and then decides whether it is acceptable in step 724. This review process (steps 722, 724, and 726) repeats until the global client manager accepts the written share.

Once the global client manager accepts the written share in step 726, then, in step 728, the global client office returns the written share for each treaty back to the cedent. The written share program quotes can include, for example, spreadsheet files (structured) and documentation attachments (unstructured).

FIG. 7B shows a centralized model in which the global client office is responsible for entering the final program structure, marking the program/layer options that are being negotiated, and entering the final rates for each treaty. In the decentralized model, instead of the global client office (which does not exist in the decentralized model), the local client manager would perform these tasks.

Returning to FIG. 7A, after the reinsurer returns a written share to the cedent in step 728, the reinsurance officer of the cedent reviews the written share and decides if a change is needed, in step 730. The reinsurance officer loads the written share as structured data into host server 201 and compares values in special reports and screens provided by cedent interface 312.

If the reinsurance officer of the cedent does not receive the written share electronically (e.g., by fax or mail), then the reinsurance officer must manually enter the written share. FIGS. 20D and 20E illustrate exemplary screens 2010 and 2012, respectively, through which the reinsurance officer manually enters written shares. FIG. 20D shows the status page for a written share that has been dispatched. As shown by box 2014, the reinsurance officer has not received a written share from the listed reinsurer for this program. Assuming that the reinsurance officer then receives the written share response by telephone or facsimile, then the reinsurance officer must manually enter the quotation. Thus, the reinsurance officer clicks on the “Enter Written Share Manually” button 2016.

In response, as shown in FIG. 20D, cedent interface 312 displays an enter written share page 2012 for the particular reinsurer, which lists the program information and the proposed layers and options. The reinsurance officer enters the reinsurer's proposed share in the written share box 2018.

If, after reviewing the written shares, the reinsurance officer decides that the structure must be amended, then, returning to step 702, the reinsurance officer selects a new structure and/or price. The process then continues from 702 as outlined above, but for the amended structure.

If, in step 730, the reinsurance officer accepts the written share, then, proceeding to step 732, the agreed-on written share is ready for signing and for completing the placement of the business.

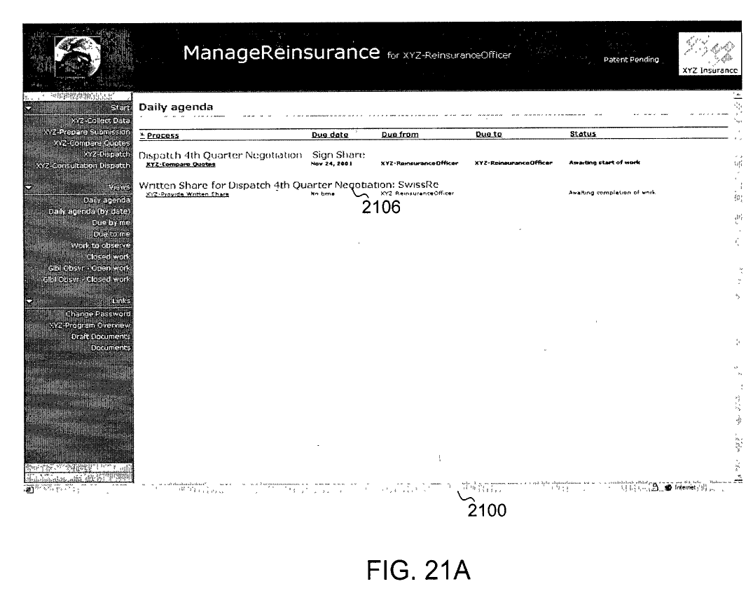

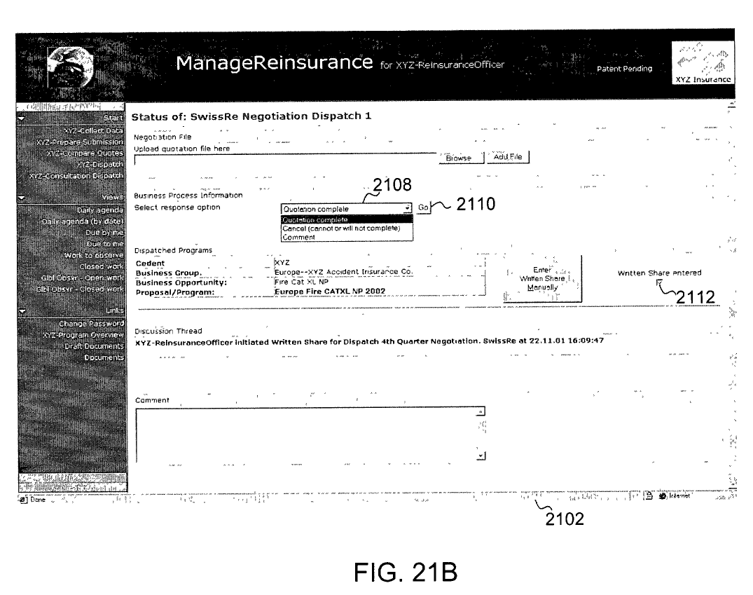

FIGS. 21A and 21B illustrate exemplary screens 2100 and 2102 through which the reinsurance officer reviews and agrees on the written share from the reinsurer in steps 730 and 732. As shown in FIG. 21A, cedent interface 312 lists the written share in the cedent's daily agenda. After the negotiation dispatch has been made, the daily agenda shows a record for the comparison of negotiation data and also a single record for each reinsurer/broker to participate in the negotiation process.

Reinsurers return their negotiation worksheets with their written shares to the reinsurance officer as a file attached to an e-mail. The reinsurance officer saves the file to the reinsurance officer's hard drive. The file can then be uploaded into cedent interface 312. Alternatively, the reinsurance officer can manually enter the written share into cedent interface 312.

In response to a click of the written share link 2106 in FIG. 21A, cedent interface displays screen 2102 of FIG. 21B. In screen 2102, the reinsurance officer agrees to the written share by selecting the “Quotation complete” option in response field 2108 and clicking the “Go” button 2110. The written share checkbox 2112 indicates that the negotiation file from the reinsurer was processed successfully and that there were no rows that were missing written share data.

In response to a selection of “quotation complete,” cedent interface 312 updates the reinsurance officer's daily agenda as shown in FIG. 21A. Specifically, the reinsurer's record is completed and removed from the daily agenda, leaving only the “Sign Share” record.

The completion of step 732 of FIG. 7A marks the end of the negotiation step 307 of FIG. 3, as well as the end of the evaluation and negotiation phase 3 of the overall reinsurance placement process (see FIGS. 1 and 3). The conclusion of step 307 also coincides with the conclusion of the evaluation and negotiation stage 320 of cedent interface 312 and the negotiation stage 326 of reinsurer interface 314.

Phase 4, Step 304

Referring to FIG. 3, after negotiating the program and written share in step 307, the reinsurance placement process ends in step 308 by completing the placement of the business. Step 308 coincides with the placement stage 322 of cedent interface 312 and the signing stage 328 of reinsurer interface 314.

FIG. 8 outlines an exemplary method for completing the business placement step 308. As shown, the business placement step 308 involves the cedent (the lead reinsurance officer and the reinsurance officer) and the reinsurer, as indicated by the horizontal rows of FIG. 8 labeled LRO, RO, and REINSURER. During this step, the cedent interacts through the placement stage 322 of cedent interface 312, and the reinsurer interacts through the signing stage 328 of reinsurer interface 314.

After the written share is agreed on in step 732, the reinsurance officer of the cedent assigns the final shares in step 800. The reinsurance officer assigns the final shares to each participant using the same technical mechanism/processes described above for requests for quotation and requests for written share. The reinsurance officer captures the signed shares as structured data and attaches documentation as unstructured data.

Once the shares have been assigned, in step 802, the lead reinsurance officer reviews the final shares and makes changes if necessary. The lead reinsurance officer then approves the final shares and dispatches them to the reinsurer as structured data. The dispatch of the final shares involves the same technical mechanism/processes described above for requests for quotation and requests for written share.

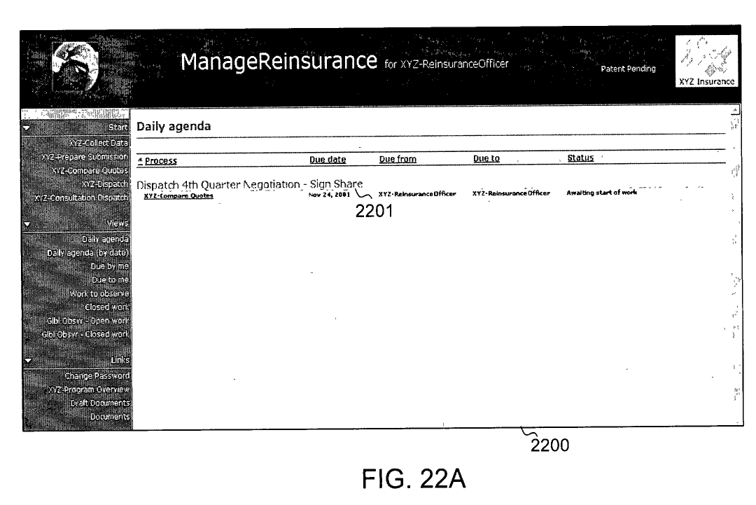

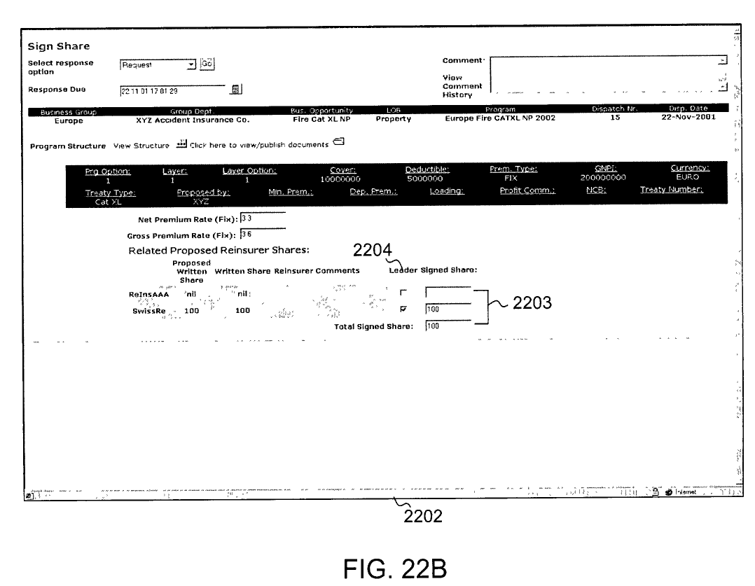

FIGS. 22A and 22B illustrate exemplary cedent interface screens 2200 and 2202 for assigning final shares. As shown in FIG. 22A, cedent interface 312 lists in the cedent's daily agenda the task of signing the final share. In response to a click of the “Sign Share” link 2201 in FIG. 22A, cedent interface displays screen 2202 of FIG. 22B. In screen 2202, the cedent enters the final signed shares in the signed share data fields 2203. The cedent selects the leader(s) using checkboxes 2204 and clicks the “Go” button 2206 to notify the reinsurers of their final shares.

Referring to FIG. 8, in step 804, the reinsurer or broker is notified of its final share. The notification is, for example, an e-mail requesting that the reinsurer/broker download a reinsurance package. Each participant is informed of its share. In the centralized model, the global client office signs the final share. In the decentralized model, the local client manager signs the final share.

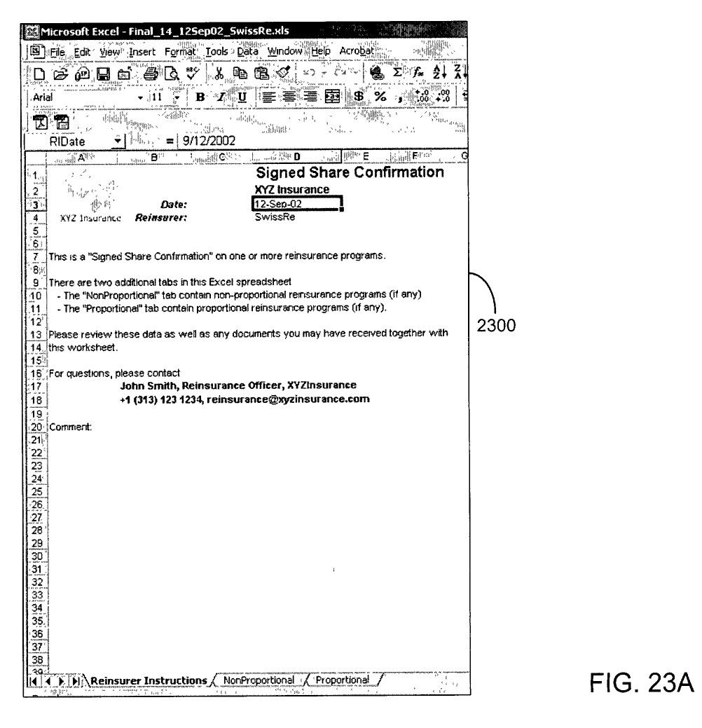

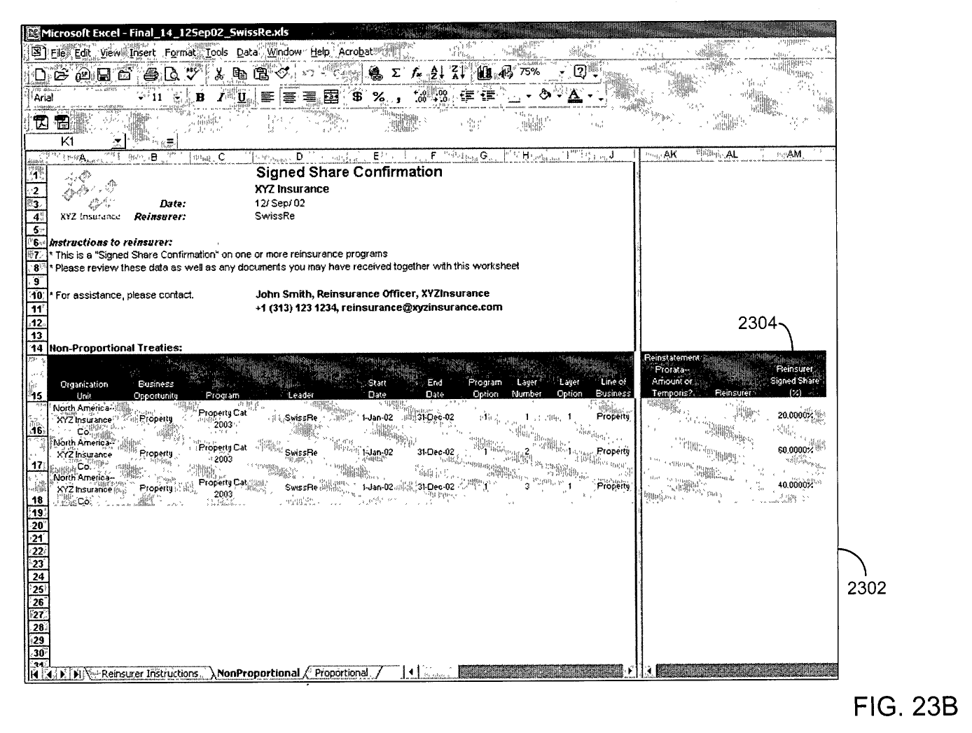

FIGS. 23A and 23B illustrate the contents of an exemplary downloaded file for the confirmation of final signed shares. The file includes an Excel workbook having multiple worksheets. The first sheet 2300, as shown in FIG. 23A, provides the reinsurer with an explanation of the signed share confirmation and includes contact information of the cedent. Sheet 2300 explains that the workbook is a signed share confirmation on one or more reinsurance programs, and that the workbook contains a “non-proportional” tab and a “proportional” tab. The non-proportional tab contains non-proportional reinsurance programs (if any). The proportional tab contains proportional reinsurance programs (if any).

FIG. 23B illustrates an exemplary worksheet 2302 for reporting the final signed shares. The spreadsheet lists the structured treaty data (e.g., dates, layering numbers, lines of business, deductibles, reinstatements, and suggested rates) describing the treaties, as entered previously by the cedent. Column 2304 lists the signed shares for each program.

In a typical case, the final share will be identical to the written share. On occasion, however, the final share and written share may differ if, for example, the cedent fails to achieve full take-up or a reinsurer withdraws late in the process. In this case, the share of the withdrawn reinsurer can be divided equally among the remaining participants. Each remaining participant would then be able to accept or refuse the adjusted share.

Returning to FIG. 8, after the participating reinsurers receive their final shares, the reinsurance officer enters the signed business rules into the accounting systems in step 806 and prints the contract wordings in step 808. Then, in steps 810, 812, and 814, the lead reinsurance officer, the reinsurance officer, and the reinsurers, respectively, sign the wordings. In steps 816 and 818, both the reinsurer and the cedent retain a signed copy of the wordings. Finally, in step 818, the business in considered placed.

In an embodiment of the present invention, steps 806-820 occur at least partially, and preferably completely, by electronic means. In other words, a portion or all of steps 806-820 involves an electronic transaction between the cedent and the reinsurer(s) that legally binds the parties to the treaty conditions and written shares. In essence, host server 201 would capture the latest conditions and shares assigned by the cedent and agreed to by the reinsurer(s), and would incorporate the corresponding structured and unstructured data into a final binding agreement, or wording.

Using online transactional tools such as electronic signatures, electronic mail, electronic underwriting, and digital document preparation, the cedent and reinsurer(s) would exchange, sign, and archive the final binding agreement, as shown in steps 808-818. Recently enacted federal laws (e.g., Electronic Signatures in Global and National Commerce Act and the Uniform Electronic Transaction Act) give legal weight to these electronic signatures and to electronic contracts.

The conclusion of the placement of the reinsurance business in step 818 marks the end of step 308 and phase 4 of FIG. 3, and thus marks the end of the overall reinsurance placement process.

Although, in reference to FIG. 3, the dispatches to the reinsurers are described as a single occurrence, these dispatches could, of course, involve multiple iterations. For example, in step 304, if the cedent dispatches a request for quotation to a group of reinsurers, and then discovers that another reinsurer should be included in the distribution, then, according to this embodiment of the present invention, the cedent could return to screen 1218 of FIG. 12B, select the additional reinsurer, and re-dispatch the request to that reinsurer. As another example, after dispatching a request for quotation, the cedent may not receive any desirable quotations, and could then return to steps 303 and 304 (FIG. 3) to revise and re-dispatch the program to the same group of reinsurers. As another example, the negotiation step 307 can involve multiple dispatches of requests for written share. Thus, as one of ordinary skill in the art would appreciate, the process of FIG. 3 can loop back to the dispatch steps as required by individual circumstances.

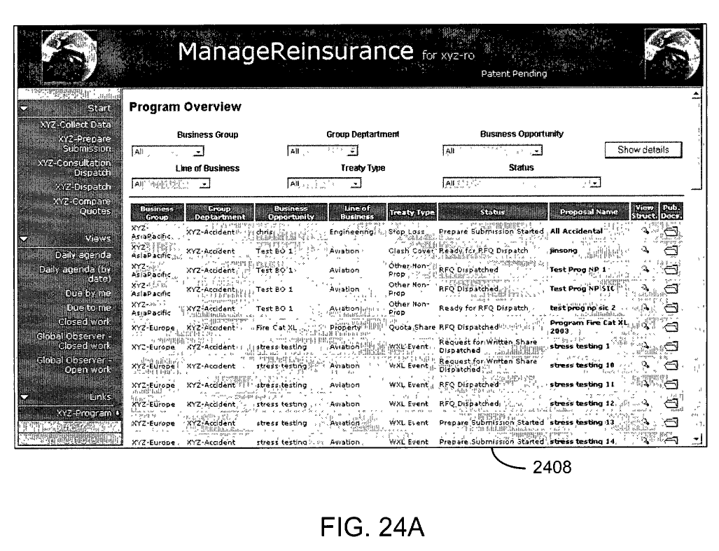

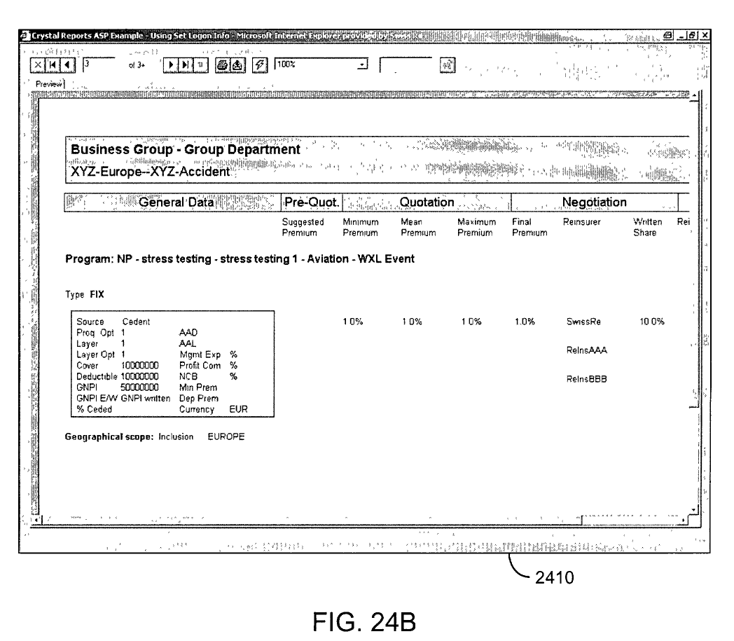

In addition to navigating the cedent through the reinsurance placement process, a representative embodiment of the present invention provides a cedent with a wide variety of summary and detail reports of the data stored during and after the process. For example, cedent interface 312 provides several reports through which the cedent can view treaty level data, such as a report of all non-proportional or proportional treaties, and a report of all treaties contained within a single program. As an example, FIGS. 24A and 24B illustrate a program overview page 2408 and program details 2410, respectively. Page 2408 lists a cedent's proposals in progress and indicates the status of each, along with pertinent data such as business group, group department, business opportunity, line of business, and treaty type. Page 2410 lists the details of a program, including the pre-quoted, quoted, and negotiated premiums and written shares.

In addition to reinsurance process control and reporting, another embodiment of the present invention provides large-scale data archiving functions. The archiving functions provide a valuable repository of reinsurance data and transactional history.

According to the archiving functions of the present invention, all data (structured or unstructured), transactional information, and communications that are generated throughout the process of FIG. 3 are stored as write-protected files in one or more database repositories. For example, a cedent's program requirements, risk data, communications related to the program, and proposals received from reinsurers would be stored on host server 201. The archiving function would store the cedent files and data of dispatches to reinsurers on file transfer server 202 including requests for quotation, submitted proposals, and communications related to the proposals. Of course, the archiving function could store this information locally as well, for example, on the local network or hard drive of the cedent.

The particular data that is archived depends upon the specific implementation of the present invention, and the individual needs of the cedent. In an exemplary implementation, the archiving function would capture key points in the process of FIG. 3, at which data, proposals, or communications are finalized. For example, an embodiment of the present invention automatically creates an audit trail that documents the activities of all parties involved in the provision and sign-off of risk data and the creation and sign-off of a proposed submission (program) or a proposed renewal package. The audit trail could include, for example, personal identifications, times, dates, and commentaries of the respective parties.

As another example of archiving key points in the process of FIG. 3, published risk data could be archived after step 406 (FIG. 4), dispatched renewal programs could be archived after step 510 (FIG. 5), and quotes could be archived as part of step 624 (FIG. 6). With regard to communications, discussion threads between the cedent and reinsurer(s) are archived to provide a complete record of the transactions. FIGS. 15, 17A, 20D, and 21B illustrate exemplary discussion threads. This record of communication is especially helpful during the negotiation step 307 when collaboration between the parties is likely to involve offline communications (e.g., meetings or telephone calls). With this archiving function, the cedent can therefore enter the substance of these offline communications to more effectively track the reinsurance placement process.

Capitalizing on the data repository built by the archiving function, a further aspect of this embodiment provides large-scale data editing and manipulation functions. The editing and manipulation functions ease the cedent's task of structuring a quotation, and include, for example, a copy program function.

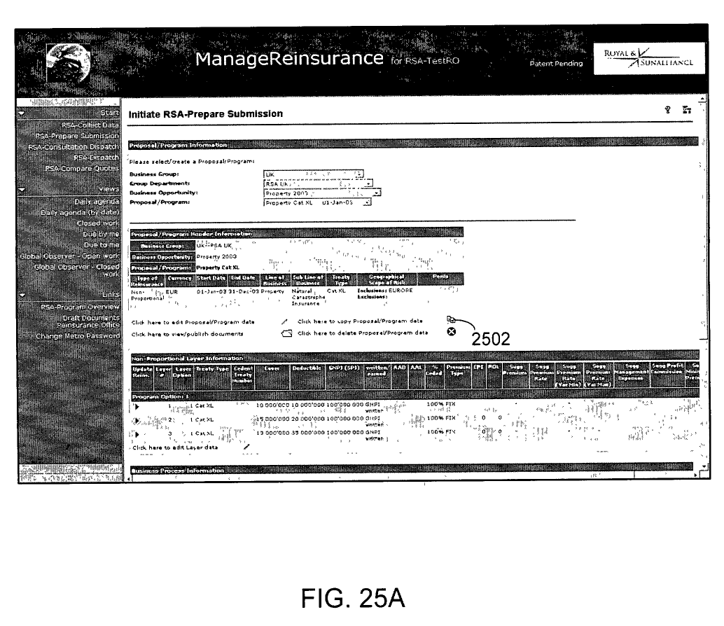

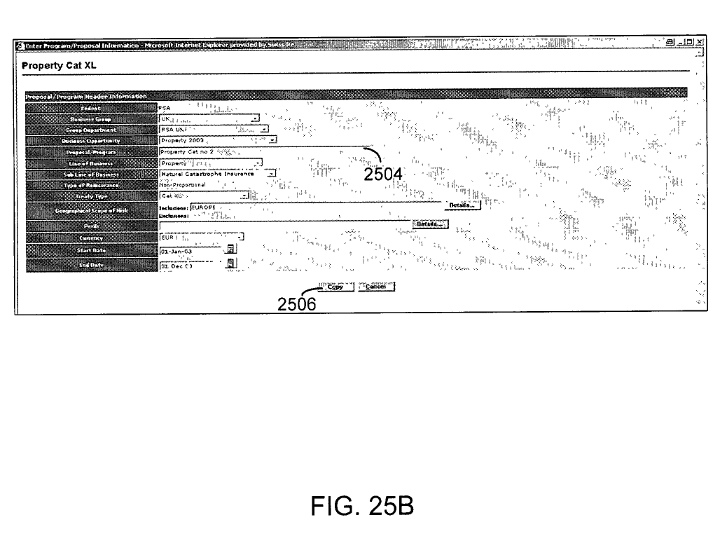

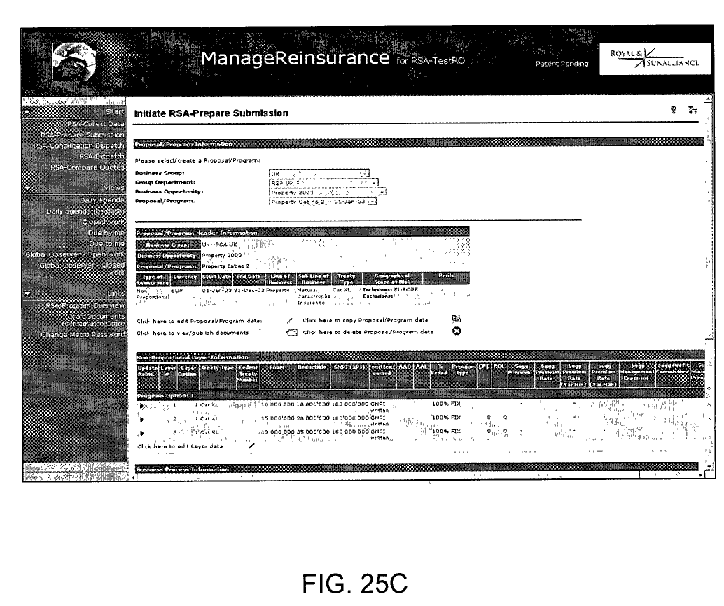

The copy program function copies basic treaty data from previously entered renewal information (in prior renewal years), and makes the data readily available for renewal for the current year. The cedent can edit or modify the copied data as necessary. FIGS. 25A-25C illustrate exemplary screens of cedent interface 312 through which a cedent can copy renewal data. As shown in FIG. 25A, to activate the function, the cedent clicks on link 2502. Then, as shown in FIG. 25B, the cedent can enter a new program name in field 2504. The cedent can also amend the other details shown in FIG. 25B, if desired. Once finished, the cedent clicks the “Copy” button 2506. In response, the new program is created and displayed in a “Prepare Submission” screen as shown in FIG. 25C. The cedent can modify the details of the program as shown in FIG. 25C.

A further embodiment of the present invention provides a global terminology software tool that establishes an international standard for reinsurance placement terminology, while also providing users with a conveniently accessible glossary. In conventional practices, a significant impediment to the global harmonization of the reinsurance placement business is the contrasting terminology used by different regions of the world. Indeed, the same reinsurance placement concept may have three different names in three different markets, such as Asia, Europe, and the United States. In addition, different markets may use the same term to refer to different reinsurance placement concepts. Not surprisingly, the participants in global reinsurance transactions can find many of the terms confusing.

To address these problems of terminology, the present invention establishes universal user interfaces and templates that standardize the names used to refer to the elements of the reinsurance placement business, such as participants, processes, calculations, and other concepts. Cedent interface 312 and reinsurer interface 314 are examples of these universal user interfaces. According to this embodiment of the present invention, each of the interfaces 312 and 314 use the same names to describe reinsurance-relevant data, such as program conditions, terms, and prices. For example, FIG. 11D shows the standardized names of proposal/program information (e.g., program, type of reinsurance, line of business, and perils) and non-proportional layers and options (e.g., treaty type, cover, AAD, and AAL) used in cedent interface 312, which would be mirrored in the reinsurer interface 314. In this manner, the cedent and the reinsurers can transact within a standardized framework, using agreed-upon definitions. As more cedents and reinsurers participate, the standardized terminology will be more widely accepted, thereby facilitating a better understanding of the market by all participants, removing the terminology obstacles preventing a truly global market, and making reinsurance placement more efficient.

The global terminology of this embodiment of the present invention is further promoted by the structured data exchanged between cedents and reinsurers, in the context of requests for quotations, requests for written shares, and signed confirmations. For example, the quotation workbook described above in reference to FIGS. 13B-13D provides a template in which the cedents and reinsurers enter conditions, prices, and shares under standardized headings with standardized names. As the cedents and reinsurers use this template, they understand and accept the global terminology.

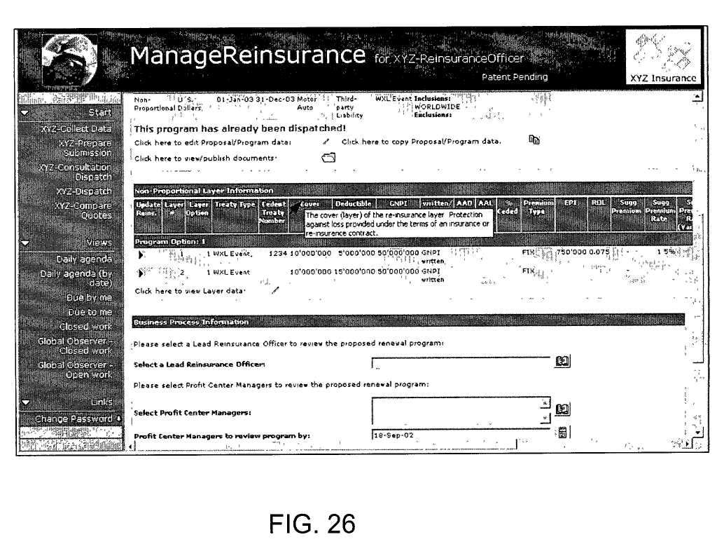

To assist cedents and reinsurers in understanding and conforming to the global terminology, a further embodiment of the present invention provides a global terminology software tool that displays a definition pop-up box or window when a mouse pointer is placed over a reinsurance placement term. FIG. 26 shows this mouse-over text help feature. Each term on a user interface is linked to a glossary database that contains a definition of the term, along with any synonyms or equivalent terms from other markets. Thus, as shown in FIG. 26, the term “cover” is linked to the definition: “The cover (layer) of the reinsurance layer. Protection against loss provided under the terms of an insurance or reinsurance contract.” Thus, if, for example, a user is unsure about what the contents of data field mean, the user need only place the mouse pointer over the name of that data field to access the definition of the name or, perhaps, a synonym of the term with which the user is more familiar.

According to an embodiment of the present invention, the mouse-over text feature operates in the background of cedent interface 312 or reinsurer interface 314, displaying the contents of the glossary database when the mouse pointer is placed over designated terms. In a further embodiment of the present invention, the mouse-over text feature is included as part of the dispatches of spreadsheet files to reinsurers, so that when the different reinsurers open the files, the reinsurers can access the glossary, understand the requested information, and provide the appropriate contents in the data fields.

The reinsurance placement system and process of the present invention provide significant benefits including one or more of the following:

A better control over the whole process;

A solution for the creation and renewal of treaty business, enabling cedents to develop programs for reinsurance and to manage the collaboration requirements for ceding the risk to the market;

An increased transparency;

An enhanced potential for the optimization of the portfolio;

An increased speed of the placement;

An encouragement for placing alternative solutions;

Helps cedents more effectively manage the value chain between insurer and reinsurer by providing control over complexity of internal reinsurance data collection and validation and by simplifying collaboration with reinsurance partners;

Provides visibility and reporting of all placements by creating a shared repository for all internal reinsurance data and by simplifying the benchmarking of market conditions and opportunities; and

Supports strategic decision making by structuring the process to save time, which can then be applied to strategic review and analysis, and by providing timely data delivery.

Although this specification describes the present invention in the context of reinsurance, one of ordinary skill in the art would appreciate that the systems and methods of the present invention apply equally well to the selling of insurance of all types, and to the forming of agreements to assume risks of others.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for facilitating preparation of a reinsurance renewal package by a cedent comprising:
receiving, from the cedent, conditions of the reinsurance renewal package as structured data;
receiving, from the cedent, an unstructured file related to the reinsurance renewal package;
associating the structured data with the unstructured file;
storing the associated structured data and unstructured file in a database; and
providing the cedent with access to the associated structured data and unstructured file.

2. The method of claim 1, wherein prior to receiving the conditions, the method comprises:
receiving risk data from the cedent;
storing the risk data in the database; and
providing the cedent with access to the risk data to perform calculations to determine the conditions.

3. The method of claim 1, further comprising:
receiving, from the cedent, a designation of reinsurers from which the cedent desires to receive a quote on the reinsurance renewal package; and
providing the reinsurers with access to the associated structured data and unstructured file.

4. The method of claim 3, wherein providing the reinsurers with access comprises forwarding to the reinsurers an electronic communication containing a link to the associated structured data and unstructured file stored on the database.

5. The method of claim 4, wherein providing the reinsurers with access further comprises downloading a spreadsheet that contains the structured data and fields in which to enter a quote.

6. The method of claim 5, further comprising:
receiving, from the reinsurers, completed spreadsheets, wherein the spreadsheets contain quotations;
associating the spreadsheets with the reinsurance renewal package; and
providing the cedent with access to the quotations.

7. The method of claim 6, wherein providing the cedent with access to the quotations comprises displaying a matrix that lists the reinsurers and their quotations.

8. The method of claim 3, wherein, after providing the reinsurers with access to the associated structured data and unstructured file, the method further comprises archiving the associated structured data and unstructured file.

9. The method of claim 3, further comprising reporting to the cedent the reinsurers that have received access to the associated structured data and unstructured file.

10. The method of claim 9, wherein reporting the reinsurers that have received access comprises displaying a matrix that lists reinsurance renewal packages against reinsurers, wherein the reinsurance renewal package is among the listed reinsurance renewal packages, wherein the designated reinsurers are among the listed reinsurers, and wherein the matrix indicates which reinsurers have received access to which reinsurance renewal package.

11. The method of claim 1, wherein, prior to receiving the conditions of the reinsurance renewal package and the unstructured file related to the reinsurance renewal package, the method comprises:
receiving at least one proposed program for the reinsurance renewal package; and
enabling multiple parties of the cedent to review and approve the at least one proposed program.

12. The method of claim 11, further comprising automatically creating an audit trail that documents activities of parties involved in creating, reviewing, and approving the at least one proposed program.

13. The method of claim 11, wherein receiving the conditions of the reinsurance renewal package and the unstructured file related to the reinsurance renewal package includes receiving, from the cedent, a designation of approved proposed programs to include in the reinsurance renewal package.

14. A method for facilitating preparation of a reinsurance renewal package by a cedent through a computer user interface comprising:
prompting for entry of risk data;
receiving the risk data;
storing the risk data on a server;
providing access to the risk data to perform offline calculations determining whether a need for reinsurance exists;
receiving at least one proposed program, wherein conditions of the at least one proposed program are based on the offline calculations;
enabling a member of the cedent to review and approve the at least one proposed program;
storing approved proposed programs on the server;
receiving an indication of at least one designated proposed program of the approved proposed programs to include in the reinsurance renewal package; and
storing the reinsurance renewal package on the server, wherein the reinsurance renewal package includes the at least one designated proposed program.

15. The method of claim 14, further comprising receiving a selection of reinsurers to receive the reinsurance renewal package and enabling a second member of the cedent to review and approve the reinsurance renewal package and the selected reinsurers.

16. The method of claim 15, wherein, if the reinsurance renewal package and the selected reinsurers are not approved, prompting for one of a different selection of reinsurers and a different proposed program.

17. The method of claim 15, further comprising automatically creating an audit trail of parties involved in reviewing and approving the at least one proposed program, the reinsurance renewal package, and the selected reinsurers.

18. The method of claim 16, wherein the audit trail includes personal identifications, times, dates, and commentaries by the parties.

19. The method of claim 14, wherein the indication of at least one designated proposed program is a combination of approved proposed programs for a first reinsurer, and wherein the method further comprises receiving a second indication of a second combination of approved proposed programs for a second reinsurer, wherein the reinsurance renewal package also includes the second combination.

20. The method of claim 14, wherein, before providing access to the risk data to perform offline calculations determining whether a need for reinsurance exists, the method comprises:
prompting for acceptance of the risk data;
if the risk data is not accepted,
prompting for additional risk data,
receiving the additional risk data, and
storing the additional risk data in the server; and
receiving the acceptance of the risk data.

21. The method of claim 20, further comprising automatically creating an audit trail of parties involved in reviewing and approving the risk data.

22. The method of claim 14, wherein prompting for entry of the risk data comprises:
receiving a business opportunity that defines a potential reinsurance need;
receiving qualifiers defining the business opportunity;
receiving unstructured documents;
associating the unstructured documents with the business opportunity;
providing access to the business opportunity; and
requesting entry of risk data pertinent to the business opportunity.

23. The method of claim 22, wherein the qualifiers include at least one of geographical scope of risk, line of business, sub line of business, and individuals who are to provide the risk data.

24. The method of claim 14, further comprising:
receiving at least one reinsurance purchasing scenario; and
providing access to the at least one reinsurance purchasing scenario to perform offline calculations determining whether a need for reinsurance exists.

25. The method of claim 14, wherein the at least one proposed program includes structured data and unstructured files.

26. A system for preparing a reinsurance renewal package comprising:
(a) a communication application adapted to communicate through a computer network with a plurality of cedent computers, wherein the plurality of cedent computers are used by at least a cedent manager and a cedent transactor;
(b) a process engine adapted to
receive a business opportunity from the cedent manager through the communication application,
provide the cedent transactor with access to the business opportunity through the communication application,
receive risk data associated with the business opportunity from the cedent transactor through the communication application,
provide the cedent manager with access to the risk data through the communication application to determine whether a need for reinsurance exists,
receive proposed programs from the cedent manager through the communication application,
provide the cedent transactor with access to the proposed programs through the communication application to determine whether to approve the proposed programs,
receive an indication of approved proposed programs from the cedent transactor through the communication application,
provide the cedent manager with access to the approved proposed programs through the communication application, and
receive from the cedent manager an indication to include at least one designated proposed program, from among the approved proposed programs, in the reinsurance renewal package; and
(c) a database adapted to store the risk data, the proposed programs, the approved proposed programs, the at least one designated proposed program, and the reinsurance renewal package.

27. The system of claim 26, wherein the process engine is further adapted to receive an indication of selected reinsurers to receive the reinsurance renewal package.

28. The system of claim 27, wherein the process engine is further adapted to
enable the cedent manager to review and approve the reinsurance renewal package and the indication of selected reinsurers, and
to receive approval of the reinsurance renewal package and the indication of selected reinsurers from the cedent manager through the communication application.

29. The system of claim 26, wherein the process engine if further adapted to receive different combinations of designated proposed programs to send to different selected reinsurers.

30. The system of claim 26, wherein the communication application is at least one of a web application and an e-mail application.

31. The system of claim 26, further comprising a spreadsheet application adapted to copy conditions of the at least one designated proposed program into a spreadsheet on which reinsurers can provide their quotations, and wherein the spreadsheet is part of the reinsurance renewal package.

32. The system of claim 26, further comprising a reporting application adapted to provide summarized and detail reports of the risk data and the approved proposed programs stored in the database.

33. The system of claim 26, further comprising a document application adapted to receive and associate unstructured files and structured spreadsheets to be included in the proposed programs.

34. The system of claim 26, further comprising a dispatch application adapted to prepare a dispatch file based on the reinsurance renewal package, for dispatch to a reinsurer.

35. The system of claim 26, wherein the process engine requires receipt of the risk data before providing the cedent manager with access to the risk data to determine whether a need for reinsurance exists.

36. The system of claim 26, wherein the process engine requires that the proposed programs be complete before providing the cedent transactor with access to the proposed programs.

37. The system of claim 26, wherein the process engine is adapted to:
receive a reinsurance purchasing scenario from a second cedent manager through the communication application, and
provide the cedent manager with access to the reinsurance purchasing scenario, along with the risk data, to determine whether a need for reinsurance exists.

38. A method for facilitating the preparation of a reinsurance renewal package by a cedent comprising:
receiving a business opportunity from a cedent manager;
providing a cedent transactor with access to the business opportunity;
prompting the cedent transactor to enter risk data associated with the business opportunity from the cedent manager;
receiving the risk data from the cedent transactor;
providing the cedent manager with access to the risk data;
prompting the cedent manager to enter a proposed submission based on the business opportunity and the risk data;
receiving a proposed program from the cedent manager;
providing the cedent transactor with access to the proposed program;
prompting the cedent transactor for approval of the proposed program;
receiving approval of the proposed program from the cedent transactor;
providing the cedent manager with access to the approved proposed program;
prompting the cedent manager to include the approved proposed program in the reinsurance renewal package;
receiving an indication to include the approved proposed program in the reinsurance renewal package;
prompting for a selection of reinsurers to receive the reinsurance renewal package;
receiving an indication of designated reinsurers to receive the reinsurance renewal package; and
providing a second cedent manager with access to review the reinsurance renewal package and the indication of designated reinsurers.

39. The method of claim 38, wherein providing access to the business opportunity, to the risk data, to the proposed program, to the approved proposed program, to the indication of designated reinsurers, and to the reinsurance renewal package comprises storing the business opportunity, the risk data, the proposed program, the approved proposed program, the indication of designated reinsurers, and the reinsurance renewal package on a server accessible by the cedent manager and the cedent transactor through a computer network.

40. The method of claim 38, further comprising requiring entry of the risk data before prompting the cedent manager to enter the proposed program.

41. The method of claim 38, further comprising requiring the proposed program to be complete before prompting the cedent transactor for approval of the proposed program.

42. The method of claim 38, further comprising requiring the proposed program to be complete and approved before prompting the cedent manager for inclusion of the program into the reinsurance renewal package.

43. The method of claim 38, further comprising requiring the second cedent manager to approve the reinsurance renewal package, and then generating the reinsurance renewal package based on the approved proposed program and the designated reinsurers.

44. A method for facilitating negotiation of placement of reinsurance business between a cedent and a reinsurer comprising:
receiving a plurality of reinsurance programs from the cedent;
receiving a designation from the cedent of selected programs, from among the plurality of reinsurance programs, to be included in a reinsurance renewal package for the reinsurer;
automatically assembling the selected programs into the reinsurance renewal package;
providing the reinsurer with access to the reinsurance renewal package including the selected programs;
receiving a quotation from the reinsurer for the reinsurance renewal package; and
providing the cedent with access to the quotation.

45. The method of claim 44, wherein the reinsurance renewal package includes unstructured files and a structured spreadsheet.

46. The method of claim 44, wherein providing the reinsurer with access to the reinsurance renewal package comprises:
storing the reinsurance renewal package on a server;
forwarding, to the reinsurer, an electronic communication that includes a link to the reinsurance renewal package; and
enabling the reinsurer to download the reinsurance renewal package from the server to the reinsurer.

47. The method of claim 46, wherein the reinsurance renewal package includes unstructured files containing risk data and a structured spreadsheet describing conditions of the selected programs and containing fields in which to enter quotes, and wherein providing access to the quotation comprises receiving the structured spreadsheet with the fields completed by the reinsurer and storing the spreadsheet on a server accessible to the cedent.

48. The method of claim 44, further comprising performing a plausibility check on the quotation before providing the cedent with access to the quotation.

49. The method of claim 44, further comprising:
storing the plurality of reinsurance programs on a first server;
storing the reinsurance renewal package on a second server, wherein the second server is separated from the first server by a firewall; and
storing the quotation on the first server.

50. The method of claim 49, wherein the reinsurer has access to the second server but not the first server.

51. The method of claim 50, wherein prior to receiving the plurality of reinsurance programs, the method further comprises:
receiving risk data from the cedent, wherein the plurality of reinsurance programs is based on the risk data of the cedent; and
storing the risk data on the first server.

52. The method of claim 44, further comprising:
recording an audit trail documenting the reinsurance renewal package, the quotation, and commentaries by the cedent and the reinsurer; and
displaying the audit trail to the cedent.

53. The method of claim 44, wherein receiving a designation from the cedent of selected programs comprises displaying a matrix that lists the plurality of reinsurance programs against a plurality of reinsurers, wherein the reinsurer is among the listed plurality of reinsurers, and wherein the designation of selected programs is made on the matrix.

54. The method of claim 44, wherein providing the cedent with access to the quotation comprises one of:
automatically uploading the quotation into an interface accessible to the cedent; and
receiving manual input of quotations through the interface.

55. The method of claim 54, wherein providing the cedent with access to the quotation further comprises displaying the quotations on a program by program basis.

56. The method of claim 44, further comprising:
receiving from the cedent final prices and final structures for the selected programs;
providing the reinsurer with access to a final reinsurance renewal package containing the final prices and final structures of the selected programs;
receiving a written share proposal for the selected programs from the reinsurer; and
providing the cedent with access to the written share proposal of the reinsurer.

57. The method of claim 56, further comprising:
receiving from the cedent final shares for the reinsurer for the selected programs; and
providing the reinsurer with access to the final shares.

58. A system for facilitating negotiation of placement of reinsurance business between a cedent and a reinsurer comprising:
(a) a host server adapted to
communicate with a cedent computer through a computer network,
receive a plurality of reinsurance programs from the cedent computer, wherein the programs contain unstructured files and structured data,
receive a designation from the cedent computer of selected programs to include in a reinsurance package, and
automatically compile the selected programs into the reinsurance package; and
(b) a file transfer server in communication with the host server, wherein the file transfer server is adapted to
communicate with a reinsurer computer through a computer network,
receive the reinsurance package from the host server, and
transmit the reinsurance package to the reinsurer computer.

59. The system of claim 58, wherein the host server is further adapted to receive a completed quotation spreadsheet and to associate the spreadsheet with the reinsurance package.

60. The system of claim 59, wherein the host server is further adapted to receive the completed quotation spreadsheet by one of:
uploading the completed quotation spreadsheet from an electronic communication received by the cedent computer from the reinsurer computer; and
receiving manual input of the completed quotation spreadsheet.

61. The system of claim 59, wherein the completed quotation spreadsheet contains a quotation, and wherein the host server is further adapted to display the quotation along with other quotations for the reinsurance package from other reinsurers.

62. The system of claim 58, wherein the host server is further adapted to receive risk data and program information from the cedent computer, and to prevent access to the risk data and program information by the reinsurer computer.

63. A method for facilitating placement of reinsurance business comprising:
receiving, from a cedent, unstructured files and structured data to be included in reinsurance renewal packages for a plurality of reinsurers;
automatically creating the reinsurance renewal packages from the unstructured files and the structured data, wherein each reinsurance renewal package includes a quotation spreadsheet that contains the structured data along with fields in which to enter quotes;
providing each reinsurer of a plurality of reinsurers with access to its reinsurance renewal package;
receiving completed quotation spreadsheets from the plurality of reinsurers, wherein the quotation spreadsheets include the quotes; and
providing the cedent with access to the quotes.

64. The method of claim 63, wherein providing the cedent with access to the quotes comprises displaying the quotes of the plurality of reinsurers simultaneously for comparison.

65. The method of claim 63, wherein providing each reinsurer of the plurality of reinsurers with access to its reinsurance renewal package comprises:
storing a particular reinsurance renewal package on a server for a particular reinsurer;
forwarding an electronic communication to the particular reinsurer, wherein the electronic communication contains a link to the particular reinsurance renewal package; and
enabling the particular reinsurer to download the particular reinsurance renewal package.

66. The method of claim 63, wherein the unstructured files include documents pertinent to programs in the reinsurance renewal package.

67. A method for facilitating negotiation of placement of reinsurance business comprising:
dispatching a portfolio of reinsurance programs in a reinsurance renewal package to a plurality of reinsurers;
receiving quotations from the plurality of reinsurers;
displaying a comparison of the quotations that facilitates benchmarking of a price for each of the reinsurance programs;
establishing final reinsurance programs that include a final price and a final structure;
dispatching a final reinsurance renewal package containing final reinsurance programs, along with a request for written share, to a plurality of select reinsurers;
receiving written share proposals from the plurality of select reinsurers; and
establishing a final share for each final reinsurance program for the plurality of select reinsurers.

68. The method of claim 67, further comprising dispatching the final reinsurance renewal package containing the final reinsurance programs, along with the final shares, to the plurality of select reinsurers.

69. The method of claim 67, further comprising receiving a signing of the final share from each of the plurality of select reinsurers.

70. The method of claim 67, wherein the reinsurance renewal package includes unstructured files and a quotation spreadsheet having data fields in which to enter quotes, and wherein dispatching the reinsurance renewal package to the plurality of reinsurers comprises downloading unstructured files and a quotation spreadsheet to each reinsurer of the plurality of reinsurers, and wherein receiving the quotations comprises receiving the quotation spreadsheet with quotes entered in the quotation spreadsheet from each reinsurer of the plurality of reinsurers.

71. The method of claim 67, wherein the final reinsurance renewal package includes a spreadsheet containing final conditions, a final price for each of the final reinsurance programs, and data fields in which to enter written shares for each of the final reinsurance programs, and wherein dispatching the final reinsurance renewal package to the plurality of select reinsurers comprises downloading the spreadsheet to each reinsurer of the plurality of select reinsurers, and wherein receiving the written shares comprises receiving the spreadsheet with the written shares entered in the spreadsheet from each reinsurer of the plurality of select reinsurers.

72. The method of claim 68, wherein the final reinsurance renewal package includes a spreadsheet containing final conditions, the final price, and the final shares for each reinsurance program, and wherein dispatching the final reinsurance renewal package to the plurality of select reinsurers comprises downloading the spreadsheet to each reinsurer of the plurality of select reinsurers.

73. A method for facilitating a global communication between a cedent and a reinsurer placing reinsurance business comprising:
providing the cedent with a cedent interface in which to enter reinsurance-relevant data, wherein the cedent interface refers to the reinsurance-relevant data using reinsurance terms;
generating a spreadsheet that contains the reinsurance-relevant data and labels the reinsurance-relevant data with the reinsurance terms, wherein the spreadsheet contains data fields in which to enter quotations, and wherein the data fields are labeled with quotation terms;
forwarding the spreadsheet to the reinsurer;
receiving the spreadsheet from the reinsurer with quotations entered in the data fields; and
displaying to the cedent through the cedent interface the reinsurance-relevant data and the quotations, wherein reinsurance-relevant data is labeled with the reinsurance terms and the quotations are labeled with the quotation terms.

74. The method of claim 73, further comprising providing through the cedent interface a glossary of the reinsurance terms and the quotation terms.

75. The method of claim 74, wherein providing the glossary comprises displaying a definition window when a mouse pointer is positioned over a term of the reinsurance terms and the quotation terms.

76. The method of claim 75, wherein the definition window includes at least one of a definition and a synonym of the term.

77. The method of claim 73, further comprising providing through the spreadsheet a glossary of the reinsurance terms and the quotation terms.

78. The method of claim 77, wherein providing the glossary comprises displaying a definition window in the spreadsheet when a mouse pointer is positioned over a term of the reinsurance terms and the quotation terms.

79. A method for promoting a standard terminology between a first party and a second party to a transaction comprising:
displaying a user interface prompting the first party for data related to the transaction, wherein the user interface labels the data with terms;
displaying on the user interface a definition window when the first party positions a mouse pointer over a certain term of the terms, wherein the definition window includes one of a definition and a synonym for the certain term; and
generating a communication to the second party, wherein the communication includes the data related to the transaction and labels the data with the terms.

80. The method of claim 79, further comprising displaying in the communication a definition window when the second party positions a second mouse pointer over a particular term, wherein the definition window includes one of a definition and a synonym of the particular term.

81. The method of claim 79, wherein the communication requests input from the second party, wherein the communication labels the input with second terms, and wherein the method further comprises:
receiving a second communication from the second party, wherein the second communication includes the input;
displaying the second communication to the first party; and
labeling the input with the second terms.

82. The method of claim 81, further comprising displaying in the second communication a definition window when the first party a second mouse pointer over a particular term of the second terms in the second communication, wherein the definition window includes one of a definition and a synonym of the particular term.

83. The method of claim 79, wherein the first party is a cedent and the second party is a reinsurer and wherein the communication is a request for quotation spreadsheet.
